(19) United States
(12) Patent Application Publication
(10) Pub. No.: US 2023/0134660 A1
(43) Pub. Date: May 4, 2023

(54) LOAD MONITORING, BRAKING CONTROL, AND HEIGHT MANAGEMENT

(71) Applicant: BASE AIR MANAGEMENT LIMITED, Sydney, New South Wales (AU)

(72) Inventors: David Bryan LEWIS, Amelia Court House, VA (US); Joseph CALAWAY, Camden, MI (US); Matthew VAUGHAN, Surfers Paradise, Queensland (AU); Anthony THURGAR, Queensland (AU)

(73) Assignee: BASE AIR MANAGEMENT LIMITED, Sydney, New South Wales (AU)

(21) Appl. No.: 17/912,321

(22) PCT Filed: Mar. 16, 2021
(86) PCT No.: PCT/IB2021/052186

§ 371 Date: Sep. 16, 2022

Related U.S. Application Data
(60) Provisional application No. 62/990,649, filed on Mar. 17, 2020.

(51) Int. Cl. B60G 17/015; B60G 17/019; B60G 17/052; B60G 17/056

(52) U.S. Cl. CPC B60G 17/0155; B60G 17/01941; B60G 17/0525; B60G 17/0565; B60G 2202/152; B60G 2204/82; B60G 2204/8304; B60G 2400/51222; B60G 2400/61; B60G 2500/2021; B60G 2800/915; B60G 2800/914

(57) ABSTRACT

Systems and methods for load monitoring and/or braking control. The load monitoring may include calculating a weight on one or more axles of a vehicle or a trailer using cross-flow pressure information indicative of an air pressure within a cross-flow passage between first and second leveling valves of first and second pneumatic circuits configured to adjust independently heights on first and second sides, respectively, of the vehicle or the trailer. The braking control may include (i) using the cross-flow pressure and speed and/or acceleration information indicative of a speed and/or acceleration of the vehicle and/or the trailer to calculate first and second brake application levels and (ii) applying the calculated first and second brake application levels to first and second brakes on the first and second sides, respectively, of the vehicle or the trailer.

### CROSS-REFERENCE TO RELATED APPLICATION

The present application claims the benefit of priority to U.S. Provisional Application Ser. No. 62/990,649, filed on Mar. 17, 2020, which is incorporated herein by reference in its entirety.

### BACKGROUND

### Field of Invention

This disclosure relates to improvements in load monitoring and/or braking control systems for vehicles and/or trailers having one or more axles supported by air springs.

### Discussion of the Background

Air suspension systems for vehicles have a plurality of air suspension springs or bags supporting one or more vehicle axles in pairs on either side of each axle. In one well-known vehicle, the pairs of air springs are connected by common large diameter air lines extending between correspondingly positioned air springs on adjacent axles. The common air lines are each connected by an air line to a height control valve directed to a respective side of a vehicle. The height control valve controls the air supply to the common air lines to adjust the inflation of the air springs to ensure that the vehicle is kept level as it is driven over variable road conditions. Unless defined otherwise, the term “height control valve” is used as equivalent to the term “leveling valve,” such that the terms “height control valve” and “leveling valve” may be used inter-changeably.

For example, when a vehicle negotiates a turn, the vehicle's center of gravity shifts along its width away from the turn. Due to the weight shift, the air springs on the side of the vehicle facing away from the turn start to contract, while the air springs on the side of the vehicle facing the turn start to extend. Consequently, the vehicle becomes unleveled from side-to-side. In response, one of the leveling valves on the lowered side of the vehicle supplies air to the contracted air springs, while the other leveling valve on the elevated side of the vehicle removes air from the extended air springs to keep the vehicle level. Through testing, it has now been found that leveling valves often overcompensate in responding to dynamic weight shifts of the vehicle, in which the air springs that were supplied air from the leveling valve tend to have a greater air pressure than the air springs that were purged by the leveling valve. As a result, a pressure difference persists between the two sides of the air suspensions system even after the leveling valves attempt to level the vehicle. Due to this pressure differential between the air springs, the vehicle remains unlevel even after the leveling valves have adjusted the pressure of the air springs in response to the vehicle weight shift.

Conventional load monitoring systems use pressure readings from one side of a vehicle or trailer to calculate weights (e.g., one or more axle masses and/or one or more axle group masses). When there is a pressure difference between the two sides, the pressures used to calculate weights will either be too high or too low and will result in inaccurate weight calculations. For instance, use of the lower pressure to calculate a weight will result in a weight calculation that is lower than the actual weight. This could results in fines for the vehicle operator (e.g., if the calculated weight is below a legal weight limit, but the actual weight is above the legal limit). Current technologies for measuring weights include on board mass units and load cells, which are costly to purchase and install and add complexity and maintenance costs to fleet operations. Further, despite their costs and complexities, such systems can produce inaccurate readings.

Conventional braking control systems may use pressure readings to calculate brake application levels. When there is a pressure difference between the two sides, the braking control system may use the higher pressure to calculate brake application levels. This results in the system applying the brakes harder than necessary, which results in unnecessary air usage, unnecessary excessive wear on the brakes and tires, and driver discomfort.

Accordingly, the present inventors have recognized that there is a need for load monitoring and/or braking control systems that address the various problems of existing systems. Moreover, the present inventors have recognized that with the system described herein, it is possible to eliminate various components and vehicle systems, thereby realizing significant cost savings in terms of vehicle procurement, maintenance, and lifetime operating performance metrics.

### SUMMARY

The present invention addresses the problem of inaccurate pressure readings by using cross-flow pressure readings indicative of an air pressure within a cross-flow passage that connects first and second leveling valves that adjust independently a height of first and second sides, respectively, of a vehicle or a trailer. In some aspects, when the first and second leveling valves are adjusting independently the height of first and/or second sides, the first and second leveling valves may shut off the sides of the cross-flow passage, such that pressure is retained in the cross-flow passage from the preceding balanced state, i.e., the “balanced pressure” from a preceding “crossflow event.” This balanced pressure in the cross-flow passage has been found to be more accurate for the purposes of weight calculations and braking control (than using solely pressure readings from one or both sides of the vehicle or the trailer) while the vehicle or the trailer is changing dynamically (e.g., during axle input, body roll, turning, and/or braking).

One aspect of the present invention relates to a load monitoring system including a cross-flow passage, a cross-flow air pressure sensor, an analog-to-digital converter (ADC), and first and second pneumatic circuits. The cross-flow air pressure sensor may be configured to output cross-flow pressure information indicative of an air pressure within the cross-flow passage. The ADC may be configured to convert the cross-flow pressure information into digital cross-flow pressure information. The first pneumatic circuit may have a first leveling valve configured to adjust independently a height of a first side of a vehicle or a trailer. The second pneumatic circuit may have a second leveling valve configured to adjust independently a height of a second side of the vehicle or the trailer. The cross-flow passage may connect the first leveling valve and the second leveling valve. The first and second leveling valves may be configured to establish pneumatic communication between the first and second pneumatic circuits via the cross-flow passage when neither the first leveling valve is adjusting independently the height of the first side nor the second leveling valve is adjusting independently the height of the second side. The cross-flow pressure information is used for monitoring a load in the vehicle or the trailer.

In some aspects, the system may further include a display configured to display the digital cross-flow pressure information. In some aspects, the cross-flow air pressure sensor may be inside the cross-flow passage. In some aspects, the system may further include a fitting connected to the cross-flow passage, and the cross-flow air pressure sensor may be configured to communicate pneumatically with the cross-flow passage via the fitting. In some aspects, the fitting may be a T-fitting. In some aspects, the system may further include one or more air lines that connect the cross-flow air pressure sensor to the fitting for pneumatic communication between the cross-flow air pressure sensor and the cross-flow passage.

In some aspects, the system may further include (i) an air line connecting one or more air springs of the first pneumatic circuit and one or more air springs of the second pneumatic circuit and (ii) a fitting connected to the air line, and the cross-flow air pressure sensor may be configured to communicate pneumatically with the air line via the fitting. In some aspects, the air line connecting the one or more air springs of the first pneumatic circuit and the one or more air springs of the second pneumatic circuit may have a smaller diameter than the cross-flow passage. In some aspects, the fitting may be a T-fitting. In some aspects, the system may further include one or more air lines that connect the cross-flow air pressure sensor to the fitting for pneumatic communication between the cross-flow air pressure sensor and the air line connecting the one or more air springs of the first pneumatic circuit and the one or more air springs of the second pneumatic circuit. In some aspects, the air line may include a first back flow preventer on one side of the fitting and a second back flow preventer on the other side of the fitting, the first back flow preventer may be configured to prevent air from the one or more air springs of the second pneumatic circuit from flowing into the one or more air springs of the first pneumatic circuit via the air line, and the second back flow preventer may be configured to prevent air from the one or more air springs of the first pneumatic circuit from flowing into the one or more air springs of the second pneumatic circuit via the air line. In some aspects, the cross-flow pressure information may be indicative of the air pressure within the cross-flow passage when the first and second leveling valves have established pneumatic communication between the first and second pneumatic circuits via the cross-flow passage, and the cross-flow pressure information may be indicative of the higher of (i) an air pressure within one or more air springs of the first pneumatic circuit and (ii) an air pressure within one or more air springs of the second pneumatic circuit when the first and second leveling valves are adjusting independently the height of the first and second sides of the vehicle or the trailer.

In some aspects, the first pneumatic circuit may include a first air spring disposed on the first side, and the system may further include a first air spring air pressure sensor configured to output first air spring pressure information indicative of an air pressure within the first air spring. In some aspects, the system may further include an ADC and a display. The ADC may be configured to convert the first air spring pressure information into digital first air spring pressure information. The display may be configured to display the digital first air spring pressure information and the digital cross-flow pressure information.

In some aspects, the second pneumatic circuit comprises a second air spring disposed on the second side, and the system further comprises a second air spring air pressure sensor configured to output second air spring pressure information indicative of an air pressure within the second air spring. In some aspects, the system may further include an ADC and a display. The ADC may be configured to convert the second air spring pressure information into digital second air spring pressure information. The display may be configured to display the digital first air spring pressure information, the digital second air spring pressure information, and the digital cross-flow pressure information.

In some aspects, the system may further include a processor or computer configured to use the digital cross-flow pressure information to calculate a cross-flow-based weight on one or more axles of the vehicle or the trailer. In some aspects, the cross-flow pressure information may be first cross-flow pressure information indicative of an air pressure within the cross-flow passage at a first measurement time, and the cross-flow air pressure sensor may be further configured to output second cross-flow pressure information indicative of an air pressure within the cross-flow passage at a second measurement time. In some aspects, the digital cross-flow pressure information may be digital first cross-flow pressure information, and the ADC may be further configured to convert the second cross-flow pressure information into digital second cross-flow pressure information. In some aspects, the cross-flow-based weight may be indicative of a weight on the one or more axles of the vehicle or the trailer at the first measurement time, and the computer may be configured to use reference weight information, the digital first cross-flow pressure information, and the digital second cross-flow pressure information to calculate the cross-flow-based weight. In some aspects, the reference weight information is indicative of a weight on the one or more axles of the vehicle or the trailer at the second measurement time. In some aspects, the system may further include a display configured to display the cross-flow-based weight.

In some aspects, the first pneumatic circuit may include a first air spring disposed on the first side, and the system may further include a first air spring air pressure sensor configured to output first air spring pressure information indicative of an air pressure within the first air spring at the first measurement time and second air spring pressure information indicative of an air pressure within the first air spring at the second measurement time. In some aspects, the system may include an ADC configured to convert the first air spring pressure information into digital first air spring pressure information and to convert the second air spring pressure information into digital second air spring pressure information, and the computer may be further configured to use the reference weight information, the digital first air spring pressure information, and the digital second air spring pressure information to calculate a first air spring-based weight on the one or more axles of the vehicle or the trailer at the first measurement time. In some aspects, the second pneumatic circuit may include a second air spring disposed on the second side, and the system may further include a second air spring air pressure sensor configured to output third air spring pressure information indicative of an air pressure within the second air spring at the first measurement time and fourth air spring pressure information indicative of an air pressure within the second air spring at the first measurement time.

In some aspects, the system may include an ADC configured to convert the third air spring pressure information into third digital air spring pressure information and to convert the fourth air spring pressure information into fourth digital air spring pressure information, and the computer may be further configured to use the reference weight information, the third digital air spring pressure information, and the fourth digital air spring pressure information to calculate a second air spring-based weight on the one or more axles of the vehicle or the trailer at the first measurement time. In some aspects, the ADC configured to convert the first and second cross-flow pressure information, the ADC configured to convert the first and second air spring pressure information, and the ADC configured to convert the third and fourth air spring pressure information may be the same ADC. In some aspects, the ADC configured to convert the first and second cross-flow pressure information, the ADC configured to convert the first and second air spring pressure information, and the ADC configured to convert the third and fourth air spring pressure information may be different ADCs. In some aspects, the system may further include a display configured to display the cross-flow-based weight, the first air spring-based weight, and the second air spring-based weight.

In some aspects, the system may further include a display configured to display the cross-flow-based weight and the first air spring-based weight. In some aspects, using the reference weight information, the digital first cross-flow pressure information, and the digital second cross-flow pressure information to calculate the cross-flow-based weight on the one or more axles of the vehicle or the trailer at the first measurement time may include: using the reference weight information and the digital first cross-flow pressure information to calculate a pressure-to-weight conversion function, and using the pressure-to-weight conversion function and the digital second cross-flow pressure information to calculate the cross-flow-based weight on the one or more axles of the vehicle or the trailer at the first measurement time.

In some aspects, the reference weight information may be first reference weight information; the cross-flow air pressure sensor may be further configured to output third cross-flow pressure information indicative of an air pressure within the cross-flow passage at a third measurement time; the ADC configured to convert the first and second cross-flow pressure information may be further configured to convert the third cross-flow pressure information into third digital cross-flow pressure information; and the computer may be configured to use the first reference weight information, second reference weight information, the digital first cross-flow pressure information, the digital second cross-flow pressure information, and the third digital cross-flow pressure information to calculate the cross-flow-based weight on the one or more axles of the vehicle or the trailer at the first measurement time. The second reference weight information may be indicative of a weight on the one or more axles of the vehicle or the trailer at the third measurement time. In some aspects, using the first reference weight information, the second reference weight information, the digital first cross-flow pressure information, the digital second cross-flow pressure information, and the third digital cross-flow pressure information to calculate the cross-flow-based weight on the one or more axles of the vehicle at the first measurement time may include: using the first and second reference weight information and the first and third digital cross-flow pressure information to calculate a pressure-to-weight conversion function; and using the pressure-to-weight conversion function and the digital second cross-flow pressure information to calculate the cross-flow-based weight on the one or more axles of the vehicle or the trailer at the first measurement time.

Another aspect of the invention relates to a load monitoring method including using a cross-flow air pressure sensor to output cross-flow pressure information indicative of an air pressure within a cross-flow passage. The cross-flow passage may connect a first leveling valve of a first pneumatic circuit with a second leveling valve of a second pneumatic circuit, the first level circuit may be configured to adjust independently a height of a first side of a vehicle or a trailer, the second leveling valve may be configured to adjust independently a height of a second side of the vehicle or the trailer, and the first and second leveling valves may be configured to establish pneumatic communication between the first and second pneumatic circuits via the cross-flow passage when neither the first leveling valve is adjusting independently the height of the first side nor the second leveling valve is adjusting independently the height of the second side. The load monitoring method may include using an analog-to-digital converter (ADC) to convert the cross-flow pressure information into digital cross-flow pressure information.

In some aspects, the method may further include: using the first leveling valve to adjust independently the height of the first side of the vehicle or the trailer; and using the second leveling valve to adjust independently the height of the second side of the vehicle or the trailer.

In some aspects, the method may further include using the first and second leveling valves to establish pneumatic communication between the first and second pneumatic circuits via the cross-flow passage when neither the first leveling valve is adjusting independently the height of the first side nor the second leveling valve is adjusting independently the height of the second side. In some aspects, the method may further include using a display to display the digital cross-flow pressure information. In some aspects, the cross-flow air pressure sensor may be inside the cross-flow passage.

In some aspects, the first pneumatic circuit may include a first air spring disposed on the first side of the vehicle or the trailer, and the method further include using a first air spring air pressure sensor configured to output first air spring pressure information indicative of an air pressure within the first air spring. In some aspects, the method may further include: using an ADC to convert the first air spring pressure information into digital first air spring pressure information; and using a display to display the digital first air spring pressure information and the digital cross-flow pressure information. In some aspects, the second pneumatic circuit may include a second air spring disposed on the second side of the vehicle or the trailer, and the method may further include using a second air spring air pressure sensor to output second air spring pressure information indicative of an air pressure within the second air spring. In some aspects, the method may further include: using an ADC to convert the second air spring pressure information into digital second air spring pressure information, and using a display to display the digital first air spring pressure information, the digital second air spring pressure information, and the digital cross-flow pressure information.

In some aspects, the method may further include using a computer to use the digital cross-flow pressure information to calculate a cross-flow-based weight on one or more axles of the vehicle or the trailer. In some aspects, the cross-flow pressure information may be first cross-flow pressure information indicative of an air pressure within the cross-flow passage at a first measurement time, the digital cross-flow pressure information may be digital first cross-flow pressure information, the cross-flow-based weight may be indicative of a weight on the one or more axles of the vehicle or the trailer at the first measurement time, and the method may further include: using the cross-flow air pressure sensor to output second cross-flow pressure information indicative of an air pressure within the cross-flow passage at a second measurement time; and using the ADC to convert the second cross-flow pressure information into digital second cross-flow pressure information. The computer may use reference weight information, the digital first cross-flow pressure information, and the digital second cross-flow pressure information to calculate the cross-flow-based weight, and the reference weight information may be indicative of a weight on the one or more axles of the vehicle or the trailer at the second measurement time.

In some aspects, the method may further include using a display to display the cross-flow-based weight. In some aspects, the first pneumatic circuit may include a first air spring disposed on the first side of the vehicle or the trailer, and the method may further include: using a first air spring air pressure sensor to output first air spring pressure information indicative of an air pressure within the first air spring at the first measurement time; and using the first air spring air pressure sensor to output second air spring pressure information indicative of an air pressure within the first air spring at the second measurement time. In some aspects, the method may further include: using an ADC to convert the first air spring pressure information into digital first air spring pressure information and to convert the second air spring pressure information into digital second air spring pressure information; and using the computer to use the reference weight information, the digital first air spring pressure information, and the digital second air spring pressure information to calculate a first air spring-based weight on the one or more axles of the vehicle or the trailer at the first measurement time. In some aspects, the second pneumatic circuit may include a second air spring disposed on a second side of the vehicle or the trailer, and the method may further include: using a second air spring air pressure sensor to output third air spring pressure information indicative of an air pressure within the second air spring at the first measurement time; and using the second air spring air pressure sensor to output fourth air spring pressure information indicative of an air pressure within the second air spring at the first measurement time.

In some aspects, the method may further include: using an ADC to convert the third air spring pressure information into third digital air spring pressure information and to convert the fourth air spring pressure information into fourth digital air spring pressure information; and using the computer to use the reference weight information, the third digital air spring pressure information, and the fourth digital air spring pressure information to calculate a second air spring-based weight on the one or more axles of the vehicle or the trailer at the first measurement time. In some aspects, the method may further include displaying the cross-flow-based weight, the first air spring-based weight, and the second air spring-based weight. In some aspects, the method may further include displaying the cross-flow-based weight and the first air spring-based weight.

In some aspects, using the reference weight information, the digital first cross-flow pressure information, and the digital second cross-flow pressure information to calculate the cross-flow-based weight on the one or more axles of the vehicle or the trailer at the first measurement time may include: using the reference weight information and the digital first cross-flow pressure information to calculate a pressure-to-weight conversion function; and using the pressure-to-weight conversion function and the digital second cross-flow pressure information to calculate the cross-flow-based weight on the one or more axles of the vehicle or the trailer at the first measurement time.

In some aspects, the reference weight information may be first reference weight information, and the method may further include: using the cross-flow air pressure sensor to output third cross-flow pressure information indicative of an air pressure within the cross-flow passage at a third measurement time; using an ADC to convert the third cross-flow pressure information into third digital cross-flow pressure information; and using the computer to use the first reference weight information, the second reference weight information, the digital first cross-flow pressure information, the digital second cross-flow pressure information, and the third digital cross-flow pressure information to calculate the cross-flow-based weight on the one or more axles of the vehicle or the trailer at the first measurement time. The second reference weight information may be indicative of a weight on the one or more axles of the vehicle or the trailer at the third measurement time. In some aspects, using the first reference weight information, the second reference weight information, the digital first cross-flow pressure information, the digital second cross-flow pressure information, and the third digital cross-flow pressure information to calculate the cross-flow-based weight on the one or more axles of the vehicle or the trailer at the first measurement time may include: using the first and second reference weight information and the first and third digital cross-flow pressure information to calculate a pressure-to-weight conversion function; and using the pressure-to-weight conversion function and the digital second cross-flow pressure information to calculate the cross-flow-based weight on the one or more axles of the vehicle or the trailer at the first measurement time.

Yet another aspect of the invention relates to a braking control system including a cross-flow passage, one or more speed and/or acceleration sensors, a cross-flow air pressure sensor, a computer, and first and second pneumatic circuits. The one or more speed and/or acceleration sensors may be configured to output speed and/or acceleration information indicative of a speed and/or acceleration of a vehicle and/or a trailer. The cross-flow air pressure sensor may be configured to output cross-flow pressure information indicative of an air pressure within the cross-flow passage. The computer may be configured to use the speed and/or acceleration information and the cross-flow pressure information to calculate first and second brake application levels. The computer may be configured to apply the calculated first brake application level to a first brake on a first side of the vehicle or the trailer. The computer may be configured to apply the calculated second brake application level to a second brake on a second side of the vehicle or the trailer. The first pneumatic circuit may have a first leveling valve configured to adjust independently a height of the first side. The second pneumatic circuit may have a second leveling valve configured to adjust independently a height of the second side. The cross-flow passage may connect the first leveling valve and the second leveling valve, and the first and second leveling valves may be configured to establish pneumatic communication between the first and second pneumatic circuits via the cross-flow passage when neither the first leveling valve is adjusting independently the height of the first side nor the second leveling valve is adjusting independently the height of the second side.

In some aspects, the cross-flow air pressure sensor is inside the cross-flow passage. In some aspects, the system may further include a fitting connected to the cross-flow passage, and the cross-flow air pressure sensor may be configured to communicate pneumatically with the cross-flow passage via the fitting. In some aspects, the fitting may be a T-fitting. In some aspects, the system may further include one or more air lines that connect the cross-flow air pressure sensor to the fitting for pneumatic communication between the cross-flow air pressure sensor and the cross-flow passage.

In some aspects, the system may further include (i) an air line connecting one or more air springs of the first pneumatic circuit and one or more air springs of the second pneumatic circuit and (ii) a fitting connected to the air line, and the cross-flow air pressure sensor may be configured to communicate pneumatically with the air line via the fitting. In some aspects, the air line connecting the one or more air springs of the first pneumatic circuit and the one or more air springs of the second pneumatic circuit may have a smaller diameter than the cross-flow passage. In some aspects, the fitting may be a T-fitting. In some aspects, the system may further include one or more air lines that connect the cross-flow air pressure sensor to the fitting for pneumatic communication between the cross-flow air pressure sensor and the air line connecting the one or more air springs of the first pneumatic circuit and the one or more air springs of the second pneumatic circuit. In some aspects, the air line may include a first back flow preventer on one side of the fitting and a second back flow preventer on the other side of the fitting, the first back flow preventer may be configured to prevent air from the one or more air springs of the second pneumatic circuit from flowing into the one or more air springs of the first pneumatic circuit via the air line, and the second back flow preventer may be configured to prevent air from the one or more air springs of the first pneumatic circuit from flowing into the one or more air springs of the second pneumatic circuit via the air line. In some aspects, the cross-flow pressure information may be indicative of the air pressure within the cross-flow passage when the first and second leveling valves have established pneumatic communication between the first and second pneumatic circuits via the cross-flow passage, and the cross-flow pressure information may be indicative of the higher of (i) an air pressure within one or more air springs of the first pneumatic circuit and (ii) an air pressure within one or more air springs of the second pneumatic circuit when the first and second leveling valves are adjusting independently the height of the first and second sides of the vehicle or the trailer.

In some aspects, the first pneumatic circuit may include a first air spring disposed on the first side of the vehicle or the trailer, and the system may further include a first air spring air pressure sensor configured to output first air spring pressure information indicative of an air pressure within the first air spring. In some aspects, the computer may be configured to use the speed and/or acceleration information, the cross-flow pressure information, and the first air spring pressure information to calculate the first and second brake application levels. In some aspects, the second pneumatic circuit may include a second air spring disposed on the second side of the vehicle or the trailer, and the system may further include a second air spring air pressure sensor configured to output second air spring pressure information indicative of an air pressure within the second air spring. In some aspects, the computer may be configured to use the speed and/or acceleration information, the cross-flow pressure information, the first air spring pressure information, and the second air spring pressure information to calculate the first and second brake application levels.

In some aspects, the first and second brake application levels may be brake application pressure levels. In some aspects, the speed and/or acceleration information may include speed information indicative of the speed of the vehicle and/or the trailer and acceleration information indicative of an acceleration of the vehicle and/or the trailer, and the computer may be configured to use the speed information, the acceleration information, and the cross-flow pressure information to calculate the first and second brake application levels. In some aspects, the speed information may include wheel rotational speed information for one or more wheels of the vehicle or the trailer. In some aspects, the acceleration information may include lateral acceleration information.

In some aspects, the cross-flow passage may be a vehicle cross-flow passage, the cross-flow air pressure sensor may be a vehicle cross-flow air pressure sensor, the cross-flow pressure information may be vehicle cross-flow pressure information, the first and second brake application levels may be first and second vehicle brake application levels, and the first and second brakes may be first and second vehicle brakes. The computer may be further configured to: receive trailer cross-flow pressure information indicative of an air pressure within a trailer cross-flow passage of a trailer; use the speed and/or acceleration information, the vehicle cross-flow pressure information, and the trailer cross-flow pressure information to calculate the first and second vehicle brake application levels and first and second trailer brake application levels; apply the calculated first trailer brake application level to a first trailer brake on a first side of the trailer; and apply the calculated second trailer brake application level to a second trailer brake on a second side of the trailer.

In some aspects, the first and second pneumatic circuits may be first and second vehicle pneumatic circuits, and the system may further include: the trailer cross-flow passage; a trailer cross-flow air pressure sensor configured to output the trailer cross-flow pressure information indicative of the air pressure within the trailer cross-flow passage; a first trailer pneumatic circuit having a first trailer leveling valve configured to adjust independently a height of the first side of the trailer; and a second trailer pneumatic circuit having a second trailer leveling valve configured to adjust independently a height of the second side of the trailer. The trailer cross-flow passage may connect the first trailer leveling valve and the second trailer leveling valve, and the first and second trailer leveling valves may be configured to establish pneumatic communication between the first and second trailer pneumatic circuits via the trailer cross-flow passage when neither the first trailer leveling valve is adjusting independently the height of the first side of the trailer nor the second trailer leveling valve is adjusting independently the height of the second side of the trailer. In some aspects, the computer may be further configured to (i) receive a brake pedal pressure signal indicative of a pressure applied to a brake pedal of the vehicle and (ii) use the brake pedal pressure signal, the speed and/or acceleration information, the vehicle cross-flow pressure information, and the trailer cross-flow pressure information to calculate the first and second vehicle brake application levels and the first and second trailer brake application levels.

In some aspects, the computer may be further configured to (i) receive a brake pedal pressure signal indicative of a pressure applied to a brake pedal of the vehicle and (ii) use the brake pedal pressure signal, the speed and/or acceleration information, and the cross-flow pressure information to calculate the first and second brake application levels.

Still another aspect of the invention relates to a braking control method including using one or more speed and/or acceleration sensors to output speed and/or acceleration information indicative of a speed and/or acceleration of a vehicle and/or a trailer. The braking control method may include using a cross-flow air pressure sensor to output cross-flow pressure information indicative of an air pressure within a cross-flow passage connecting a first leveling valve of a first pneumatic circuit with a second leveling valve of a second pneumatic circuit. The first level circuit may be configured to adjust independently a height of a first side of the vehicle or the trailer, the second leveling valve may be configured to adjust independently a height of a second side of the vehicle or the trailer, and the first and second leveling valves may be configured to establish pneumatic communication between the first and second pneumatic circuits via the cross-flow passage when neither the first leveling valve is adjusting independently the height of the first side nor the second leveling valve is adjusting independently the height of the second side. The braking control method may include using a computer to use the speed and/or acceleration information and the cross-flow pressure information to calculate first and second brake application levels. The braking control method may include using the computer to apply the calculated first brake application level to a first brake on the first side of the vehicle or the trailer. The braking control method may include using the computer to apply the calculated second brake application level to a second brake on the second side of the vehicle or the trailer.

In some aspects, the method may further include: using the first leveling valve to adjust independently the height of the first side of the vehicle or the trailer; and using the second leveling valve to adjust independently the height of the second side of the vehicle or the trailer. In some aspects, the method may further include using the first and second leveling valves to establish pneumatic communication between the first and second pneumatic circuits via the cross-flow passage when neither the first leveling valve is adjusting independently the height of the first side nor the second leveling valve is adjusting independently the height of the second side.

In some aspects, the first pneumatic circuit may include a first air spring disposed on the first side of the vehicle or the trailer, and the method may further include using a first air spring air pressure sensor to output first air spring pressure information indicative of an air pressure within the first air spring. In some aspects, the method may further include using the computer to use the speed and/or acceleration information, the cross-flow pressure information, and the first air spring pressure information to calculate the first and second brake application levels. In some aspects, the second pneumatic circuit may include a second air spring disposed on the second side of the vehicle or the trailer, and the method may further include using a second air spring air pressure sensor to output second air spring pressure information indicative of an air pressure within the second air spring. In some aspects, the method may further include using the computer to use the speed and/or acceleration information, the cross-flow pressure information, the first air spring pressure information, and the second air spring pressure information to calculate the first and second brake application levels.

In some aspects, the first and second brake application levels may be brake application pressure levels. In some aspects, the speed and/or acceleration information may include speed information indicative of the speed of the vehicle and/or the trailer and acceleration information indicative of an acceleration of the vehicle and/or the trailer, and the computer may use the speed information, the acceleration information, and the cross-flow pressure information to calculate the first and second brake application levels. In some aspects, the speed information may include wheel rotational speed information for one or more wheels of the vehicle and/or the trailer. In some aspects, the acceleration information may include lateral acceleration information.

In some aspects, the cross-flow passage may be a vehicle cross-flow passage, the cross-flow air pressure sensor may be a vehicle cross-flow air pressure sensor, the cross-flow pressure information may be vehicle cross-flow pressure information, the first and second brake application levels may be first and second vehicle brake application levels, the first and second brakes may be first and second vehicle brakes, and the first and second pneumatic circuits may be first and second vehicle pneumatic circuits. The method may further include receiving trailer cross-flow pressure information indicative of an air pressure within a trailer cross-flow passage of a trailer. The trailer cross-flow passage may connect a first trailer leveling valve of a first trailer pneumatic circuit with a second trailer leveling valve of a second trailer pneumatic circuit, the first trailer level circuit may be configured to adjust independently a height of a first side of the trailer, the second trailer leveling valve may be configured to adjust independently a height of a second side of the trailer, and the first and second trailer leveling valves may be configured to establish pneumatic communication between the first and second trailer pneumatic circuits via the trailer cross-flow passage when neither the first trailer leveling valve is adjusting independently the height of the first side of the trailer nor the second trailer leveling valve is adjusting independently the height of the second side of the trailer. The method may further include using the speed and/or acceleration information, the vehicle cross-flow pressure information, and the trailer cross-flow pressure information to calculate the first and second vehicle brake application levels and first and second trailer brake application levels. The method may further include applying the calculated first trailer brake application level to a first trailer brake on the first side of the trailer. The method may further include applying the calculated second trailer brake application level to a second trailer brake on the second side of the trailer.

In some aspects, the method may further include using a trailer cross-flow air pressure sensor to output the trailer cross-flow pressure information indicative of the air pressure within the trailer cross-flow passage. In some aspects, the method may further include: using the first trailer pneumatic circuit having the first trailer leveling valve to adjust independently the height of the first side of the trailer; and using the second trailer pneumatic circuit having the second trailer leveling valve to adjust independently the height of the second side of the trailer. In some aspects, the method may further include using the first and second trailer leveling valves to establish pneumatic communication between the first and second trailer pneumatic circuits via the trailer cross-flow passage when neither the first trailer leveling valve is adjusting independently the height of the first side of the trailer nor the second trailer leveling valve is adjusting independently the height of the second side of the trailer.

In some aspects, the braking control method may further include using a computer to receive a brake pedal pressure signal indicative of a pressure applied to a brake pedal of the vehicle, and the computer uses the brake pedal pressure signal, the speed and/or acceleration information, and the cross-flow pressure information to calculate the first and second brake application levels.

Yet another aspect of the invention relates to a load monitoring system including a first pneumatic circuit, a second pneumatic circuit, an air pressure sensor, an analog-to-digital converter (ADC), and a computer. The first pneumatic circuit may have a first leveling valve configured to adjust independently a height of a first side of a vehicle or a trailer. The first pneumatic circuit may include a first air spring disposed on the first side. The second pneumatic circuit may have a second leveling valve configured to adjust independently a height of a second side of the vehicle or the trailer. The second pneumatic circuit may include a second air spring disposed on the second side. The air pressure sensor may be configured to output pressure information indicative of an air pressure that is different than both an air pressure within the first air spring and an air pressure within the second air spring at least when the first leveling valve is adjusting independently the height of the first side and the second leveling valve is adjusting independently the height of the second side. The ADC may be configured to convert the pressure information into digital pressure information. The computer may be configured to use the digital pressure information to calculate a weight on one or more axles of the vehicle or the trailer. The calculated weight may have less variation than an air spring-based weight calculated using pressure information indicative of an air pressure within the first air spring or the second air spring.

In some aspects, the system may further include a cross-flow passage that connects the first leveling valve and the second leveling valve, the pressure information output by the air pressure sensor may be indicative of an air pressure within the cross-flow passage, the calculated weight may be a cross-flow-based weight, and the first and second leveling valves may be configured to establish pneumatic communication between the first and second pneumatic circuits via the cross-flow passage when neither the first leveling valve is adjusting independently the height of the first side nor the second leveling valve is adjusting independently the height of the second side. In some aspects, a variation of the calculated weight may be less than 30% (and preferably less than 25% and more preferably less than 20%) of a variation of the air spring-based weight.

Still another aspect of the invention relates to a load monitoring method including using a first leveling valve of a first pneumatic circuit to adjust independently the height of a first side of the vehicle or the trailer. The first pneumatic circuit may include a first air spring disposed on the first side. The method may include using a second leveling valve of a second pneumatic circuit to adjust independently the height of a second side of the vehicle or the trailer. The second pneumatic circuit may include a second air spring disposed on the second side. The method may include using an air pressure sensor to output pressure information indicative of an air pressure that is different than both an air pressure within the first air spring and an air pressure within the second air spring at least when the first leveling valve is adjusting independently the height of the first side and the second leveling valve is adjusting independently the height of the second side. The method may include using an analog-to-digital converter (ADC) to convert the pressure information into digital pressure information. The method may include using a computer to use the digital pressure information to calculate a weight on one or more axles of the vehicle or the trailer, wherein the calculated weight has less variation than an air spring-based weight calculated using pressure information indicative of an air pressure within the first air spring or the second air spring.

In some aspects, the method may further include using the first and second leveling valves to establish pneumatic communication between the first and second pneumatic circuits via a cross-flow passage that connects the first leveling valve and the second leveling valve when neither the first leveling valve is adjusting independently the height of the first side nor the second leveling valve is adjusting independently the height of the second side, the pressure information output by the air pressure sensor may be indicative of an air pressure within the cross-flow passage, and the calculated weight may be a cross-flow-based weight. In some aspects, a variation of the calculated weight may be less than 30% (and preferably less than 25% and more preferably less than 20%) of a variation of the air spring-based weight.

Yet another aspect of the invention relates to a load monitoring system including a first pneumatic circuit, a second pneumatic circuit, an air pressure sensor, an analog-to-digital converter (ADC), and a computer. The first pneumatic circuit may have a first leveling valve configured to adjust independently a height of a first side of a vehicle or a trailer. The first pneumatic circuit may include a first air spring disposed on the first side. The second pneumatic circuit may have a second leveling valve configured to adjust independently a height of a second side of the vehicle or the trailer. The second pneumatic circuit may include a second air spring disposed on the second side. The air pressure sensor may be configured to output pressure information indicative of an air pressure that is different than both an air pressure within the first air spring and an air pressure within the second air spring at least when the first leveling valve is adjusting independently the height of the first side and the second leveling valve is adjusting independently the height of the second side. The ADC may be configured to convert the pressure information into digital pressure information. The computer may be configured to use the digital pressure information to calculate a weight on one or more axles of the vehicle or the trailer. The calculated weight is less affected by one or more events that cause the first and/or second leveling valves to adjust independently the height of the first and/or second sides of the vehicle or the trailer than an air spring-based weight calculated using pressure information indicative of an air pressure within the first air spring or the second air spring.

In some aspects, the system may further include a cross-flow passage that connects the first leveling valve and the second leveling valve, the pressure information output by the air pressure sensor may be indicative of an air pressure within the cross-flow passage, the calculated weight may be a cross-flow-based weight, and the first and second leveling valves may be configured to establish pneumatic communication between the first and second pneumatic circuits via the cross-flow passage when neither the first leveling valve is adjusting independently the height of the first side nor the second leveling valve is adjusting independently the height of the second side. In some aspects, the one or more events include non-zero lateral acceleration of the vehicle or the trailer.

Yet another aspect of the invention relates to a load monitoring method including using a first leveling valve of a first pneumatic circuit to adjust independently the height of a first side of the vehicle or the trailer. The first pneumatic circuit may include a first air spring disposed on the first side. The method may include using a second leveling valve of a second pneumatic circuit to adjust independently the height of a second side of the vehicle or the trailer. The second pneumatic circuit may include a second air spring disposed on the second side. The method may include using an air pressure sensor to output pressure information indicative of an air pressure that is different than both an air pressure within the first air spring and an air pressure within the second air spring at least when the first leveling valve is adjusting independently the height of the first side and the second leveling valve is adjusting independently the height of the second side. The method may include using an analog-to-digital converter (ADC) to convert the pressure information into digital pressure information. The method may include using a computer to use the digital pressure information to calculate a weight on one or more axles of the vehicle or the trailer. The calculated weight may be less affected by one or more events that cause the first and/or second leveling valves to adjust independently the height of the first and/or second sides of the vehicle or the trailer than an air spring-based weight calculated using pressure information indicative of an air pressure within the first air spring or the second air spring.

In some aspects, the method may further include using the first and second leveling valves to establish pneumatic communication between the first and second pneumatic circuits via a cross-flow passage that connects the first leveling valve and the second leveling valve when neither the first leveling valve is adjusting independently the height of the first side nor the second leveling valve is adjusting independently the height of the second side, and the pressure information output by the air pressure sensor may be indicative of an air pressure within the cross-flow passage, and the calculated weight is a cross-flow-based weight. In some aspects, the one or more events may include non-zero lateral acceleration of the vehicle or the trailer.

Still another aspect of the invention relates to a braking control system including a first pneumatic circuit, a second pneumatic circuit, one or more first brakes, and one or more second brakes. The first pneumatic circuit may have a first leveling valve configured to adjust independently a height of a first side of a vehicle or a trailer. The second pneumatic circuit may have a second leveling valve configured to adjust independently a height of a second side of the vehicle or the trailer. The one or more first brakes may be on the first side of the vehicle or the trailer. The one or more second brakes may be on the second side of the vehicle or the trailer. The braking control system may be configured to apply a brake application level to the one or more first brakes and the one or more second brakes, and the braking control system may be configured to apply only the same brake application level to both the one or more first brakes and the one or more second brakes.

In some aspects, the brake application level may be based on a pressure applied to a brake pedal. In some aspects, the system may further include a cross-flow passage that connects the first leveling valve and the second leveling valve, and the first and second leveling valves may be configured to establish pneumatic communication between the first and second pneumatic circuits via the cross-flow passage when neither the first leveling valve is adjusting independently the height of the first side nor the second leveling valve is adjusting independently the height of the second side. In some aspects, the brake application level may be based on only the pressure applied to the brake pedal. In some aspects, the brake application level may be based on (1) speed and/or acceleration information indicative of a speed and/or acceleration of the vehicle and/or the trailer and/or (2) pressure information indicative of an air pressure within (a) an air spring of the first or second pneumatic circuits or (b) a cross-flow passage connecting the first and second leveling valves.

Yet another aspect of the invention relates to a braking control method including using a first leveling valve of a first pneumatic circuit to adjust independently the height of a first side of the vehicle or the trailer. The method may include using a second leveling valve of a second pneumatic circuit to adjust independently the height of a second side of the vehicle or the trailer. The method may include applying a brake application level to (i) one or more first brakes on the first side of the vehicle or the trailer and (ii) one or more second brakes on the second side of the vehicle or the trailer, and only the same brake application level may be applied to both the one or more first brakes and the one or more second brakes.

In some aspects, the brake application level may be based on a pressure applied to a brake pedal. In some aspects, the method may further include using the first and second leveling valves to establish pneumatic communication between the first and second pneumatic circuits via a cross-flow passage that connects the first leveling valve and the second leveling valve when neither the first leveling valve is adjusting independently the height of the first side nor the second leveling valve is adjusting independently the height of the second side. In some aspects, the brake application level may be based on only the pressure applied to the brake pedal. In some aspects, the brake application level may be based on (1) speed and/or acceleration information indicative of a speed and/or acceleration of the vehicle and/or the trailer and/or (2) pressure information indicative of an air pressure within (a) an air spring of the first or second pneumatic circuits or (b) a cross-flow passage connecting the first and second leveling valves.

Still another aspect of the invention relates to a system including (1) a first pneumatic circuit and (2) a second pneumatic circuit. The first pneumatic circuit may include: (1A) a first air spring, (1B) a second air spring, (1C) a third air spring, (1D) a first air line, (1E) a second air line, (1F) a first leveling valve. The first air spring may be configured to support a first axle of a vehicle or a trailer on a first side of the vehicle or the trailer. The second air spring may be configured to support a second axle of the vehicle or the trailer on the first side of the vehicle or the trailer. The third air spring may be configured to support a third axle of the vehicle or the trailer on the first side of the vehicle or the trailer. The second axle may be located between the first and third axles. The first air line may connect the first and second air springs of the first pneumatic circuit. The second air line may connect second and third air springs of the first pneumatic circuit. The first leveling valve may be configured to adjust independently a height of the first side of the vehicle or the trailer by increasing or decreasing an amount of air in the first, second, and third air springs of the first pneumatic circuit. The second pneumatic circuit may include: (2A) a first air spring, (2B) a second air spring, (2C) a third air spring, (2D) a first air line, (2E) a second air line, and (2F) a second leveling valve. The first air spring of the second pneumatic circuit may be configured to support the first axle of the vehicle or the trailer on a second side of the vehicle or the trailer. The second air spring of the second pneumatic circuit may be configured to support the second axle of the vehicle or the trailer on the second side of the vehicle or the trailer. The third air spring of the second pneumatic circuit may be configured to support the third axle of the vehicle or the trailer on the second side of the vehicle or the trailer. The first air line of the second pneumatic circuit may connect the first and second air springs of the second pneumatic circuit. The second air line of the second pneumatic circuit may connect the second and third air springs of the second pneumatic circuit. The second leveling valve of the second pneumatic circuit may be configured to adjust independently a height of the second side of the vehicle or the trailer by increasing or decreasing an amount of air in the first, second, and third air springs of the second pneumatic circuit.

In some aspects, the first and second air lines of the first pneumatic circuit may be configured to enable front-to-back and/or back-to-front air flow between the first, second, and third air springs of the first pneumatic circuit, and the first and second air lines of the second pneumatic circuit may be configured to enable front-to-back and/or back-to-front air flow between the first, second, and third air springs of the second pneumatic circuit. In some aspects, the second air spring of the first pneumatic circuit may be configured to act as a reservoir between the first and third air springs of the first pneumatic circuit, and the second air spring of the second pneumatic circuit may be configured to act as a reservoir between the first and third air springs of the second pneumatic circuit. In some aspects, air added to the first and third air springs of the first pneumatic circuit may pass through the second air spring of the first pneumatic circuit before reaching the first and third air springs of the first pneumatic circuit, and air added to the first and third air springs of the second pneumatic circuit may pass through the second air spring of the second pneumatic circuit before reaching the first and third air springs of the second pneumatic circuit. In some aspects, the system may further include a cross-flow passage that connects the first leveling valve and the second leveling valve, and the first and second leveling valves are configured to establish pneumatic communication between the first and second pneumatic circuits via the cross-flow passage when neither the first leveling valve is adjusting independently the height of the first side nor the second leveling valve is adjusting independently the height of the second side.

In the various aspects of the invention set forth above, the first pneumatic circuit may include: (1A) a first air spring, (1B) a second air spring, (1C) a third air spring, (1D) a first air line, (1E) a second air line, (1F) a first leveling valve. The first air spring may be configured to support a first axle of a vehicle or a trailer on a first side of the vehicle or the trailer. The second air spring may be configured to support a second axle of the vehicle or the trailer on the first side of the vehicle or the trailer. The third air spring may be configured to support a third axle of the vehicle or the trailer on the first side of the vehicle or the trailer. The second axle may be located between the first and third axles. The first air line may connect the first and second air springs of the first pneumatic circuit. The second air line may connect second and third air springs of the first pneumatic circuit. The first leveling valve may be configured to adjust independently a height of the first side of the vehicle or the trailer by increasing or decreasing an amount of air in the first, second, and third air springs of the first pneumatic circuit. The second pneumatic circuit may include: (2A) a first air spring, (2B) a second air spring, (2C) a third air spring, (2D) a first air line, (2E) a second air line, and (2F) a second leveling valve. The first air spring of the second pneumatic circuit may be configured to support the first axle of the vehicle or the trailer on a second side of the vehicle or the trailer. The second air spring of the second pneumatic circuit may be configured to support the second axle of the vehicle or the trailer on the second side of the vehicle or the trailer. The third air spring of the second pneumatic circuit may be configured to support the third axle of the vehicle or the trailer on the second side of the vehicle or the trailer. The first air line of the second pneumatic circuit may connect the first and second air springs of the second pneumatic circuit. The second air line of the second pneumatic circuit may connect the second and third air springs of the second pneumatic circuit. The second leveling valve of the second pneumatic circuit may be configured to adjust independently a height of the second side of the vehicle or the trailer by increasing or decreasing an amount of air in the first, second, and third air springs of the second pneumatic circuit. The first leveling valve may be configured to adjust independently the height of the first side of the vehicle or the trailer by increasing or decreasing an amount of air in the first, second, and third air springs of the first pneumatic circuit. The second leveling valve may be configured to adjust independently the height of the second side of the vehicle or the trailer by increasing or decreasing an amount of air in the first, second, and third air springs of the second pneumatic circuit.

In the various aspects of the invention set forth above, the system may further include one or more raise and lower valves configured to enable an operator to manually vary a height of a chassis of the vehicle trailer relative to the ground. In the various aspects of the invention set forth above, the system may further include one or more pressure protection valves. In the various aspects of the invention set forth above, the system may further include one or more dump valves. In the various aspects of the invention set forth above, the system may further include an integrated pressure protection valve unit including an inlet, a first outlet, a second outlet, and an exhaust.

Yet another aspect of the invention relates to a load monitoring system including a cross-flow passage, an air pressure sensor, a first pneumatic circuit, a second pneumatic circuit, an air line, a fitting, a first back flow preventer, and a second back flow preventer. The air pressure sensor may be configured to output pressure information indicative of an air pressure. The first pneumatic circuit may include one or more first air springs and a first leveling valve configured to adjust independently a height of a first side of a vehicle or a trailer. The second pneumatic circuit may include one or more second air springs and a second leveling valve configured to adjust independently a height of a second side of the vehicle or the trailer. The cross-flow passage may connect the first leveling valve and the second leveling valve. The first and second leveling valves may be configured to establish pneumatic communication between the first and second pneumatic circuits via the cross-flow passage when neither the first leveling valve is adjusting independently the height of the first side nor the second leveling valve is adjusting independently the height of the second side. The air line may connect the one or more first air springs and the one or more second air springs. The fitting may be connected to the air line. The air pressure sensor may be configured to communicate pneumatically with the air line via the fitting. The first back flow preventer may be on one side of the fitting. The first back flow preventer may be configured to prevent air from the one or more air springs of the second pneumatic circuit from flowing into the one or more air springs of the first pneumatic circuit via the air line. The second back flow preventer may be on the other side of the fitting. The second back flow preventer may be configured to prevent air from the one or more air springs of the first pneumatic circuit from flowing into the one or more air springs of the second pneumatic circuit via the air line.

In some aspects, the air line connecting the one or more first air springs and the one or more second air springs may have a smaller diameter than the cross-flow passage. In some aspects, the fitting may be a T-fitting. In some aspects, the system may further include one or more air lines that connect the air pressure sensor to the fitting for pneumatic communication between the air pressure sensor and the air line connecting the one or more air springs of the first pneumatic circuit and the one or more air springs of the second pneumatic circuit. In some aspects, the pressure information may be indicative of the air pressure within the cross-flow passage when the first and second leveling valves have established pneumatic communication between the first and second pneumatic circuits via the cross-flow passage, and the pressure information is indicative of the higher of (i) an air pressure within the one or more first air springs and (ii) an air pressure within the one or more second air springs when the first and second leveling valves are adjusting independently the height of the first and second sides of the vehicle or the trailer.

Still another aspect of the invention relates to a system including a first leveling valve, a second leveling valve, and a raise lower valve (RLV). The first leveling valve may be configured to adjust independently a height of a first side of a vehicle or a trailer. The second leveling valve may be configured to adjust independently a height of a second side of the vehicle or the trailer. The RLV may be configured to, in response to a leveling valve height control input, allow the first and second leveling valves to adjust independently the heights of the first and second sides of the vehicle or the trailer. The RLV may be configured to, in response to a raise input, raise the height of one or both of the first and second sides of the vehicle or the trailer and prevent the first and second leveling valves from adjusting independently the heights of the first and second sides of the vehicle or the trailer. The RLV may be configured to, in response to a lower input, lower the height of one or both of the first and second sides of the vehicle or the trailer and prevent the first and second leveling valves from adjusting independently the heights of the first and second sides of the vehicle or the trailer.

Yet another aspect of the invention relates to a method performed by a raise lower valve (RLV). The method may include, in response to a leveling valve height control input, allowing a first leveling valve to adjust independently a height of a first side of a vehicle or a trailer and a second leveling valve to adjust independently a height of a second side of the vehicle or the trailer. The method may include, in response to a raise input, raising the height of one or both of the first and second sides of the vehicle or the trailer and preventing the first and second leveling valves from adjusting independently the heights of the first and second sides of the vehicle or the trailer. The method may include, in response to a lower input, lowering the height of one or both of the first and second sides of the vehicle or the trailer and preventing the first and second leveling valves from adjusting independently the heights of the first and second sides of the vehicle or the trailer.

Still another aspect of the invention relates to a raise lower valve (RLV) including one or more housings including one or more passages, one or more supply seals in the one or more passages, one or more delivery seals in the one or more passages, a first actuator, a second actuator, and a controller. The first actuator may be configured to move the one or more supply seals in the one or more passages. The second actuator may be configured to move the one or more delivery seals in the one or more passages. The controller may be configured to control the first and second actuators to move the one or more supply seals and the one or more delivery seals in the one or more passages.

Yet another aspect of the invention relates to a method performed by a raise lower valve (RLV). The method may include using a controller to control a first actuator to move one or more supply seals in one or more passages of one or more housings. The method may include using the controller to control a second actuator to move one or more delivery seals in the one or more passages.

Still another aspect may provide an air management system for a vehicle or trailer. The air management system may include a first pneumatic circuit having a first leveling valve configured to adjust independently a height of a first side of a first axle of the vehicle or the trailer. The air management system may include a second pneumatic circuit having a second leveling valve configured to adjust independently a height of a second side of the first axle of the vehicle or the trailer. The air management system may include a first cross-flow line connecting the first leveling valve with the second leveling valve. The air management system may include a third pneumatic circuit having a third leveling valve configured to adjust independently a height of a third axle of the vehicle or the trailer. The air management system may include a second cross-flow line connecting the third leveling valve with the first cross-flow line. The first, second, and third leveling valves may be configured to establish pneumatic communication between the first, second, and third pneumatic circuits when the first leveling valve is not independently adjusting the height of the first side of the first axle, the second leveling valve is not independently adjusting the height of the second side of the first axle, and the third leveling valve is not independently adjusting the height of the second axle.

In some aspects, the first leveling valve may be further configured to adjust independently a height of a first side of a third axle of the vehicle or the trailer, and the second leveling valve may be further configured to adjust independently a height of a second side of the third axle.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting aspects of the present invention. In the drawings, like reference numbers indicate identical or functionally similar elements.

FIGS. 1A and 1B are side views illustrating a vehicle and trailer embodying aspects of the present invention.

FIGS. 2A, 2B, and 2C are block diagrams illustrating vehicle systems embodying aspects of the present invention.

FIGS. 2D, 2E, 2F, 2G, and 2O are block diagrams illustrating trailer portions of vehicle systems embodying aspects of the present invention.

FIGS. 2H, 2I, 2J, 2K, 2L, 2M, 2N, 2P, and 2Q are block diagrams illustrating pneumatic circuits of trailer portions of vehicle systems embodying aspects of the present invention.

FIG. 2R is a block diagram illustrating a trailer portion of a vehicle system embodying aspects of the present invention.

FIGS. 2S-2U illustrate a side view, top view, and block diagram, respectively, of a two axle trailer embodying aspects of the present invention.

FIGS. 2V-2X illustrate a side view, top view, and block diagram, respectively, of a three axle trailer embodying aspects of the present invention.

FIGS. 3A, 3B, 3C, 3D, and 3E are block diagram illustrating cross-flow air pressure sensors embodying aspects of the present invention.

FIG. 4 is a block diagram illustrating a computer of a vehicle system embodying aspects of the present invention.

FIG. 5A is a flow chart illustrating a braking control process embodying aspects of the present invention.

FIG. 5B is a flow chart illustrating a braking control process embodying aspects of the present invention.

FIG. 6 is a flow chart illustrating a load monitoring process embodying aspects of the present invention.

FIG. 7 is a flow chart illustrating a load monitoring process embodying aspects of the present invention.

FIGS. 8A-8E are block diagrams illustrating a raise and lower valve embodying aspects of the present invention.

FIG. 9 is a flow chart illustrating a raise lower process embodying aspects of the present invention.

FIG. 10 is a block diagram illustrating a raise and lower valve embodying aspects of the present invention.

### DETAILED DESCRIPTION

While the present invention may be embodied in many different forms, a number of illustrative aspects are described herein with the understanding that the present disclosure is to be considered as providing examples of the principles of the invention and such examples are not intended to limit the invention to preferred aspects described herein and/or illustrated herein.

The singular forms “a,” “an,” and “the” include plural referents unless the context clearly dictates otherwise.

In understanding the scope of the present disclosure, the terms “including” or “comprising” and their derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps. It is understood that reference to any one of these transition terms (i.e. “comprising,” “consisting,” or “consisting essentially”) provides direct support for replacement to any of the other transition term not specifically used. For example, amending a term from “comprising” to “consisting essentially of” would find direct support due to this definition.

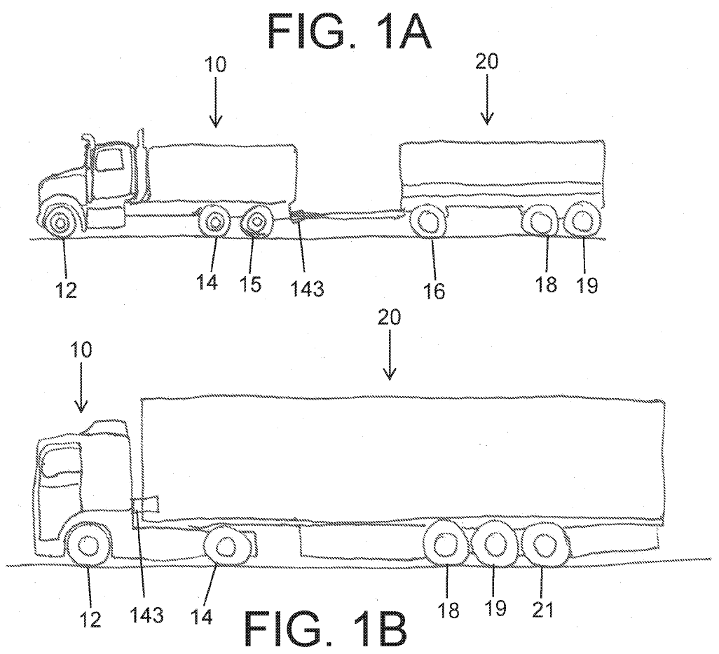

FIG. 1A illustrates a non-limiting aspect of a vehicle 10 (e.g., a car, truck, tractor, or load carrying prime mover) embodying aspects of the present invention. FIG. 1B illustrates an alternative aspect in which the vehicle 10 is a semi-tractor. In some aspects, the vehicle 10 may include one or more wheeled axles (e.g., one or more of axles 12, 14, and 15). In some aspects, the axles may be driven or non-driven. In some aspects, the vehicle 10 may include one or more steering axles 12 (e.g., at the front of the vehicle 10) and one or more drive axles 14 and 15. In some aspects, as shown in the FIGS. 1A and 1B, the vehicle 10 may include one or more trailers 20. In some aspects, a trailer 20 may be a towable of any kind. In some aspects, the trailer 20 may have one or more wheeled axles (e.g., one or more of axles 16, 18, 19, and 21). In some aspects, the trailer axles may include one or more steering axles 16 (e.g., at the front of the trailer 20) and/or one or more drive axles 18, 19, and 21. In some aspects, the vehicle 10 and trailer 20 may communicate via a trailer interface 143, which may include, for example and without limitation, a trailer plug and socket.

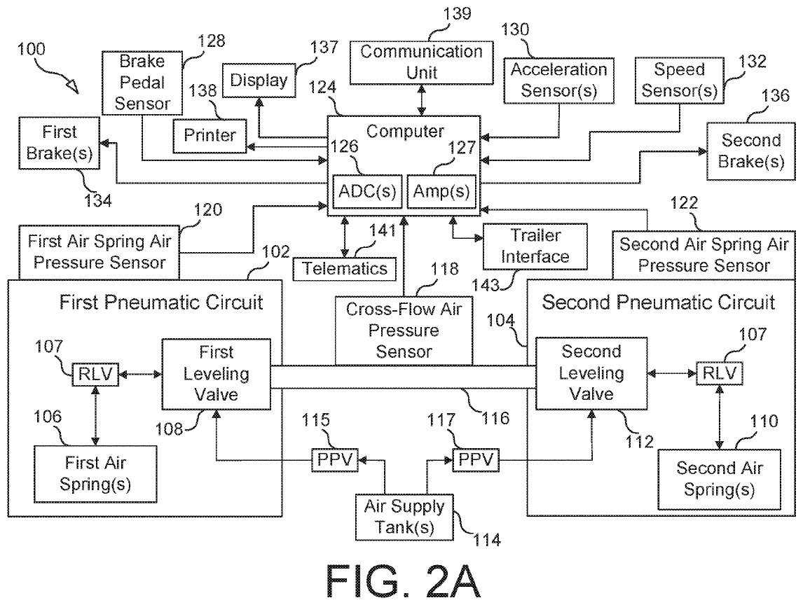

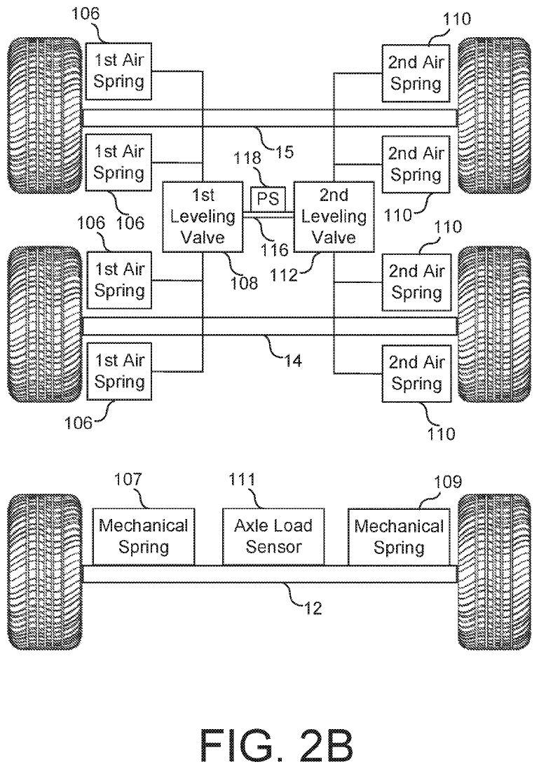

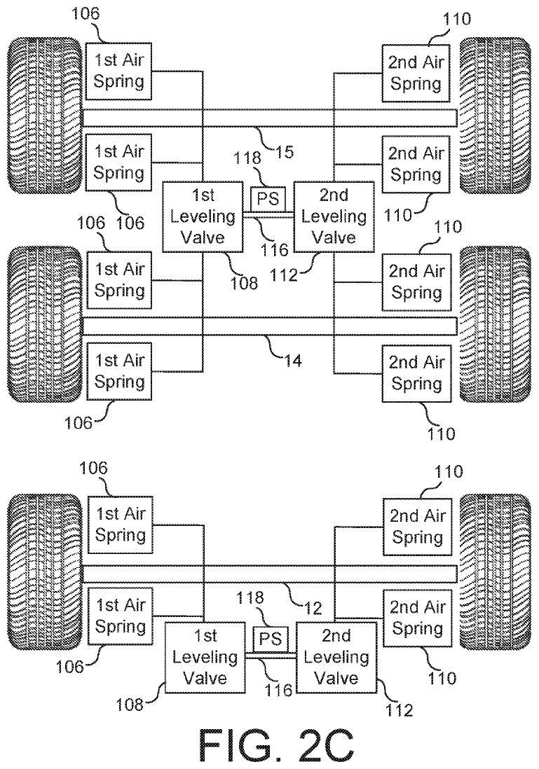

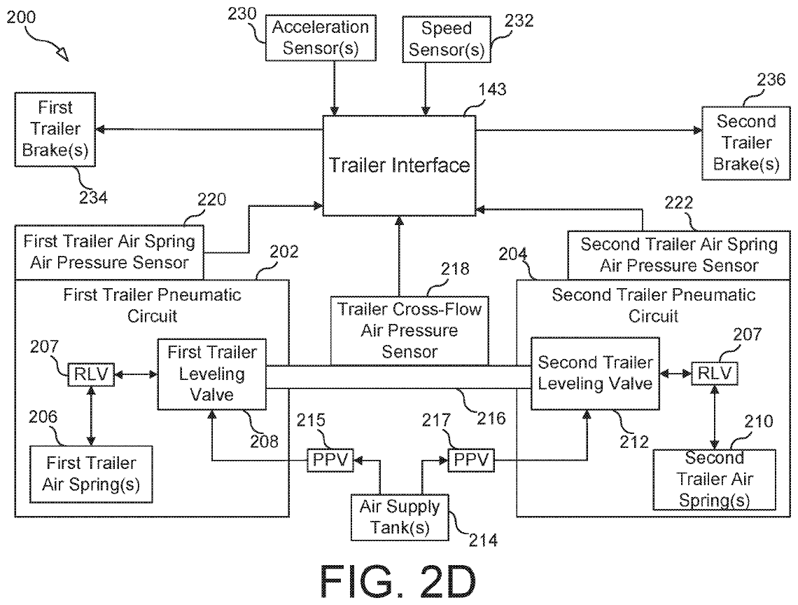

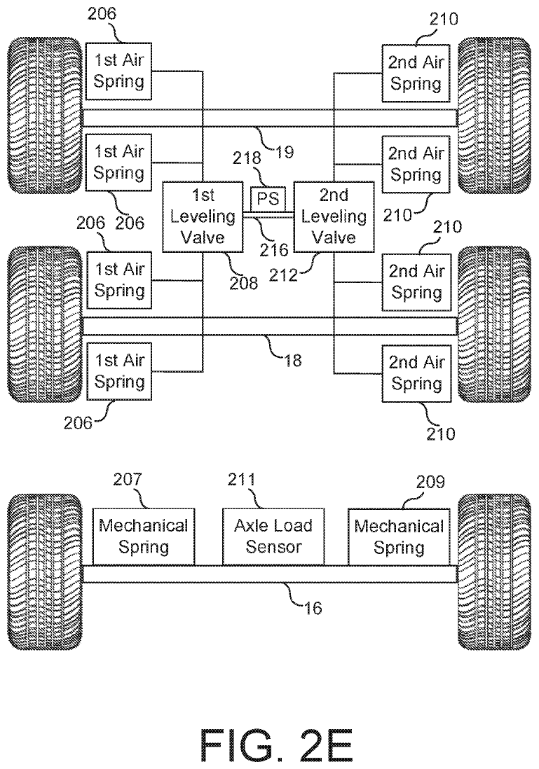

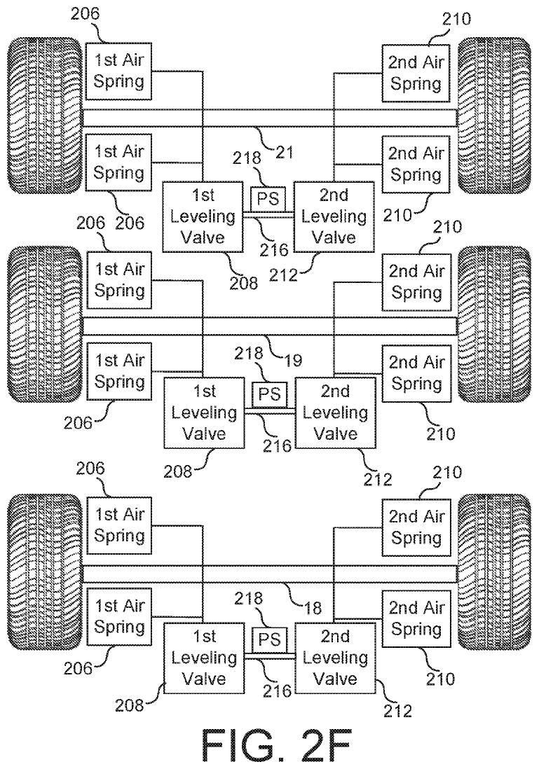

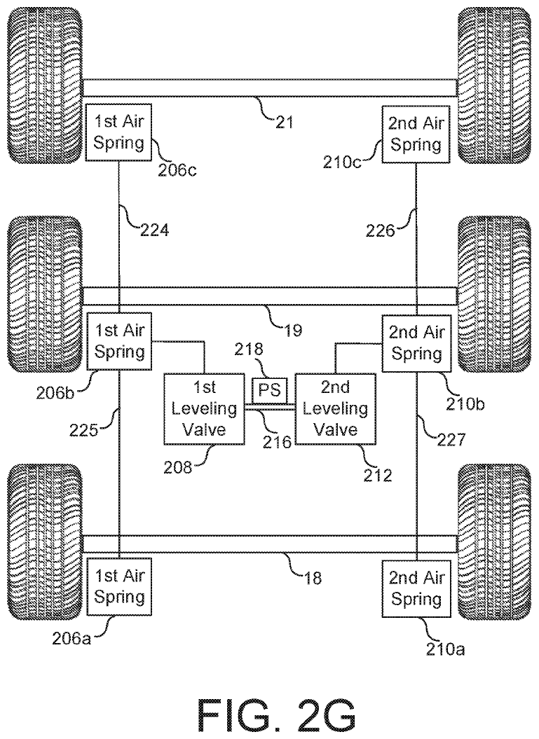

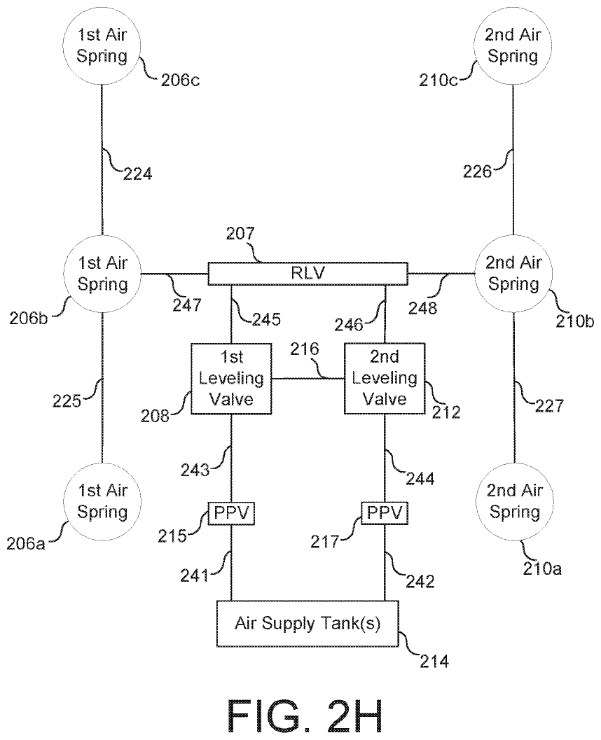

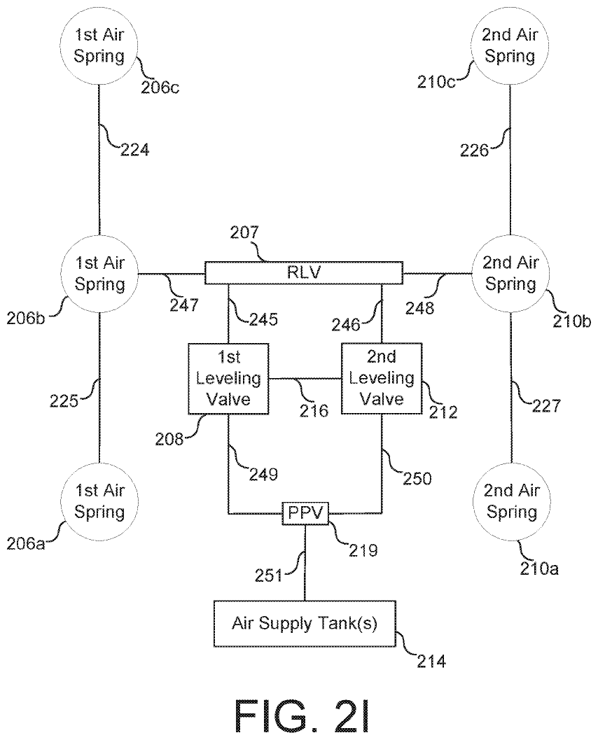

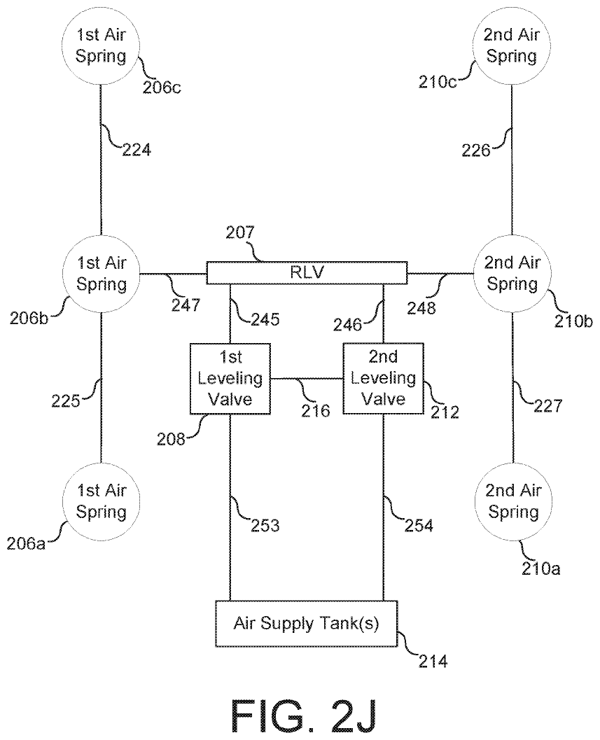

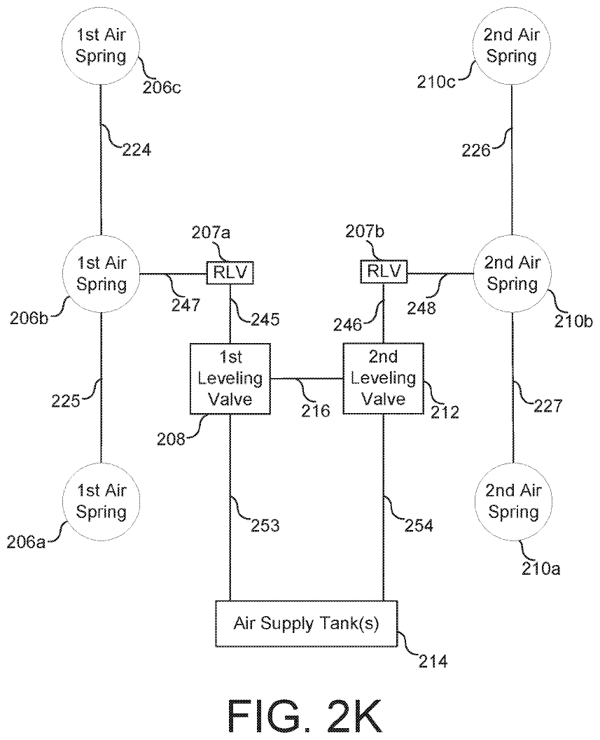

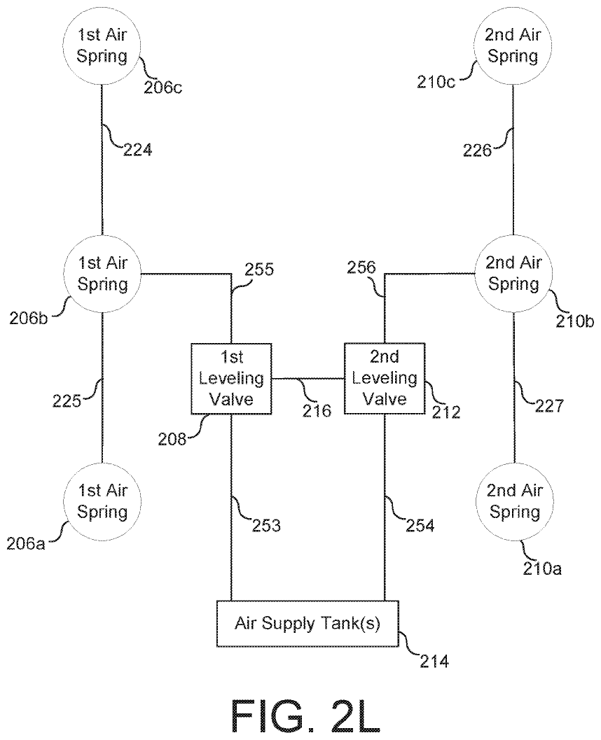

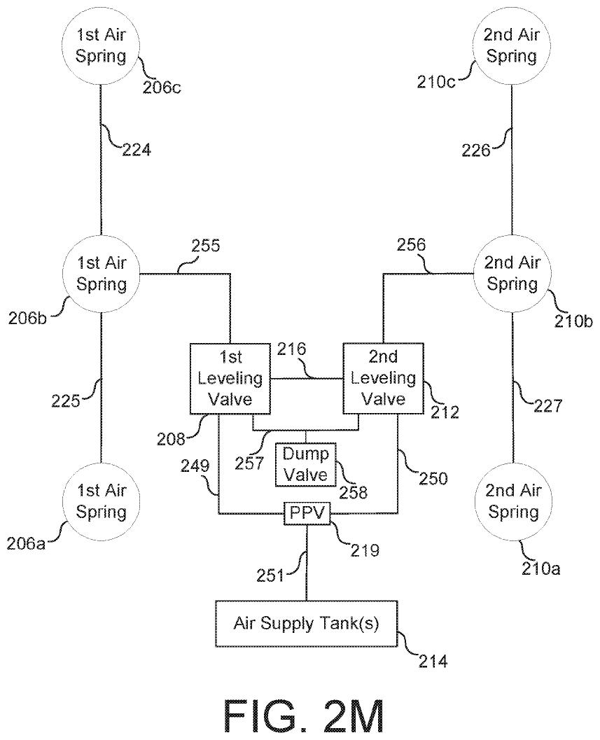

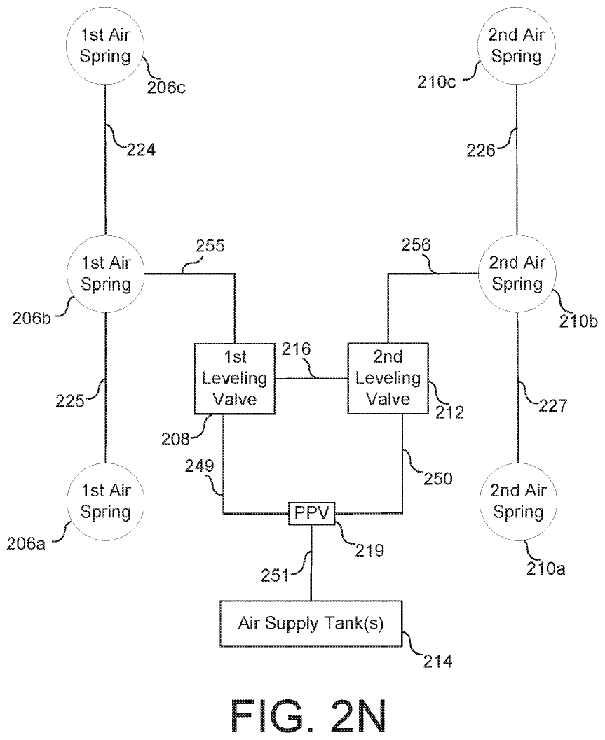

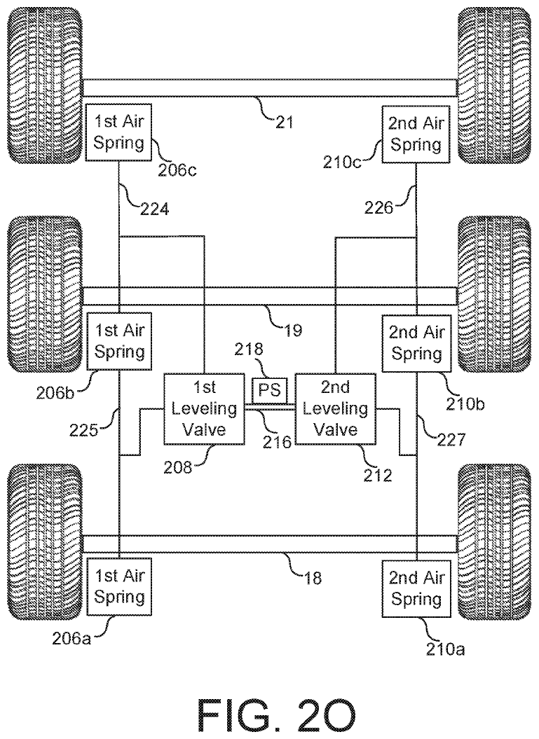

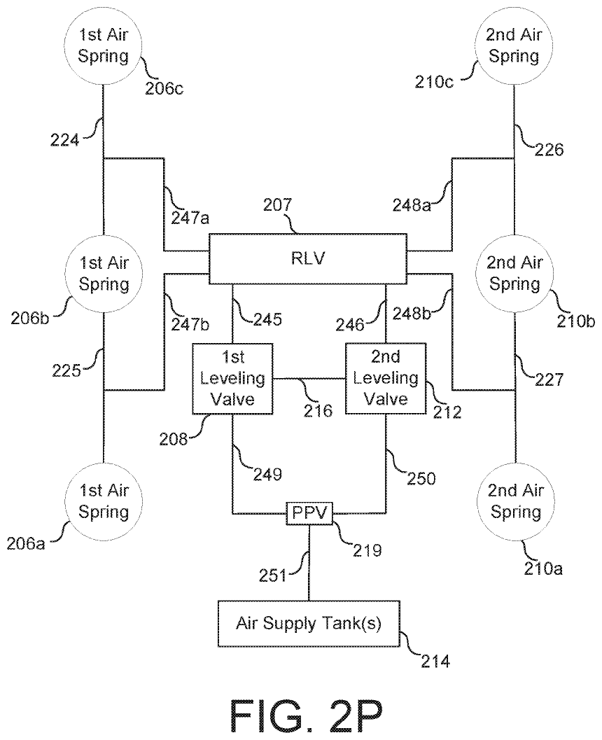

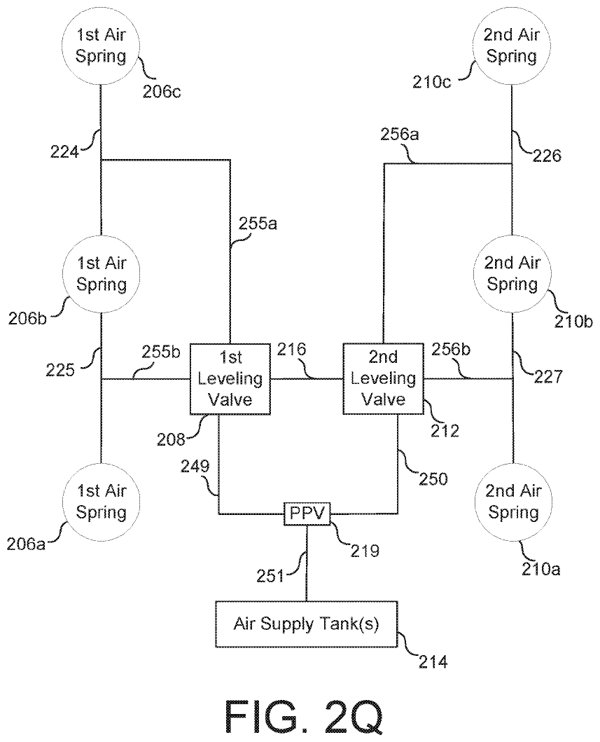

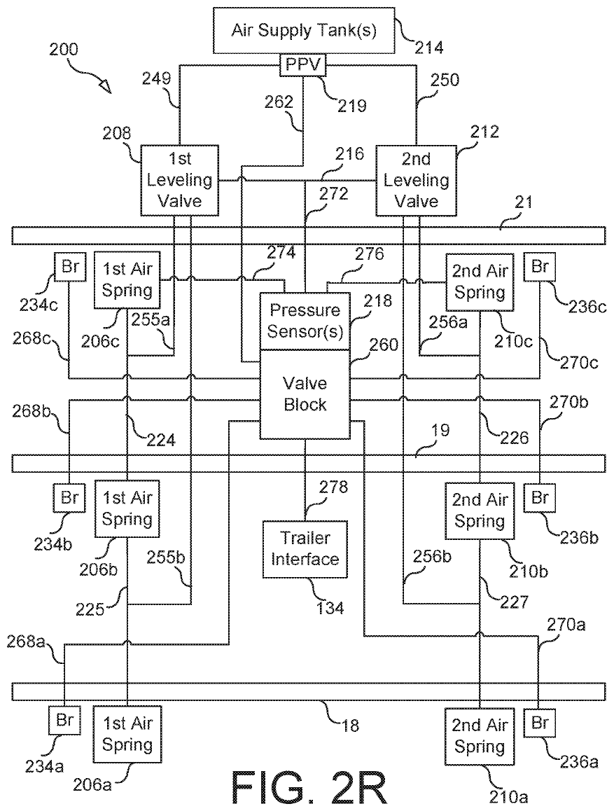

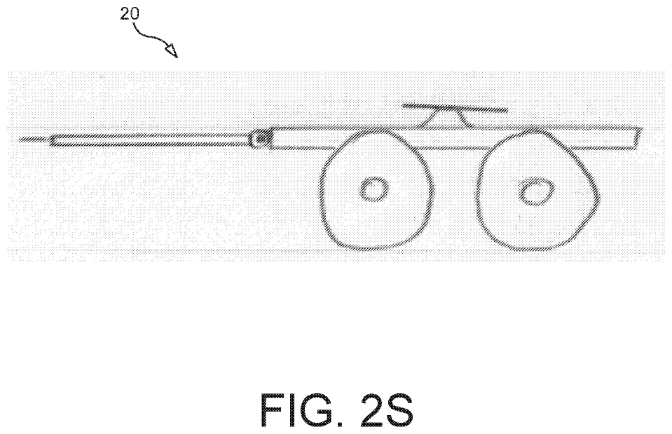

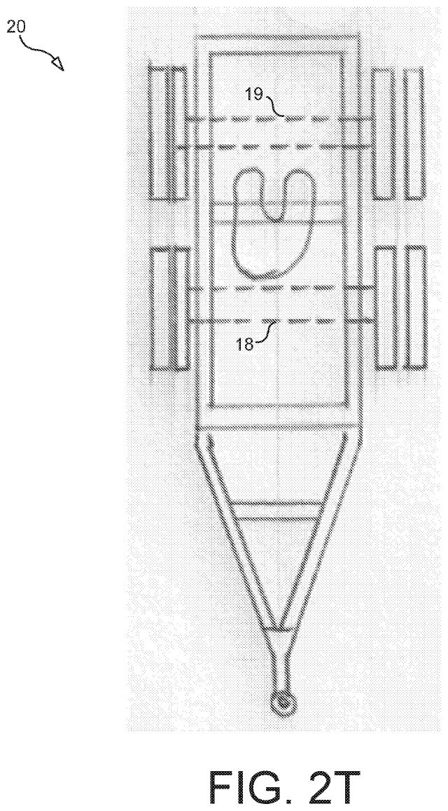

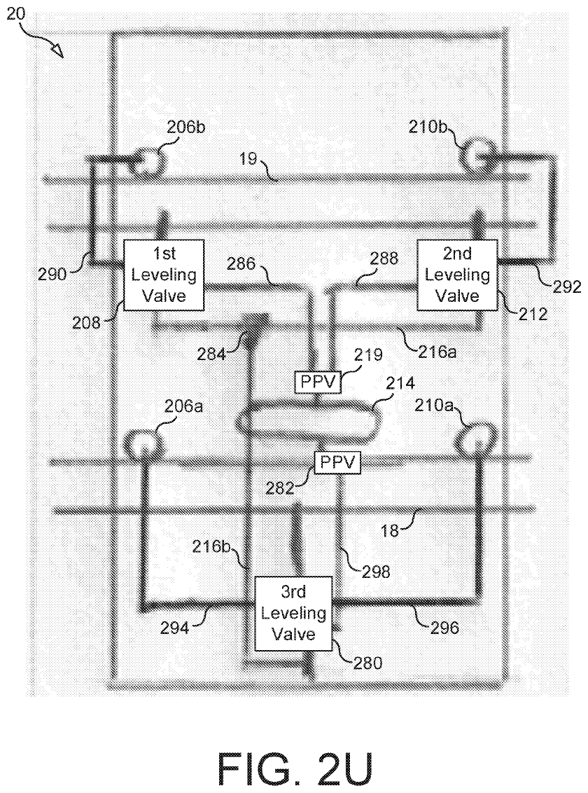

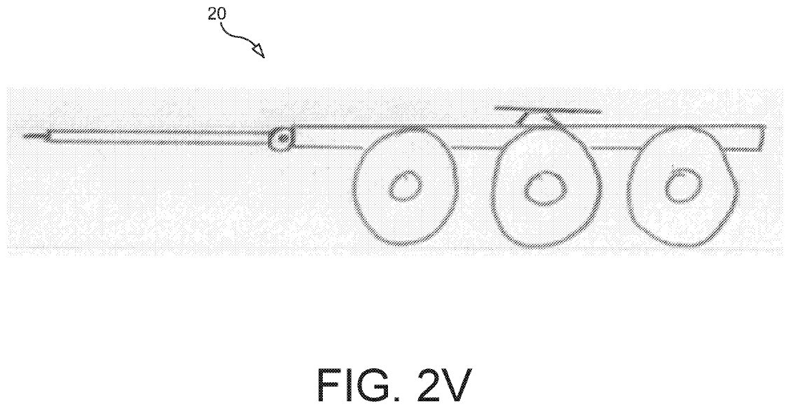

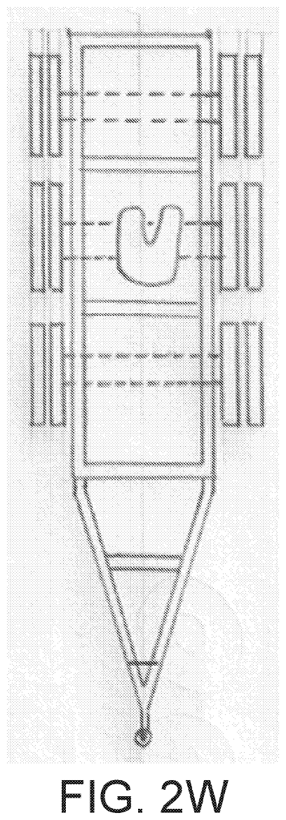

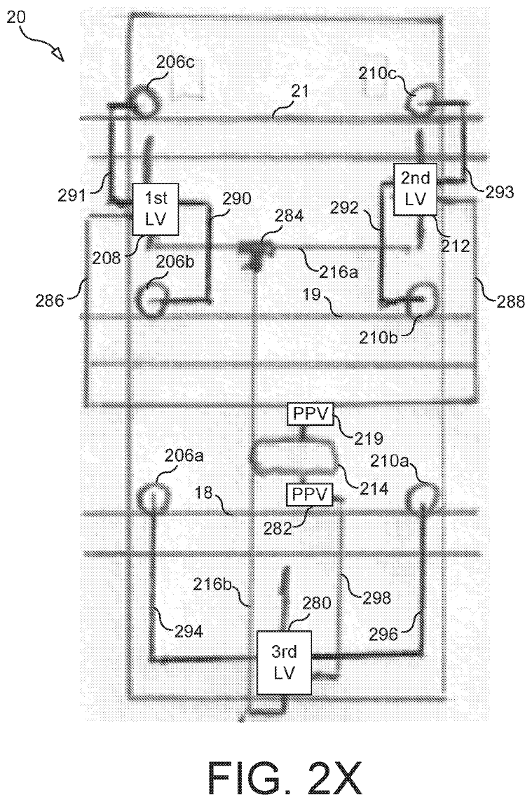

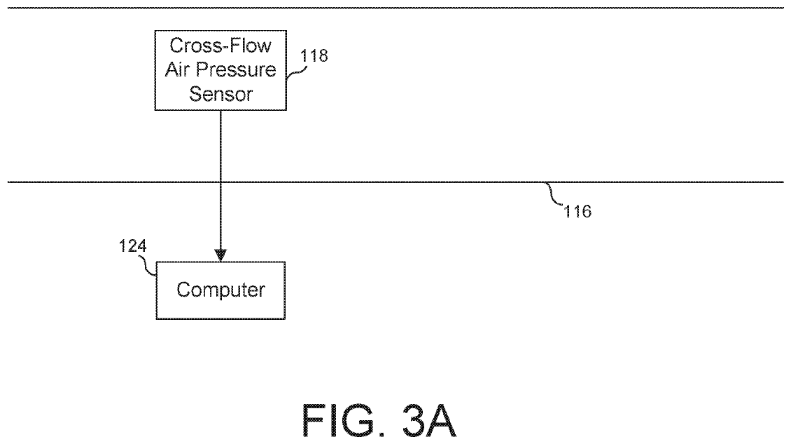

FIG. 2A is a block diagram of a non-limiting aspect of a vehicle system 100. In some aspects, the system 100 may provide braking control for the vehicle 10 and/or trailer 20. In some aspects, the system 100 may additionally or alternatively provide load monitoring for the vehicle 10 and/or trailer 20. In some aspects, the system 100 may additionally or alternatively provide air management for the vehicle 10 and/or trailer 20.

In some aspects, the system 100 may include a first pneumatic circuit 102 and a second pneumatic circuit 104. The first pneumatic circuit 102 may include one or more first air springs 106 (e.g., one or more air bags) and a first leveling valve 108. The second pneumatic circuit 104 may include one or more second air springs 110 and a second leveling valve 112. In some aspects, the first leveling valve 108 may be configured to adjust independently the height of a first side of the vehicle 10 (e.g., by increasing or decreasing air in the one or more first air springs 106), and the second leveling valve 112 may be configured to adjust independently the height of a second side of the vehicle 10 (e.g., by increasing or decreasing air in the one or more second air springs 110). In some aspects, the first and second sides may be opposite sides of the vehicle 10 (e.g., left and right sides). In some aspects, the system 100 may include one or more air supply tanks 114. In some aspects, one or more supply lines may connect the one or more air supply tanks 114 to the first leveling valve 108, and one or more supply lines may connect the one or more air supply tanks 114 to the second leveling valve 112.

In some aspects, the first leveling valve 108 may increase air in the one or more first air springs 106 by supplying air from one or more of the one or more air supply tanks 114, and the second leveling valve 112 may increase air in the one or more second air springs 110 by supplying air from one or more of the one or more air supply tanks 114. In some aspects, the first leveling valve 108 may decrease air in the one or more first air springs 106 by purging air from the one or more first air springs 106 (e.g., allowing air from the one or more first air springs 106 out of an exhaust port), and the second leveling valve 112 may decrease air in the one or more second air springs 110 by purging air from the one or more second air springs 110 (e.g., allowing air from the one or more second air springs 110 out of an exhaust port).

In some aspects, as shown in FIG. 2A, the system 100 may include one or more raise and lower valves (RLVs) 107. In some aspects, the one or more RLVs 107 may enable an operator to manually vary the height of the chassis of the vehicle 10 relative to the ground (e.g., to facilitate height adjustment of the vehicle at the loading dock). In some aspects, although the RLV 107 is shown as two units in FIG. 2A, the RLV 107 may be a single unit so that the operator may manually vary the height of the chassis of the vehicle 10 relative to the ground on both sides of the vehicle 10 using a single controller. In some alternative aspects, the system 100 may include a first RLV 107 for manually varying the height of the chassis of the vehicle 10 on the first side of the vehicle 10, and the system 100 may include a second RLV 107 for manually varying the height of the chassis of the vehicle 10 on the second side of the vehicle 10.

In some aspects, the one or more RLVs 107 may be connected by air lines to the first leveling valve 108, the one or more first air springs 106, the second leveling valve 112, and the one or more second air springs 110. In some aspects, although not shown in FIG. 2A, one or more supply lines may supply air from the one or more air supply tanks 114 to the one or more RLVs 107 (e.g., for increasing the height of the chassis of the vehicle 10 relative to the ground). In some aspects, when set in a neutral or drive mode (e.g., while the vehicle 10 is traveling), the one or more RLVs 107 may enable pneumatic communication between the first leveling valve 108 and the one or more first air springs 106 and pneumatic communication between the second leveling valve 112 and the one or more second air springs 110 so that the first and second leveling valves 108 and 112 perform automatic height control by controlling the amounts of air in the first and second air springs 106 and 110, respectively.

In some aspects, the operator may use the one or more RLVs 107 to manually control the height of the chassis of the vehicle 10 relative to the ground when first and second leveling valves 108 and are not performing automatic height control (e.g., while the vehicle 10 is stationary, such as at a loading dock). In some aspects, when the operator is manually controlling the height of the chassis of the vehicle 10 relative to the ground, the one or more RLVs 107 may be set to one of a stop mode, a raise mode, and a lower mode. In some aspects, in each of the stop, raise, and lower modes, the one or more RLVs 107 may prevent pneumatic communication between the first leveling valve 108 and the one or more first air springs 106 and prevent pneumatic communication between the second leveling valve 112 and the one or more second air springs 110. In some aspects, when set in the stop mode, the one or more RLVs 107 may prevent all pneumatic communication through the one or more RLVs 107 so that height of the chassis of the vehicle 10 relative to the ground does not change. In some aspects, when set in the raise mode, the one or more RLVs 107 may enable pneumatic communication between the one or more air supply tanks 114 and the one or more first air springs 106 and pneumatic communication between the one or more air supply tanks 114 and the one or more second air springs 110 increase the amount of air in the first and second air springs 106 and 110 and, thereby, increase the height of the chassis of the vehicle 10. In some aspects, when set in the lower mode, the one or more RLVs 107 may vent air from the one or more first air springs 106 and the one or more second air springs 110 to decrease the amount of air in the first and second air springs 106 and 110 and, thereby, decrease the height of the chassis of the vehicle 10. In some aspects, in all of the RLV modes, the one or more RLVs 107 may prevent the one or more first air springs 106 from communicating pneumatically with the second leveling valve 112 and the one or more second air springs 110 and may prevent the first leveling valve 108 from communicating pneumatically with the second leveling valve 112 and the one or more second air springs 110.

However, one or more RLVs 107 are not required, and, in some alternative aspects, the system 100 may not include an RLV, one or more air lines may connect directly the first leveling valve 108 and the one or more first air springs 106, and one or more air lines may connect directly the second leveling valve 112 and the one or more second air springs 110. In some aspects, the system 100 may include one or more dump valves. In some aspects, one or more air lines may connect and provide pneumatic communication (i) between a dump port of the first leveling valve 108 to the dump valve and (ii) between a dump port of the second leveling valve 112 to the dump valve. In some aspects, an air line may connect and provide pneumatic communication between the one or more air supply tanks 114 and the dump valve. In some aspects, the dump valve may be used to dump (manually or automatically) air from the air springs 106 and 110.

In some aspects, the system 100 may include one or more pressure protection valves (PPVs), which may protect the system 100 in the event of a leak or failure within the system 100. For example, as shown in FIG. 2A, the system 100 may include a first PPV 115 between the one or more air supply tanks 114 and the first leveling valve 108 and a second PPV 117 between the one or more air supply tanks 114 and the second leveling valve 112. In some aspects, a supply line may connect the one or more air supply tanks 114 to the first PPV 115, and a supply line may connect the first PPV 115 and the first leveling valve 108. In some aspects, a supply line may connect the one or more air supply tanks 114 to the second PPV 117, and a supply line may connect the second PPV 117 and the second leveling valve 112. In some alternative aspects, the first and second PPVs 115 and 117 may be integrated into a single PPV unit (e.g., a dual PPV including an inlet, two outlets, and an exhaust), the one or more air supply tanks 114 may be connected to an inlet of the integrated PPV unit, a first air line may connect a first outlet of the integrated PPV unit and the first leveling valve 108, and a second air line may connect a second outlet of the integrated PPV unit and the second leveling valve 112. However, the one or more PPVs are not required, and, in some alternative aspects, a supply line may connect the one or more air supply tanks 114 directly to the first leveling valve 108, and a supply line may connect the one or more air supply tanks 114 directly to the second leveling valve 112.

In some aspects, the air lines of the first and second pneumatic circuits 102 and 104 may be configured to supply equal volumes of air to maintain symmetry within the pneumatic circuits 102 and 104 on both sides of the vehicle 10. In some aspects, the air lines of the first and second pneumatic circuits 102 and 104 may include (i) an air line connecting the first leveling valve 108 and the RLV 107 and one or more air lines connecting the RLV 107 and the one or more first air springs 106 (or one or more air lines connecting the first leveling valve 108 and the one or more first air springs 106 if there is no RLV 107), (ii) an air line connecting the second leveling valve 112 and the RLV 107 and one or more air lines connecting the RLV 107 and the one or more second air springs 110 (or one or more air lines connecting the second leveling valve 112 and the one or more second air springs 110 if there is no RLV 107), (iii) a supply line connecting the one or more air supply tanks 114 to a PPV (e.g., the first PPV 115) and a supply line may connect the PPV and the first leveling valve 108 (or one or more supply lines connecting the one or more air supply tanks 114 and the first leveling valve 108 if there is no PPV), and/or (iv) a supply line connecting the one or more air supply tanks 114 to a PPV (e.g., the second PPV 117) and a supply line may connect the PPV and the second leveling valve 112 (or one or more supply lines connecting the one or more air supply tanks 114 and the second leveling valve 112 if there is no PPV). In some aspects, one or more of the air lines of the first pneumatic circuit 102 may be of substantially the same (e.g., within ±10% or ±5% or ±2% or ±1%) or equal diameter and/or length as one or more of the corresponding air lines of the second pneumatic circuit 104.

The present invention is not limited to having the particular number of axle(s) 12, 14, and/or 15, air springs 106 and 110, air lines/hoses, and/or air supply tank(s) 114 that are shown in the drawings, as these elements vary depending on the type of vehicle that is used as would be immediately clear to a person skilled in the art. In some aspects, as shown in FIG. 2A, the first pneumatic circuit 102 and a second pneumatic circuit 104 may be supplied air by one or more common air supply tanks 114. However, this is not required, and, in some alternative aspects, one or more air supply tanks may be dedicated to the first pneumatic circuit 102, and one or more different air supply tanks may be dedicated to the second pneumatic circuit 104.

In some aspects, the system 100 may include a cross-flow passage 116 that connects the first leveling valve 108 with the second leveling valve 112. In some aspects, the cross-flow passage 116 may be an air line. The first and second leveling valves 108 and 112 may establish pneumatic communication between the first and second pneumatic circuits 102 and 104 when neither the first leveling valve 108 is adjusting independently the height of the first side of the vehicle 10 nor the second leveling valve 112 is adjusting independently the height of the second side of the vehicle 10 (e.g., when (i) the first leveling valve 108 is neither supplying air to nor purging air from the one or more first air springs 106 and (ii) the second leveling valve 112 is neither supplying air to nor purging air from the one or more second air springs 110). In some aspects, the cross-flow passage 116 is not directly connected to the one or more air supply tanks 114 (or to a supply line connected to an air supply tank 114). In some aspects, the pneumatic communication between the first and second pneumatic circuits 102 and 104 via the cross-flow passage 116 may equalize air pressure between the one or more first air springs 106 and the one or more second air springs 110. As a result, the first and second leveling valves 108 and 112 link together the first and second pneumatic circuits 102 and 104 as a common circuit when neither the first leveling valve 108 is adjusting independently the height of the first side of the vehicle 10 nor the second leveling valve 112 is adjusting independently the height of the second side of the vehicle 10.

Accordingly, during a shift in the center of gravity of the vehicle 10 (e.g., when the vehicle 10 is negotiating a sharp turn and/or is on uneven ground), one of the first and second leveling valves 108 and 112 may supply air to the one of the first and second air springs 106 and 110 that have been contracted from the weight shift of the vehicle 10 while the other one of the first and second leveling valves 108 and 112 purges air from the other one of the first and second air springs 106 and 110 that have been extended from the weight shift of the vehicle 10 without any cross-flow between the first and second pneumatic circuits 102 and 104. In this state, the first and second leveling valves 108 and 112 may overcompensate for the dynamic weight shift of the vehicle 10 by either supplying too much air to one of the first and second air springs 106 and 110 or removing too much air from the other of the first and second air springs 106 and 110, resulting in a slight pressure difference between the first and second air springs 106 and 110. When the shift in the center of gravity of the vehicle 10 ends, if not for the first and second leveling valves 108 and 112 establishing pneumatic communication between the first and second pneumatic circuits 102 and 104, the slight pressure difference would keep the vehicle 10 in an uneven state. However, because the first and second leveling valves 108 and 112 establish pneumatic communication between the first and second pneumatic circuits 102 and 104 when neither the first leveling valve 108 is adjusting independently the height of the first side of the vehicle 10 nor the second leveling valve 112 is adjusting independently the height of the second side of the vehicle 10, the slight pressure difference between the first and second air springs 106 and 110 is eliminated as air passes via the cross-flow passage 116 from the one of the first and second air springs 106 and 110 at higher pressure to the other of the first and second air springs 106 and 110 at lower pressure, thereby reaching an equilibrium state.

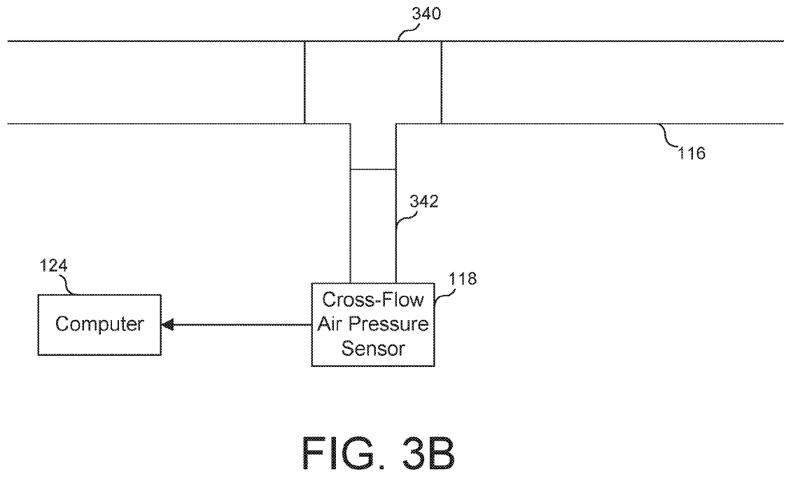

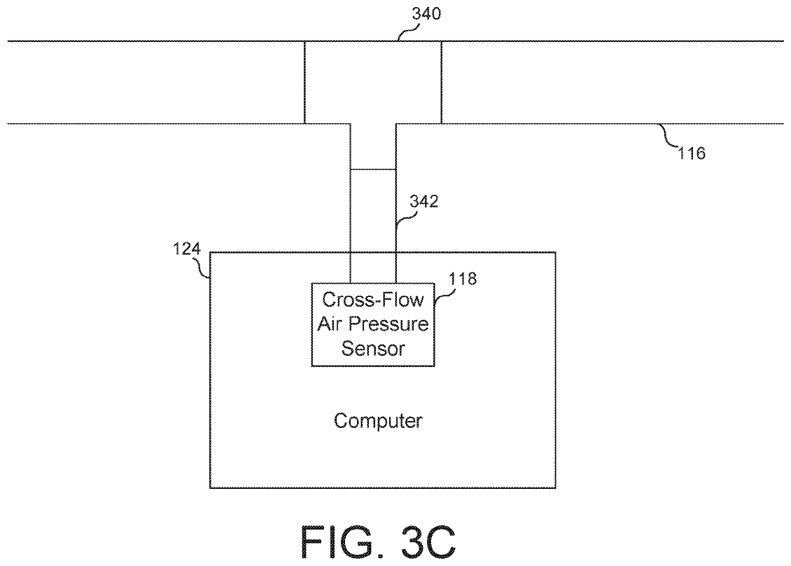

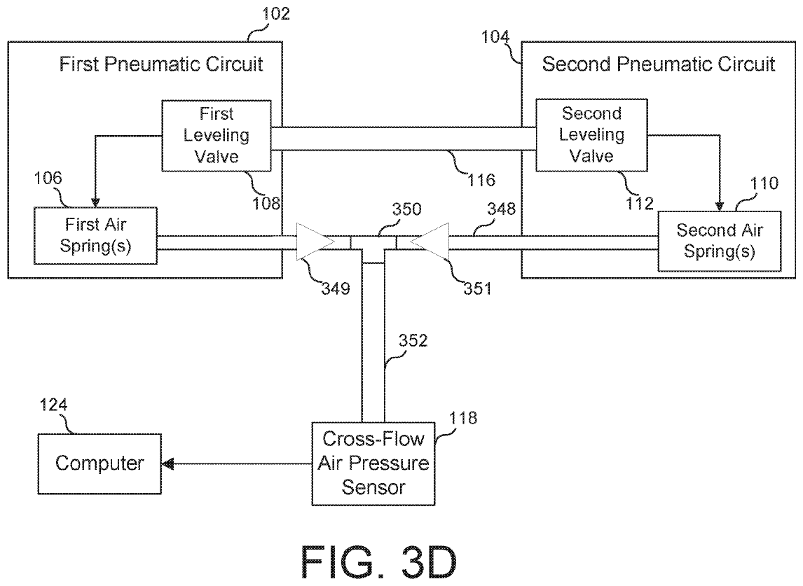

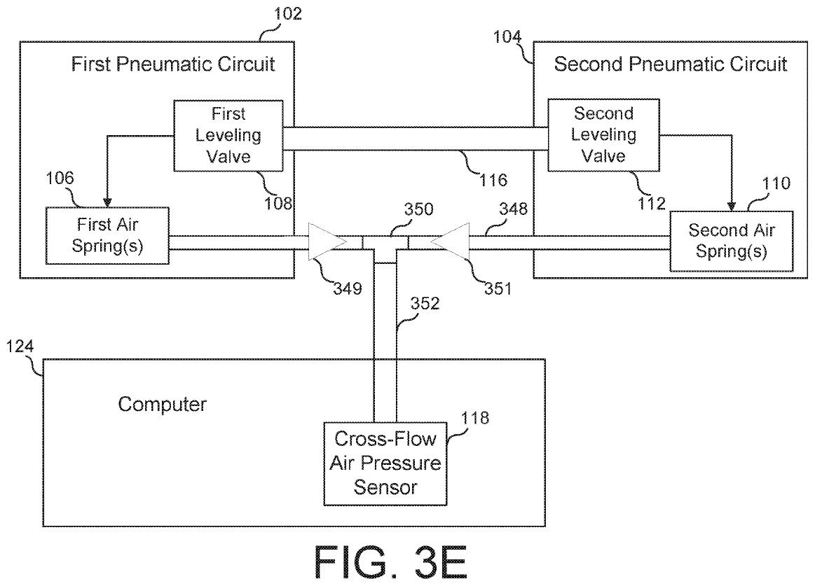

In some aspects, the system 100 may include a cross-flow air pressure sensor 118. In some aspects, the cross-flow air pressure sensor 118 may be configured to output cross-flow pressure information (e.g., an analog electrical signal) indicative of an air pressure within the cross-flow passage 116. In some aspects, as shown in FIG. 3A, the cross-flow air pressure sensor 118 may be inside the cross-flow passage 116. In some alternative aspects, as shown in FIGS. 3B and 3C, the system 100 may include a fitting 340 connected to the cross-flow passage 116, and the cross-flow air pressure sensor 118 may be configured to communicate pneumatically with the cross-flow passage 116 via the fitting 340. In some aspects, the fitting 340 may be, for example and without limitation, a T-fitting. In some aspects, one or more air lines 342 may connect the cross-flow air pressure sensor 118 to the fitting 340 for pneumatic communication between the cross-flow air pressure sensor 118 and the cross-flow passage 116.

In some alternative aspects, as shown in FIGS. 3D and 3E, the system 100 may include an air line 348 connecting the one or more first air springs 106 of the first pneumatic circuit 102 and the one or more second air springs 110 of the second pneumatic circuit 104. In some aspects, the air line 348 may have a smaller diameter than the cross-flow passage 116. In some aspects, a fitting 350 may be connected to the air line 348, and the cross-flow air pressure sensor 118 may be configured to communicate pneumatically with the air line 348 via the fitting 350. In some aspects, the fitting 350 may be, for example and without limitation, a T-fitting. In some aspects, one or more air lines 352 may connect the cross-flow air pressure sensor 118 to the fitting 350 for pneumatic communication between the cross-flow air pressure sensor 118 and the air line 348. In some aspects, the cross-flow air pressure sensor 118 that is in pneumatic communication with the air line 348, which is connected to the first and second air springs 106 and 110, may output cross-flow pressure information that is indicative of an air pressure in the air line 348. In some aspects, cross-flow pressure information generated using the air line 348 may be more stable than cross-flow pressure information generated directly from the cross-flow passage 116.

In some aspects, as shown in FIGS. 3D and 3E, the air line 348 may include back flow preventers 349 and 351. In some aspects, the back flow preventers 349 and 351 may be on opposite sides of the fitting 350. In some aspects, the back flow preventer 349 may prevent air from the one or more second air springs 110 of the second pneumatic circuit 104 from flowing into the one or more first air springs 106 of the first pneumatic circuit 102 via the air line 348. In some aspects, the back flow preventer 351 may prevent air from the one or more first air springs 106 of the first pneumatic circuit 102 from flowing into the one or more second air springs 110 of the second pneumatic circuit 104 via the air line 348. In some aspects, the back flow preventers 349 and 351 may be double check valves, reduced pressure zone devices, or any other suitable devices for preventing back flow.

In some aspects, a residual pressure purge device (e.g., a purge solenoid) may be included to vent residual pressure from the air line 348. In some aspects, the residual pressure purge device may prevent the back flow preventers 349 and 351 from creating a closed circuit from which pressure cannot escape. In some aspects, the residual pressure purge device may allow for system reset via a manual user input (e.g., a button next to the display 137), an input received (e.g., wirelessly) using the communication unit 139, and/or automatically under control of the computer 124. In some aspects including the residual pressure purge device, the fitting 350 may be a four-way fitting (e.g., instead of a three-way, T-fitting) connected to the backflow preventer 349, backflow preventer 351, cross-flow air pressure sensor 118, and the residual pressure purge device.

In some aspects, in a balanced state where the air pressure in the first and second air springs 106 and 110 is the same (e.g., when none of the first and second leveling valves 108 and 112 is adjusting independently the height of the first and second sides of the vehicle 10 and the first and second leveling valves 108 and 112 have established pneumatic communication between the first and second pneumatic circuits 102 and 104 via the cross-flow passage 116 to eliminate even a slight pressure difference between the first and second air springs 106 and 110), the air pressure in the air line 348 may be the same as air pressure in the cross-flow passage 116, which would be the same as the air pressure in the first and second air springs 106 and 110. In balanced state, the cross-flow air pressure sensor 118 that is in pneumatic communication with the air line 348 may output cross-flow pressure information that is indicative of an air pressure in the cross-flow passage 116. In some aspects, in an imbalanced state where the air pressure in the one or more air springs 106 is different than the air pressure in the one or more air springs 110 (e.g., when the first and second leveling valves 108 and 112 are adjusting independently the height of the first and second sides of the vehicle 10), the back flow preventers 349 and 351 may result in the air pressure in the portion of the air line 348 between the back flow preventers 349 and 351 being the higher of: (i) the air pressure in the one or more first air springs 106 of the first pneumatic circuit 102 and (ii) the one or more second air springs 110 of the second pneumatic circuit 104. In the imbalanced state, the cross-flow air pressure sensor 118 that is in pneumatic communication with the air line 348 may output cross-flow pressure information that is indicative of the higher of: (i) the air pressure in the one or more first air springs 106 of the first pneumatic circuit 102 and (ii) the one or more second air springs 110 of the second pneumatic circuit 104. In some aspects in which a computer 124 uses the cross-flow pressure information to provide braking control (e.g., to determine if system intervention is needed for anti-roll control) for the vehicle 10 and/or trailer 20, the back flow preventers 349 and 351 may ensure that the cross-flow pressure information reflects the higher pressure in the imbalanced state.

In some aspects, as shown in FIGS. 3A, 3B, and 3D, the cross-flow air pressure sensor 118 may be separate from the computer 124. In these aspects, the computer 124 may receive pressure information from the cross-flow air pressure sensor 118 (e.g., either directly from the cross-flow air pressure sensor 118 as an analog electrical signal or indirectly from the cross-flow air pressure sensor 118 as a digital electrical signal after being converted by an ADC). However, this is not required, and, in some alternative aspects, as shown in FIGS. 3C and 3E, the computer 124 may include the cross-flow air pressure sensor 118. In these aspects, computer 124 may receive the air line 342 or 352 as an input.

In some aspects, the system 100 may include a first air spring air pressure sensor 120. In some aspects, the first air spring air pressure sensor 120 may be configured to output first air spring pressure information (e.g., an analog electrical signal) indicative of an air pressure within the one or more first air springs 106. In some aspects, the first air spring air pressure sensor 120 may be inside an air spring of the one or more first air springs 106. In some alternative aspects, the first pneumatic circuit 102 may include a fitting (e.g., a T-fitting) connected to the one or more first air springs 106, and the first air spring air pressure sensor 120 may be configured to communicate pneumatically with the one or more first air springs 106 via the fitting.

In some aspects, the system 100 may include a second air spring air pressure sensor 122. In some aspects, the second air spring air pressure sensor 122 may be configured to output second air spring pressure information (e.g., an analog electrical signal) indicative of an air pressure within the one or more second air springs 110. In some aspects, the second air spring air pressure sensor 122 may be inside an air spring of the one or more second air springs 110. In some alternative aspects, the second pneumatic circuit 104 may include a fitting (e.g., a T-fitting) connected to the one or more second air springs 110, and the second air spring air pressure sensor 122 may be configured to communicate pneumatically with the one or more second air springs 110 via the fitting.

In some aspects, the one or more first air springs 106 and the one or more second air springs 110 may support a wheeled axle 12, 14, or 15 (or a group of wheeled axles 14 and 15) of the vehicle 10 on a chassis of the vehicle 10. In some aspects, the one or more first air springs 106 may be positioned on a first side of the axle 12, 14, or 15 (or group of axles), and the one or more second air springs 110 may be positioned on a second side of the axle 12, 14, or 15 (or group of axles), which is opposite the first side. For example, in some aspects, a pair of first air springs 106 may support an axle (e.g., axle 14 or 15) or group of axles (e.g., axles 14 and 15) on the first side, and a pair of second air springs 110 may support the axle or group of axles on the second side.

In some aspects, the first and second pneumatic circuits 102 and 104, the cross-flow passage 116, and the cross-flow air pressure sensor 118 may form a cross-flow set. In some aspects, the cross-flow set may include one or more additional components, such as, for example and without limitation, a first air spring air pressure sensor 120, a second air spring air pressure sensor 122, and/or the one or more air supply tanks 114. In some aspects, the cross-flow set may be assigned to one axle or to a group of axle. In some aspects, one or more additional cross-flow sets may be assigned to different axles or groups of axles.

FIG. 2B illustrates an example of an aspect in which a cross-flow set is assigned to a group of axles (e.g., axles 14 and 15). As shown in FIG. 2B, the cross-flow set may include a pair of first air springs 106 that support axle 14 on a first side, a pair of first air springs 106 that support axle 15 on the first side, a pair of second air springs 110 that support axle 14 on a second side, a pair of second air springs 110 that support axle 15 on the second side, a first leveling valve 108 that adjusts independently the height of the axles 14 and 15 on the first side of the vehicle 10 (e.g., by increasing or decreasing air in the first air springs 106), a second leveling valve 112 that adjusts independently the height of the axles 14 and 15 on the second side of the vehicle 10 (e.g., by increasing or decreasing air in the second air springs 110), a cross-flow passage 116, and a cross-flow air pressure sensor 118.

FIG. 2C illustrates an example of an aspect in which a first cross-flow set is assigned to one axle (e.g., axle 12), and a second cross-flow set is assigned to a group of axles (e.g., axles 14 and 15). As shown in FIG. 2C, the first cross-flow set may include a pair of first air springs 106 that support axle 12 on a first side, a pair of second air springs 110 that support axle 12 on a second side, a first leveling valve 108 that adjusts independently the height of the axle 12 on the first side of the vehicle 10, a second leveling valve 112 that adjusts independently the height of the axle 12 on the second side of the vehicle 10, a cross-flow passage 116, and a cross-flow air pressure sensor 118. As shown in FIG. 2C, the second cross-flow set may include a pair of first air springs 106 that support axle 14 on a first side, a pair of first air springs 106 that support axle 15 on the first side, a pair of second air springs 110 that support axle 14 on a second side, a pair of second air springs 110 that support axle 15 on the second side, a first leveling valve 108 that adjusts independently the height of the axles 14 and 15 on the first side of the vehicle 10, a second leveling valve 112 that adjusts independently the height of the axles 14 and 15 on the second side of the vehicle 10, a cross-flow passage 116, and a cross-flow air pressure sensor 118. In some aspects having more than one cross-flow set (e.g., the aspect shown in FIG. 2C), the computer 124 may receive cross-flow pressure information indicative of an air pressure within the cross-flow passage of each cross-flow set (e.g., cross-flow pressure information associated with axle 12 and cross-flow pressure information associated with the group of axles 14 and 15).

In some aspects, as shown in FIG. 2B, one or more of the axles (e.g., a steering axle 12, which may be at the front of the vehicle 10) may be supported on the chassis of the vehicle 10 by mechanical springs 107 and 109 (instead of by air springs 106 and 110). In some aspects in which an axle is supported by mechanical springs 107 and 109, as shown in FIG. 2B, the system 100 may include an axle load sensor 111. In some aspects, the axle load sensor 111 may be attached to the center of the axle (e.g., axle 14). In some aspects, the axle load sensor 111 may be configured to output axle strain information indicative of the strain in the axle. In some aspects, the strain in the axle may, in turn, be indicative of the weight on the axle.

In some aspects, the system 100 may include a computer 124. In some aspects, the computer 124 may include a processor and a non-transitory memory. In some aspects, the computer 124 may control the one or more aspects of the operation of the vehicle 10 and/or the trailer 20. For example, the computer 124 may provide braking control for the vehicle 10 and/or trailer 20, may provide load monitoring for the vehicle 10 and/or trailer 20, and/or may provide air management for the vehicle 10 and/or trailer 20.

In some aspects, the system 100 may include one or more analog to digital converters (ADCs) 126 configured to convert analog information into digital information. In some aspects, the system 100 may include one or more amplifiers 127 configured to amplify one or more analog signals. In some aspects, as shown in FIG. 2A, the computer 124 may include the one or more ADCs 126 and/or the one or more amplifiers 127. However, this is not required, and, in some alternative aspects, the one or more ADCs 126 and/or the one or more amplifiers 127 may be elsewhere in the system 100.

In some non-limiting aspects, the system 100 may include a brake pedal sensor 128. In some aspects, the brake pedal sensor 128 may be configured to output a brake pedal pressure signal indicative of a pressure (e.g., mechanical pressure) applied to a brake pedal of the vehicle 10 (e.g., by the foot of a driver of the vehicle 10).

In some aspects, the system 100 may include one or more acceleration sensors 130. In some aspects, the one or more acceleration sensors 130 may be configured to output acceleration information indicative of an acceleration of the vehicle 10. In some aspects, the one or more acceleration sensors 130 may include one or more accelerometers. In some aspects, the acceleration information may include lateral acceleration information and/or longitudinal acceleration information.

In some aspects, the system 100 may include one or more speed sensors 132. In some aspects, the one or more speed sensors 132 may be configured to output speed information indicative of a speed of the vehicle 10. In some aspects, the one or more speed sensors 132 may include one or more wheel rotation sensors, and the speed information may include wheel rotational speed information for one or more wheels of the vehicle. In some aspects, one or more of the wheel rotation sensors may include, for example and without limitation, a tooth wheel mounted on the hub or rotor of the monitored wheel and a speed sensor installed with its end against the tooth wheel. In some aspects, a sensor clip may hold the speed sensor in place and against the tooth wheel. In some aspects, the one or more speed sensors 132 may be configured to continuously output speed information indicative of a speed of the vehicle 10, which may be received by the computer 124.

In some aspects, although not shown in FIG. 2A, the system 100 may include one or more steering angle sensors (SASs). In some aspects, the SASs may be configured to output steering angle information indicative of position of the steering wheel of the vehicle 10.

In some aspects, the system 100 may include one or more first brakes 134 on the first side of the vehicle 10 and one or more second brakes 136 on the second side of the vehicle 10. In some aspects, the first and second brakes 134 and 136 may be configured to be controlled in accordance with first and second brake application levels, respectively, calculated by the computer 124. In some aspects, the first and second brake application levels may be brake application pressure levels. In some aspects, the first and second brake application levels may be different brake application levels. In some aspects, the computer 124 may apply the first and second brake application levels to the first and second brakes 134 and 136 via a valve block. In some aspects, the valve block may include one or more pressure modulator valves and/or one or more active braking valves (e.g., solenoid valves used for active braking) of the vehicle 10.

In some aspects, the system 100 may include one or more displays 137, one or more printers 138, one or more communication units 139, and one or more telematics units 141. In some aspects, the one or more telematics units 141 may include one or more location systems (e.g., a global positioning system (GPS)) configured to output location information indicative of a location (e.g., a GPS location) of the vehicle 10 and/or trailer 20. In some aspects, the one or more telematics units 141 may include one or more memories and/or one or more communication units. In some aspects, the one or more telematics units 141 may be configured to store and/or communicate tracking information about the vehicle 10 and/or trailer 20 (e.g., to a database server). In some aspects, the tracking information may include location information, speed and/or acceleration information, pressure information (e.g., cross-flow and/or air spring pressure information), axle strain information, brake pedal pressure signals, steering angle information, and/or weight information. In some aspects, the one or more telematics units 141 may receive the tracking information from the computer 124.

In some aspects, the one or more displays 137 may be configured to display information received from the computer 124 (e.g., pressure or weight information). In some aspects, the one or more printers 138 may be configured to print information received from the computer 124 (e.g., pressure or weight information). In some aspects, the one or more communication units 139 may include one or more wireless communication units configured to communicate wirelessly using one or more wireless communication protocols (e.g., Bluetooth) with one or more remote devices (e.g., a smartphone or other display device). In some aspects, the one or more communication units 139 may be configured to communicate information received from the computer 124 (e.g., pressure or weight information) for display on a remote device. In some aspects, the one or more displays 137, the one or more printers 138, the one or more communication units 139, and/or the one or more telematics units 141 may be mounted in a cab of the vehicle 10. In some aspects, the system 100 may additionally or alternatively include one or more user interfaces through which a user may enter data and/or commands.

In some aspects, the one or more display 137, the one or more telematics units 141, and/or the one or more user interfaces may be part of an electronic control unit (ECU) of an on-board mass (OBM) system, one or more cross-flow air pressure sensors 118 (and an axle load sensor 111 if present in the system 100) may be part of one or more mass sensor units (MSUs) of the OBM system, and the computer 124 and one or more ADCs 126 may be part of the ECU and/or one or more MSUs of the OBM system.

In some aspects, the system 100 may include the trailer interface 143. In some aspects, trailer interface 143 may include, for example and without limitation, a trailer plug and socket. In some aspects, the computer 124 of the vehicle 10 may receive information (e.g., pressure, speed, and/or acceleration information) from the trailer 20 via the trailer interface 143. In some aspects, the trailer 20 may receive information (trailer brake application levels) from the computer 124 of the vehicle 10 via the trailer interface 143.

In some aspects, the vehicle system 100 may include a trailer portion. In some aspects, the trailer portion of the vehicle system 100 may be a trailer system 200. FIG. 2D is a block diagram of a non-limiting aspect of the trailer system 200.

In some aspects, the trailer system 200 may include a first trailer pneumatic circuit 202 and a second trailer pneumatic circuit 204. The first trailer pneumatic circuit 202 may include one or more first trailer air springs 206 (e.g., one or more air bags) and a first trailer leveling valve 208. The second trailer pneumatic circuit 204 may include one or more second trailer air springs 210 and a second trailer leveling valve 212. In some aspects, the first trailer leveling valve 208 may be configured to adjust independently the height of a first side of the trailer 20 (e.g., by increasing or decreasing air in the one or more first trailer air springs 206), and the second trailer leveling valve 212 may be configured to adjust independently the height of a second side of the trailer 20 (e.g., by increasing or decreasing air in the one or more second trailer air springs 210). In some aspects, the first and second sides may be opposite sides of the trailer 20 (e.g., left and right sides). In some aspects, the trailer system 200 may include one or more trailer air supply tanks 214. In some aspects, one or more supply lines may connect the one or more trailer air supply tanks 214 to the first trailer leveling valve 208, and one or more supply lines may connect the one or more trailer air supply tanks 214 to the second trailer leveling valve 212.

In some aspects, the first trailer leveling valve 208 may increase air in the one or more first trailer air springs 206 by supplying air from one or more of the one or more trailer air supply tanks 214, and the second trailer leveling valve 212 may increase air in the one or more second trailer air springs 210 by supplying air from one or more of the one or more trailer air supply tanks 214. In some aspects, the first trailer leveling valve 208 may decrease air in the one or more first trailer air springs 206 by purging air from the one or more first trailer air springs 206 (e.g., allowing air from the one or more first trailer air springs 206 out of an exhaust port), and the second trailer leveling valve 212 may decrease air in the one or more second trailer air springs 210 by purging air from the one or more second trailer air springs 210 (e.g., allowing air from the one or more second trailer air springs 210 out of an exhaust port).

In some aspects, as shown in FIG. 2D, the trailer system 200 may include one or more raise and lower valves (RLVs) 207. In some aspects, the one or more RLVs 207 may allow an operator to manually vary the height of the chassis of the trailer 20 relative to the ground (e.g., to facilitate height adjustment of the trailer 20 at the loading dock). In some aspects, although the RLV 207 is shown as two units in FIG. 2D, the RLV 207 may be a single unit so that the operator may manually vary the height of the chassis of the trailer 20 relative to the ground on both sides of the trailer 20 using a single controller. In some alternative aspects, the trailer system 200 may include a first RLV 207 for manually varying the height of the chassis of the trailer on the first side of the trailer 20, and the trailer system 200 may include a second MN 207 for manually varying the height of the chassis of the trailer 20 on the second side of the trailer 20.

In some aspects, the one or more RLVs 207 may be connected by air lines to the first trailer leveling valve 208, the one or more first trailer air springs 206, the second trailer leveling valve 212, and the one or more second trailer air springs 210. In some aspects, although not shown in FIG. 2D, one or more supply lines may supply air from the one or more trailer air supply tanks 214 to the one or more RLVs 207 (e.g., for increasing the height of the chassis of the trailer 20 relative to the ground). In some aspects, when set in a neutral or drive mode (e.g., while the trailer 20 is traveling), the one or more RLVs 207 may enable pneumatic communication between the first trailer leveling valve 208 and the one or more first trailer air springs 206 and pneumatic communication between the second trailer leveling valve 212 and the one or more second trailer air springs 210 so that the first and second trailer leveling valves 208 and 212 perform automatic height control by controlling the amounts of air in the first and second trailer air springs 206 and 210, respectively.

In some aspects, the operator may use the one or more RLVs 207 to manually control the height of the chassis of the trailer 20 relative to the ground when first and second trailer leveling valves 208 and are not performing automatic height control (e.g., while the trailer 20 is stationary, such as at a loading dock). In some aspects, when the operator is manually controlling the height of the chassis of the trailer 20 relative to the ground, the one or more RLVs 207 may be set to one of a stop mode, a raise mode, and a lower mode. In some aspects, in each of the stop, raise, and lower modes, the one or more RLVs 207 may prevent pneumatic communication between the first trailer leveling valve 208 and the one or more first trailer air springs 206 and prevent pneumatic communication between the second trailer leveling valve 212 and the one or more second trailer air springs 210. In some aspects, when set in the stop mode, the one or more RLVs 207 may prevent all pneumatic communication through the one or more RLVs 207 so that height of the chassis of the trailer 20 relative to the ground does not change. In some aspects, when set in the raise mode, the one or more RLVs 207 may enable pneumatic communication between the one or more trailer air supply tanks 214 and the one or more first trailer air springs 206 and pneumatic communication between the one or more trailer air supply tanks 214 and the one or more second trailer air springs 210 increase the amount of air in the first and second trailer air springs 206 and 210 and, thereby, increase the height of the chassis of the trailer 20. In some aspects, when set in the lower mode, the one or more RLVs 207 may vent air from the one or more first trailer air springs 206 and the one or more second trailer air springs 210 to decrease the amount of air in the first and second trailer air springs 206 and 210 and, thereby, decrease the height of the chassis of the trailer 20. In some aspects, in all of the RLV modes, the one or more RLVs 207 may prevent the one or more first trailer air springs 206 from communicating pneumatically with the second trailer leveling valve 212 and the one or more second trailer air springs 210 and may prevent the first trailer leveling valve 208 from communicating pneumatically with the second trailer leveling valve 212 and the one or more second trailer air springs 210.

However, one or more RLVs 207 are not required, and, in some alternative aspects, the trailer system 200 may not include an RLV, one or more air lines may connect directly the first trailer leveling valve 208 and the one or more first trailer air springs 206, and one or more air lines may connect directly the second trailer leveling valve 212 and the one or more second trailer air springs 210. In some aspects, the trailer system 200 may include one or more dump valves. In some aspects, one or more air lines may connect and provide pneumatic communication (i) between a dump port of the first trailer leveling valve 208 to the dump valve and (ii) between a dump port of the second trailer leveling valve 212 to the dump valve. In some aspects, an air line may connect and provide pneumatic communication between the one or more trailer air supply tanks 214 and the dump valve. In some aspects, the dump valve may be used to dump (manually or automatically) air from the trailer air springs 206 and 210

In some aspects, the trailer system 200 may include one or more pressure protection valves (PPVs), which may protect the trailer system 200 in the event of a leak or failure within the trailer system 200. For example, as shown in FIG. 2D, the trailer system 200 may include a first PPV 215 between the one or more trailer air supply tanks 214 and the first trailer leveling valve 208 and a second PPV 217 between the one or more trailer air supply tanks 214 and the second trailer leveling valve 212. In some aspects, a supply line may connect the one or more trailer air supply tanks 214 to first PPV 215, and a supply line may connect the first PPV 215 and the first trailer leveling valve 208. In some aspects, a supply line may connect the one or more trailer air supply tanks 214 to the second PPV 217, and a supply line may connect the second PPV 217 and the second trailer leveling valve 212. In some alternative aspects, the first and second PPVs 215 and 217 may be integrated into a single PPV unit (e.g., a dual PPV including an inlet, two outlets, and an exhaust), the one or more trailer air supply tanks 214 may be connected to an inlet of the integrated PPV unit, a first air line may connect a first outlet of the integrated PPV unit and the first trailer leveling valve 208, and a second air line may connect a second outlet of the integrated PPV unit and the second trailer leveling valve 212. However, the one or more PPVs are not required, and, in some alternative aspects, a supply line may connect the one or more trailer air supply tanks 214 directly to the first trailer leveling valve 208, and a supply line may connect the one or more trailer air supply tanks 214 directly to the second trailer leveling valve 212.

In some aspects, the air lines of the first and second trailer pneumatic circuits 202 and 204 may be configured to supply equal volumes of air to maintain symmetry within the trailer pneumatic circuits 202 and 204 on both sides of the trailer 20. In some aspects, the air lines of the first and second trailer pneumatic circuits 202 and 204 may include (i) an air line connecting the first trailer leveling valve 208 and the RLV 207 and one or more air lines connecting the RLV 207 and the one or more first trailer air springs 206 (or one or more air lines connecting the first trailer leveling valve 208 and the one or more first trailer air springs 206 if there is no RLV 207), (ii) an air line connecting the second trailer leveling valve 212 and the RLV 207 and one or more air lines connecting the RLV 207 and the one or more second trailer air springs 210 (or one or more air lines connecting the second trailer leveling valve 212 and the one or more second trailer air springs 210 if there is no RLV 207), (iii) a supply line connecting the one or more trailer air supply tanks 214 to a PPV (e.g., the first PPV 215) and a supply line may connect the PPV and the first trailer leveling valve 208 (or one or more supply lines connecting the one or more trailer air supply tanks 214 and the first trailer leveling valve 208 if there is no PPV), and/or (iv) a supply line connecting the one or more trailer air supply tanks 214 to a PPV (e.g., the second PPV 217) and a supply line may connect the PPV and the second trailer leveling valve 212 (or one or more supply lines connecting the one or more trailer air supply tanks 214 and the second trailer leveling valve 212 if there is no PPV). In some aspects, one or more of the air lines of the first trailer pneumatic circuit 202 may be of substantially the same (e.g., within ±10% or ±5% or ±2% or ±1%) or equal diameter and/or length as one or more of the corresponding air lines of the second trailer pneumatic circuit 204.

The present invention is not limited to the trailer 20 having the particular number of axle(s) 16, 18, 19, and/or 21, trailer air springs 206 and 210, air lines/hoses, and/or trailer air supply tank(s) 214 that are shown in the drawings, as these elements vary depending on the type of trailer that is used as would be immediately clear to a person skilled in the art. In some aspects, as shown in FIG. 2D, the first trailer pneumatic circuit 202 and a second trailer pneumatic circuit 204 may be supplied air by one or more common trailer air supply tanks 214. However, this is not required, and, in some alternative aspects, one or more trailer air supply tanks may be dedicated to the first trailer pneumatic circuit 202, and one or more different trailer air supply tanks may be dedicated to the second trailer pneumatic circuit 204.

In some aspects, the trailer system 200 may include a trailer cross-flow passage 216 that connects the first trailer leveling valve 208 with the second trailer leveling valve 212. The first and second trailer leveling valves 208 and 212 may establish pneumatic communication between the first and second trailer pneumatic circuits 202 and 204 when neither the first trailer leveling valve 208 is adjusting independently the height of the first side of the trailer 20 nor the second trailer leveling valve 212 is adjusting independently the height of the second side of the trailer 20 (e.g., when (i) the first trailer leveling valve 208 is neither supplying air to nor purging air from the one or more first trailer air springs 206 and (ii) the second trailer leveling valve 212 is neither supplying air to nor purging air from the one or more trailer second air springs 210). In some aspects, the trailer cross-flow passage 216 is not directly connected to the one or more trailer air supply tanks 214 (or to a supply line connected to a trailer air supply tank 214). In some aspects, the pneumatic communication between the first and second trailer pneumatic circuits 202 and 204 via the trailer cross-flow passage 216 may equalize air pressure between the one or more first trailer air springs 206 and the one or more second trailer air springs 210. As a result, the first and second trailer leveling valves 208 and 212 may link together the first and second trailer pneumatic circuits 202 and 204 as a common circuit when neither the first trailer leveling valve 208 is adjusting independently the height of the first side of the trailer 20 nor the second trailer leveling valve 212 is adjusting independently the height of the second side of the trailer 20.

Accordingly, during a shift in the center of gravity of the trailer 20 (e.g., when the trailer 20 is negotiating a sharp turn and/or is on uneven ground), one of the first and second trailer leveling valves 208 and 212 may supply air to the one of the first and second trailer air springs 206 and 210 that have been contracted from the weight shift of the trailer 20 while the other one of the first and second trailer leveling valves 208 and 212 purges air from the other one of the first and second trailer air springs 206 and 210 that have been extended from the weight shift of the trailer 20 without any cross-flow between the first and second trailer pneumatic circuits 202 and 204. In this state, the first and second trailer leveling valves 208 and 212 may overcompensate for the dynamic weight shift of the trailer 20 by either supplying too much air to one of the first and second trailer air springs 206 and 210 or removing too much air from the other of the first and second trailer air springs 206 and 210, resulting in a slight pressure difference between the first and second trailer air springs 206 and 210. When the shift in the center of gravity of the trailer 20 ends, if not for the first and second trailer leveling valves 208 and 212 establishing pneumatic communication between the first and second trailer pneumatic circuits 202 and 204, the slight pressure difference would keep the trailer 20 in an uneven state. However, because the first and second trailer leveling valves 208 and 212 establish pneumatic communication between the first and second trailer pneumatic circuits 202 and 204 when neither the first trailer leveling valve 208 is adjusting independently the height of the first side of the trailer 20 nor the second trailer leveling valve 212 is adjusting independently the height of the second side of the trailer 20, the slight pressure difference between the first and second trailer air springs s06 and s10 is eliminated as air passes via the trailer cross-flow passage 216 from the one of the first and second trailer air springs 206 and 210 at higher pressure to the other of the first and second trailer air springs 206 and 210 at lower pressure, thereby reaching an equilibrium state.

In some aspects, the trailer system 200 may include a trailer cross-flow air pressure sensor 218. In some aspects, the trailer cross-flow air pressure sensor 218 may be configured to output trailer cross-flow pressure information (e.g., an analog electrical signal) indicative of an air pressure within the trailer cross-flow passage 216. In some aspects, similar to the setup shown in FIG. 3A, the trailer cross-flow air pressure sensor 218 may be inside the trailer cross-flow passage 216. In some alternative aspects, similar to the setup shown in FIGS. 3B and 3C, the trailer system 200 may include a fitting (e.g., a T-fitting) connected to the trailer cross-flow passage 216, and the trailer cross-flow air pressure sensor 218 may be configured to communicate pneumatically with the trailer cross-flow passage 216 via the fitting. In some aspects, one or more air lines may connect the trailer cross-flow air pressure sensor 218 to the fitting for pneumatic communication between the trailer cross-flow air pressure sensor 218 and the trailer cross-flow passage 216.

In some alternative aspects, similar to the setup shown in FIGS. 3D and 3E, the trailer system 200 may include a first air line connecting the one or more first trailer air springs 206 of the first trailer pneumatic circuit 202 and the one or more second trailer air springs 210 of the second trailer pneumatic circuit 204. In some aspects, the first air line may have a smaller diameter than the trailer cross-flow passage 216. In some aspects, a fitting (e.g., a T-fitting) may be connected to the first air line, and the trailer cross-flow air pressure sensor 218 may be configured to communicate pneumatically with the first air line via the fitting. In some aspects, the first air line may include back flow preventers on opposite sides of the fitting. In some aspects, one or more second air lines may connect the trailer cross-flow air pressure sensor 218 to the fitting for pneumatic communication between the trailer cross-flow air pressure sensor 218 and the first air line. In some aspects, a residual pressure purge device (e.g., a purge solenoid) may be included to vent residual pressure from the first air line connecting the one or more first trailer air springs 206 of the first trailer pneumatic circuit 202 and the one or more second trailer air springs 210 of the second trailer pneumatic circuit 204.

In some aspects, similar to the setup shown in FIGS. 3A, 3B, and 3D, the trailer cross-flow air pressure sensor 218 may be separate from the computer 124. In these aspects, the computer 124 may receive pressure information from the trailer cross-flow air pressure sensor 218 (e.g., either directly from the trailer cross-flow air pressure sensor 218 as an analog electrical signal or indirectly from the trailer cross-flow air pressure sensor 218 as a digital electrical signal after being converted by an ADC). However, this is not required, and, in some alternative aspects, similar to the setup shown in FIGS. 3C and 3E, the computer 124 (e.g., a portion of the computer 124 in the trailer 20) may include the trailer cross-flow air pressure sensor 218. In these aspects, computer 124 (e.g., a portion of the computer 124 in the trailer 20) may receive an air line as an input.

In some aspects, the trailer system 200 may include a first trailer air spring air pressure sensor 220. In some aspects, the first trailer air spring air pressure sensor 220 may be configured to output first trailer air spring pressure information (e.g., an analog electrical signal) indicative of an air pressure within the one or more first trailer air springs 206. In some aspects, the first trailer air spring air pressure sensor 220 may be inside an air spring of the one or more first trailer air springs 206. In some alternative aspects, the first trailer pneumatic circuit 202 may include a fitting (e.g., a T-fitting) connected to the one or more first trailer air springs 206, and the first trailer air spring air pressure sensor 220 may be configured to communicate pneumatically with the one or more first trailer air springs 206 via the fitting.

In some aspects, the trailer system 200 may include a second trailer air spring air pressure sensor 222. In some aspects, the second trailer air spring air pressure sensor 222 may be configured to output second trailer air spring pressure information (e.g., an analog electrical signal) indicative of an air pressure within the one or more second trailer air springs 210. In some aspects, the second trailer air spring air pressure sensor 222 may be inside an air spring of the one or more second trailer air springs 210. In some alternative aspects, the second trailer pneumatic circuit 204 may include a fitting (e.g., a T-fitting) connected to the one or more second trailer air springs 210, and the second trailer air spring air pressure sensor 222 may be configured to communicate pneumatically with the one or more second trailer air springs 210 via the fitting.

In some aspects, the trailer system 200 may include one or more analog to digital converters (ADCs) (not shown) configured to convert analog information into digital information. In some aspects, the trailer system 200 may include one or more amplifiers (not shown) configured to amplify one or more analog signals.

In some aspects, the trailer system 200 may include one or more trailer acceleration sensors 230. In some aspects, the one or more trailer acceleration sensors 230 may be configured to output trailer acceleration information indicative of an acceleration of the trailer 20. In some aspects, the one or more trailer acceleration sensors 230 may include one or more accelerometers. In some aspects, the trailer acceleration information may include lateral acceleration information and/or longitudinal acceleration information.

In some aspects, the trailer system 200 may include one or more trailer speed sensors 232. In some aspects, the one or more trailer speed sensors 232 may be configured to output trailer speed information indicative of a speed of the trailer 20. In some aspects, the one or more trailer speed sensors 232 may include one or more wheel rotation sensors, and the speed information may include wheel rotational speed information for one or more wheels of the trailer 20.

In some aspects, the trailer system 200 may include one or more first trailer brakes 234 on the first side of the trailer 20 and one or more second trailer brakes 236 on the second side of the trailer 20. In some aspects, the first and second trailer brakes 234 and 236 may be configured to be controlled in accordance with first and second trailer brake application levels, respectively, calculated by the computer 124 of the vehicle system 100. In some aspects, the first and second trailer brake application levels may be different brake application levels. In some aspects, the first trailer brake application level applied to the first trailer brake 234 may be different than the first vehicle brake application applied to the first brake 134. In some aspects, the second trailer brake application level applied to the second trailer brake 236 may be different than the second vehicle brake application applied to the second brake 136. In some aspects, the computer 124 may apply the first and second trailer brake application levels to the first and second trailer brakes 234 and 236 via a valve block. In some aspects, the valve block may include one or more pressure modulator valves and/or one or more active braking valves (e.g., solenoid valves used for active braking) of the trailer 20.

In some aspects, the one or more first trailer air springs 206 and the one or more second trailer air springs 210 may support a wheeled axle 16, 18, 19, or 21 (or a group of wheeled axles) of the trailer 20 on a chassis of the trailer 20. In some aspects, the one or more first trailer air springs 206 may be positioned on a first side of the axle 16, 18, 19, or 21 (or a group of axles), and the one or more second trailer air springs 210 may be positioned on a second side of the axle 16, 18, 19, or 21 (or a group of axles), which is opposite the first side. For example, in some aspects, a pair of first trailer air springs 206 may support an axle (e.g., axle 16, 18, 19, or 21) or group of axles (e.g., axles 18 and 19) on the first side, and a pair of second trailer air springs 210 may support the axle or group of axles on the second side.

In some aspects, the first and second trailer pneumatic circuits 202 and 204, the trailer cross-flow passage 216, and the trailer cross-flow air pressure sensor 218 may form a trailer cross-flow set. In some aspects, the trailer cross-flow set may include one or more additional components, such as, for example and without limitation, a first trailer air spring air pressure sensor 220, a second trailer air spring air pressure sensor 222, and/or one or more trailer air supply tanks 214. In some aspects, the trailer cross-flow set may be assigned to one axle or to a group of axle. In some aspects, one or more additional trailer cross-flow sets may be assigned to different axles or groups of axles.

FIG. 2E illustrates an example of an aspect in which a trailer cross-flow set is assigned to a group of axles (e.g., axles 18 and 19). As shown in FIG. 2E, the trailer cross-flow set may include a pair of first trailer air springs 206 that support axle 18 on a first side, a pair of first trailer air springs 206 that support axle 19 on the first side, a pair of second trailer air springs 210 that support axle 18 on a second side, a pair of second trailer air springs 210 that support axle 19 on the second side, a first trailer leveling valve 208 that adjusts independently the height of the axles 18 and 19 on the first side of the trailer 20 (e.g., by increasing or decreasing air in the first trailer air springs 206), a second trailer leveling valve 212 that adjusts independently the height of the axles 18 and 19 on the second side of the trailer 20 (e.g., by increasing or decreasing air in the second trailer air springs 210), a trailer cross-flow passage 216, and a trailer cross-flow air pressure sensor 218.

In some aspects, as shown in FIG. 2E, one or more of the axles (e.g., a steering axle 16, which may be at the front of the trailer 20) may be supported on the chassis of the trailer 20 by mechanical springs 207 and 209 (instead of by trailer air springs 206 and 210). In some aspects in which an axle is supported by mechanical springs 207 and 209, as shown in FIG. 2E, the trailer system 200 may include a trailer axle load sensor 211. In some aspects, the trailer axle load sensor 211 may be attached to the center of the axle (e.g., axle 16). In some aspects, the trailer axle load sensor 211 may be configured to output trailer axle strain information indicative of the strain in the axle. In some aspects, the strain in the axle may, in turn, be indicative of the weight on the axle.

FIG. 2F illustrates an example of an aspect in which a first trailer cross-flow set is assigned to one axle (e.g., axle 18), a second trailer cross-flow set is assigned to another axle (e.g., axle 19), and a third trailer cross-flow set is assigned to yet another axle (e.g., axle 21). The first, second, and third cross-flow sets shown in FIG. 2F may be used, for example and without limitation, a trailer 20 that is a triple spread axle trailer. As shown in FIG. 2F, the third trailer cross-flow set may include a pair of first trailer air springs 206 that support axle 21 on a first side, a pair of second trailer air springs 210 that support axle 21 on a second side, a first trailer leveling valve 208 that adjusts independently the height of the axle 21 on the first side of the trailer 20, a second trailer leveling valve 212 that adjusts independently the height of the axle 21 on the second side of the trailer 20, a trailer cross-flow passage 216, and a trailer cross-flow air pressure sensor 218.

In some aspects having more than one trailer cross-flow set (e.g., the aspect shown in FIG. 2F), the computer 124 may receive trailer cross-flow pressure information indicative of an air pressure within the trailer cross-flow passage 216 of each trailer cross-flow set (e.g., two or more of trailer cross-flow pressure information associated with axle 18, trailer cross-flow pressure information associated with axle 19, and trailer cross-flow pressure information associated with axle 21). In some aspects, the one or more trailer cross-flow air pressure sensors 218 (and the trailer axle load sensor 211 if present) may be part of one or more MSUs of the on-board mass (OBM) system.

FIGS. 2G and 2O illustrate examples of aspects in which a trailer cross-flow set is assigned to a group of axles (e.g., axles 18, 19, and 21) for a trailer 20 (e.g., a triaxle trailer). The provided figures are not intended to be limiting and the present disclosure further includes analogous systems with various numbers of axles, e.g., 1, 2, 3, 4, 5, or more axles. As shown in FIGS. 2G and 2O, the trailer cross-flow set may include a first trailer air spring 206a that supports an axle 18 on a first side, a first trailer air spring 206b that supports an axle 19 on the first side, a first trailer air spring 206c that supports an axle 21 on the first side, a second trailer air spring 210a that supports the axle 18 on the second side, a second trailer air spring 210b that supports the axle 19 on the second side, a second trailer air spring 210c that supports the axle 21 on the second side, a first trailer leveling valve 208 that adjusts independently the height of the axles 18, 19, and 21 on the first side of the trailer 20 (e.g., by increasing or decreasing air in the first trailer air springs 206a-c), a second trailer leveling valve 212 that adjusts independently the height of the axles 18, 19, and 21 on the second side of the trailer 20 (e.g., by increasing or decreasing air in the second trailer air springs 210a-c), a trailer cross-flow passage 216, and a trailer cross-flow air pressure sensor 218. In some aspects, as shown in FIGS. 1B, 2G, and 2O, the axle 19 may be a central axle located between the axles 18 and 21. In some aspects, as shown in FIGS. 2G and 2O, the first trailer air spring 206b that supports the central axle 19 may be a central first trailer air spring 206b located between the first trailer air spring 206a and 206c that support the axles 18 and 21, respectively. In some aspects, as shown in FIGS. 2G and 2O, the second trailer air spring 210b that supports the central axle 19 may be a central second trailer air spring 210b located between the second trailer air spring 210a and 210c that support the axles 18 and 21, respectively.

In some aspects, similar to the example illustrated in FIG. 2E, air lines may connect the first trailer leveling valve 208 (either directly or through a RLV) to each of the first trailer air springs 206a-c, and air lines may connect the second trailer leveling valve 212 (either directly or through an RLV) to each of the second trailer air springs 210a-c. In some alternative aspects, as shown in FIG. 2G, an air line may connect the first trailer leveling valve 208 (either directly or through an RLV) to the central first trailer air spring 206b that supports the axle 19, an air line 225 may connect and provide pneumatic communication between the central first trailer air spring 206b and the first trailer air spring 206a that supports the axle 18, and an air line 224 may connect and provide pneumatic communication between the central first trailer air spring 206b and the first trailer air spring 206c that supports the axle 21. In these alternative aspects, the air lines 224 and 225 may enable front-to-back (and back-to-front) air flow between the first trailer air springs 206a-c with the central first trailer air spring 206b acting as an air reservoir between the first trailer air springs 206a and 206c.

In these alternative aspects, as shown in FIG. 2G, an air line may connect the second trailer leveling valve 212 (either directly or through an RLV) to the central second trailer air spring 210b that supports the axle 19, an air line 227 may connect and provide pneumatic communication between the central second trailer air spring 210b and the second trailer air spring 210a that supports the axle 18, and an air line 226 may connect and provide pneumatic communication between the central second trailer air spring 210b and the second trailer air spring 210c that supports the axle 21. In these alternative aspects, the air lines 226 and 227 may enable front-to-back (and back-to-front) air flow between the second trailer air springs 210a-c with the central second trailer air spring 210b acting as an air reservoir between the second trailer air springs 210a and 210c.

In some other alternative aspects, as shown in FIG. 2O, a first air line may connect the first trailer leveling valve 208 (either directly or through an RLV) to the air line 224 that connects and provides pneumatic communication between the central first trailer air spring 206b and the first trailer air spring 206c, a second air line may connect the first trailer leveling valve 208 (either directly or through an RLV) to the air line 225 that connects and provides pneumatic communication between the central first trailer air spring 206b and the first trailer air spring 206a, a third air line may connect the second trailer leveling valve 212 (either directly or through an RLV) to the air line 226 that connects and provides pneumatic communication between the central second trailer air spring 210b and the second trailer air spring 210c, and a fourth air line may connect the second trailer leveling valve 212 (either directly or through an RLV) to the air line 227 that connects and provides pneumatic communication between the central second trailer air spring 210b and the second trailer air spring 210a. In some of these alternative aspects, the first, second, third, and fourth air lines may be connected to the air lines 224, 225, 226, and 227, respectively, via a fitting (e.g., a T-fitting). In some of these alternative aspects, the first, second, third, and fourth air lines may be connected to the air lines 224, 225, 226, and 227, respectively, at the mid-points of the air lines 224, 225, 226, and 227, respectively.

FIGS. 2H-2N, 2P, and 2Q illustrate pneumatic circuits (e.g., first and second trailer pneumatic circuits 202 and 204) of a trailer system 200 for a trailer 20 (e.g., a triaxle trailer) according to various aspects. In some aspects, the air lines and/or supply lines illustrated in FIGS. 2H-2N, 2P, and 2Q may be nylon hoses (e.g., nylon hoses having a ½ inch diameter). In some aspects, the air lines of the trailer system 200 may be configured to supply equal volumes of air to maintain symmetry within the pneumatic circuits on both sides of the trailer 20. In some aspects, the air line 225 between the central first trailer air spring 206b and the first trailer air spring 206a may be of substantially the same (e.g., within ±10% or ±5% or ±2% or ±1%) or equal diameter and/or length as the air line 227 between the central second trailer air spring 210b and the second trailer air spring 210a. In some aspects, the air line 225 may be of substantially the same (e.g., within ±10% or ±5% or ±2% or ±1%) or equal diameter and/or length as the air line 224 between the central first trailer air spring 206b and the first trailer air spring 206c. In some aspects, the air line 224 may be of substantially the same (e.g., within ±10% or ±5% or ±2% or ±1%) or equal diameter and/or length as the air line 226 between the central second trailer air spring 210b and the second trailer air spring 210c. In some aspects, all of the air lines 224-227 may be of substantially the same (e.g., within ±10% or ±5% or ±2% or ±1%) or equal diameter and/or length.

In some aspects, as shown in FIGS. 2H-2J and 2P, the trailer system 200 may include an RLV 207, an air line 245 that connects and provides pneumatic communication between the first trailer leveling valve 208 and the RLV 207, and an air line 246 that connects and provides pneumatic communication between the second trailer leveling valve 212 and the RLV 207. In some aspects, as shown in FIGS. 2H-2J, the trailer system 200 may include an air line 247 that connects and provides pneumatic communication between the RLV 207 and the central first trailer air spring 206b, an air line 248 that connects and provides pneumatic communication between the RLV 207 and the central second trailer air spring 210b, and an air line (not shown) that connects and provides pneumatic communication between the one or more trailer air supply tanks 214 and the RLV 207. In some aspects, the air line 245 may be of substantially the same (e.g., within ±10% or ±5% or ±2% or ±1%) or equal diameter and/or length as the air line 246. In some aspects, the air line 247 may be of substantially the same (e.g., within ±10% or ±5% or ±2% or ±1%) or equal diameter and/or length as the air line 248.

In some alternative aspects, as shown in FIG. 2K, the trailer system 200 may include a first RLV 207a for the first side of the trailer 20 and a second RLV 207b for the second side of the trailer 20, the air line 245 may connect and provide pneumatic communication between the first trailer leveling valve 208 and the first RLV 207a, the air line 246 may connect and provide pneumatic communication between the second trailer leveling valve 212 and the second RLV 207b, the air line 247 may connect and provide pneumatic communication between the first RLV 207a and the central first trailer air spring 206b, the air line 248 may connect and provide pneumatic communication between the second RLV 207b and the central second trailer air spring 210b, an air line (not shown) may connect and provide pneumatic communication between the one or more trailer air supply tanks 214 and the first RLV 207a, and an air line (not shown) may connect and provide pneumatic communication between the one or more trailer air supply tanks 214 and the second RLV 207b. In some aspects, the air line 245 may be of substantially the same (e.g., within ±10% or ±5% or ±2% or ±1%) or equal diameter and/or length as the air line 246. In some aspects, the air line 247 may be of substantially the same (e.g., within ±10% or ±5% or ±2% or ±1%) or equal diameter and/or length as the air line 248.

In some alternative aspects, as shown in FIG. 2P, the trailer system 200 may include an air line 247a that connects and provides pneumatic communication between the RLV 207 and the air line 224, an air line 247b that connects and provides pneumatic communication between the RLV 207 and the air line 225, an air line 248a that connects and provides pneumatic communication between the RLV 207 and the air line 226, an air line 248b that connects and provides pneumatic communication between the RLV 207 and the air line 227, and an air line (not shown) that connects and provides pneumatic communication between the one or more trailer air supply tanks 214 and the RLV 207. In some aspects, the RLV 207 may include only one port for connection to the first trailer air springs 206 and only one port for connection to the second trailer air springs 210, and, in this case, T-junctions may be used to connect the air lines 247a, 247b, 248a, and 248b to the RLV 207. That is, in some aspects, the air lines 247a and 247b may connect to a T-junction at the RLV port for connection to the first trailer air springs 206, and the air lines 248a and 248b for connection to the second trailer air springs 210. In some aspects, the air line 247a may be of substantially the same (e.g., within ±10% or ±5% or ±2% or ±1%) or equal diameter and/or length as the air line 248a. In some aspects, the air line 247b may be of substantially the same (e.g., within ±10% or ±5% or ±2% or ±1%) or equal diameter and/or length as the air line 248b. In some aspects, the air line 247a may be of substantially the same (e.g., within ±10% or ±5% or ±2% or ±1%) or equal diameter and/or length as the air line 247b. In some aspects, the air line 248a may be of substantially the same (e.g., within ±10% or ±5% or ±2% or ±1%) or equal diameter and/or length as the air line 248b.

In some other alternative aspects, as shown in FIGS. 2L, 2M, 2N, and 2P, the trailer system 200 may not include an RLV. In some aspects, as shown in FIGS. 2L, 2M, and 2N, and the trailer system 200 may include an air line 255 that connects and provides pneumatic communication between the first trailer leveling valve 208 and the central first trailer air spring 206b and an air line 256 that connects and provides pneumatic communication between the second trailer leveling valve 212 and the central second trailer air spring 210b. In some aspects, the air line 255 may be of substantially the same (e.g., within ±10% or ±5% or ±2% or ±1%) or equal diameter and/or length as the air line 256.

In some alternative aspects, as shown in FIG. 2P, the trailer system 200 may include an air line 255a that connects and provides pneumatic communication between the first trailer leveling valve 208 and the air line 224, an air line 255b that connects and provides pneumatic communication between the first trailer leveling valve 208 and the air line 225, an air line 256a that connects and provides pneumatic communication between the second trailer leveling valve 212 and the air line 226, an air line 256b that connects and provides pneumatic communication between the second trailer leveling valve 212 and the air line 227, and an air line (not shown) that connects and provides pneumatic communication between the one or more trailer air supply tanks 214 and the RLV 207. In some aspects, the air line 255a may be of substantially the same (e.g., within ±10% or ±5% or ±2% or ±1%) or equal diameter and/or length as the air line 256a. In some aspects, the air line 255b may be of substantially the same (e.g., within ±10% or ±5% or ±2% or ±1%) or equal diameter and/or length as the air line 256b. In some aspects, the air line 255a may be of substantially the same (e.g., within ±10% or ±5% or ±2% or ±1%) or equal diameter and/or length as the air line 255b. In some aspects, the air line 256a may be of substantially the same (e.g., within ±10% or ±5% or ±2% or ±1%) or equal diameter and/or length as the air line 256b.

In some aspects, as shown in FIG. 2H, the trailer system 200 may include first and second PPVs 215 and 217, a supply line 241 that connects and provides pneumatic communication between the one or more trailer air supply tanks 214 and the first PPV 215, a supply line 242 that connects and provides pneumatic communication between the one or more trailer air supply tanks 214 and the second PPV 217, a supply line 243 that connects and provides pneumatic communication between the first PPV 215 and the first trailer leveling valve 208, and a supply line 244 that connects and provides pneumatic communication between the second PPV 217 and the second trailer leveling valve 212. In some aspects, the supply line 241 may be of substantially the same (e.g., within ±10% or ±5% or ±2% or ±1%) or equal diameter and/or length as the supply line 242. In some aspects, the supply line 243 may be of substantially the same (e.g., within ±10% or ±5% or ±2% or ±1%) or equal diameter and/or length as the supply line 244.

In some alternative aspects, as shown in FIGS. 2I, 2M, 2N, 2P, and 2Q, the trailer system 200 may include an integrated PPV unit 219 for both the first and second trailer leveling valves 208 and 212. In some aspects, the integrated PPV unit 219 may be a dual PPV including an inlet, two outlets, and an exhaust. In some aspects, the integrated PPV unit 219 may be easier to install than separate PPVs 215 and 217. In some aspects, as shown in FIGS. 2I, 2M, and 2N, a supply line 251 that connects and provides pneumatic communication between the one or more trailer air supply tanks 214 and an inlet of the integrated PPV unit 219, a supply line 249 that connects and provides pneumatic communication between the a first outlet of the integrated PPV unit 219 and the first trailer leveling valve 208, and a supply line 250 that connects and provides pneumatic communication between a second outlet of the integrated PPV unit 219 and the second trailer leveling valve 212. In some aspects, the supply line 249 may be of substantially the same (e.g., within ±10% or ±5% or ±2% or ±1%) or equal diameter and/or length as the supply line 250.

In some alternative aspects, as shown in FIGS. 2J, 2K, and 2L, the trailer system 200 may not include a PPV, a supply line 253 may connect and provide pneumatic communication between the one or more trailer air supply tanks 214 and the first trailer leveling valve 208, and a supply line 254 may connect and provide pneumatic communication between the one or more trailer air supply tanks 214 and the second trailer leveling valve 212. In some aspects, the supply line 253 may be of substantially the same (e.g., within ±10% or ±5% or ±2% or ±1%) or equal diameter and/or length as the supply line 254.

In some aspects, as shown in FIG. 2M, the trailer system 200 may include a dump valve 258. In some aspects, one or more air lines 257 may connect and provide pneumatic communication (i) between a dump port of the first trailer leveling valve 208 to the dump valve 258 and (ii) between a dump port of the second trailer leveling valve 212 to the dump valve 258. In some aspects, an air line (not shown) may connect and provide pneumatic communication between the one or more trailer air supply tanks 214 and the dump valve 258. In some aspects, the dump valve 258 may be used to dump (manually or automatically) air from the trailer air springs 206 and 210. However, the dump valve 258 is not required, and, in some alternative aspects, as shown in FIGS. 2H-2L, 2N, 2P, and 2Q, the trailer system 200 may not include a dump valve.

In some aspects, as described above, the vehicle system 100 and/or trailer system 200 may integrate height control, load monitoring, and/or braking control. FIG. 2R illustrates a trailer system 200 integrating height control, load monitoring, and braking control according to some non-limiting aspects. Although an integrated trailer system 200 is illustrated in FIG. 2R, the vehicle system 100 may be integrated in a similar fashion.

In some aspects, as shown in FIG. 2R, the trailer 20 may be a triaxle trailer including axles 18, 19, and 21. However, three axles are not required, and, in alternative aspects, the trailer 20 may include a different number of axles (e.g., 1, 2, 4, 5, or more axles). In some aspects, similar to FIG. 2O, a trailer cross-flow set may be assigned to a group of axles (e.g., axles 18, 19, and 21) for the trailer 20. As shown in FIG. 2R, the trailer cross-flow set may include a first trailer air spring 206a that supports an axle 18 on a first side, a first trailer air spring 206b that supports an axle 19 on the first side, a first trailer air spring 206c that supports an axle 21 on the first side, a second trailer air spring 210a that supports the axle 18 on the second side, a second trailer air spring 210b that supports the axle 19 on the second side, a second trailer air spring 210c that supports the axle 21 on the second side, a first trailer leveling valve 208 that adjusts independently the height of the axles 18, 19, and 21 on the first side of the trailer 20 (e.g., by increasing or decreasing air in the first trailer air springs 206a-c), a second trailer leveling valve 212 that adjusts independently the height of the axles 18, 19, and 21 on the second side of the trailer 20 (e.g., by increasing or decreasing air in the second trailer air springs 210a-c), a trailer cross-flow passage 216, and a trailer cross-flow air pressure sensor 218. In some aspects, the pneumatic circuits (e.g., first and second trailer pneumatic circuits 202 and 204) of the trailer system 200 illustrated in FIG. 2R may be similar to the pneumatic circuits illustrated in FIG. 2Q.

In some aspects, as shown in FIG. 2R, the trailer system 200 may include one or more pressure sensors (e.g., pressure sensors 218, 220, and 222). In some aspects, the one or more pressure sensors may include a first side input connected pneumatically to the first trailer air springs 206a-206c on the first side of the trailer 20 (e.g., via air line 274), a second side input connected pneumatically to the second trailer air springs 210a-210c on the second side of the trailer 20 (e.g., via air line 276), and/or a cross-flow input connected pneumatically to the trailer cross-flow passage 216. In some aspects, the one or more pressure sensors may output first trailer air spring pressure information indicative of an air pressure within the first trailer air springs 206a-206c, second trailer air spring pressure information indicative of an air pressure within the second trailer air springs 210a-210c, and/or trailer cross-flow pressure information indicative of an air pressure within the trailer cross-flow passage 216. In some aspects, the one or more pressure sensors may include one or more ADCs and/or one or more amplifiers. In some aspects, the trailer pressure information may be an analog and/or digital electrical signals. In some aspects, the computer 124 may receive the trailer pressure information and calculate a first trailer air spring-based weight indicative of a weight on the first side of the trailer 20, a second trailer air spring-based weight indicative of a weight on the second side of the trailer 20, and/or a trailer cross-flow-based weight. In some aspects, the pressure and/or weight information (e.g., including weight information on each of the first and second sides of the trailer 20) may be used (e.g., by an electronic braking system (EBS), for anti-roll control (ARC), and/or for stability control) to control brake activation based on the actual weight on each side airbag group and/or the cross-flow-based weight. In some aspects, the pressure and/or weight information (e.g., digital pressure and/or weight information) may be transmitted to any remote system (e.g., via a communication unit 139) through wireless (e.g., Bluetooth or wifi) or wired communication.

In some aspects, the trailer system 200 may include first trailer brakes 234a-234c on the first side of the trailer 20 and second trailer brakes 236a-236c on the second side of the trailer 20. In some aspects, one or more of the trailer brakes 234a-234c and 236a-236c may include a brake booster. In some aspects, the first and second trailer brakes 234a-234c and 236a-236c may be configured to be controlled in accordance with trailer brake application levels calculated by the computer 124 of the vehicle system 100. In some aspects, a trailer brake application level applied to one of the first trailer brakes 234a-234c may be different than one or more of the trailer brake application levels applied to the other ones of the first trailer brakes 234a-234c. Similarly, in some aspects, a trailer brake application level applied to one of the second trailer brakes 236a-236c may be different than one or more of the trailer brake application levels applied to the other ones of the second trailer brakes 236a-236c. In some aspects, the brake application levels applied to the first trailer brakes 234a-234c may be different than or the same as the brake application levels applied to the second trailer brakes 236a-236c, respectively.

In some aspects, the computer 124 may apply the first and second trailer brake application levels to the first and second trailer brakes 234a-234c and 236a-236c via a valve block 260. In some aspects, the valve block 260 may be part of the computer 124. In some aspects, the valve block 260 may include one or more pressure modulator valves and/or one or more active braking valves (e.g., solenoid valves used for active braking) of the trailer 20. In some aspects, the valve block 260 may include, for example, three or more (e.g., four) brake spool solenoids on each side and may, therefore, have three or more outlets on each side. In some aspects, the outlets of the valve block 260 may be connected to the first and second trailer brakes 234a-234c and 236a-236c via air lines 268a-268c and 270a-270c, respectively. In some aspects, the valve block 260 may receive a constant supply of air from the one or more trailer air supply tanks 214 (e.g., via the an air line 262). In some aspects, the valve block 260 may include a service brake input configured to receive a brake pedal pressure signal indicative of a pressure (e.g., mechanical pressure) applied to a brake pedal of the vehicle 10 (e.g., by the foot of a driver of the vehicle 10). In some aspects, the valve block 260 may receive the brake pedal pressure signal via the trailer interface 134. In some aspects, the brake pedal pressure signal may be received from a towing vehicles brake supply system of the trailer 20. In some aspects, the brake pedal pressure signal may be a simple electrical signal or a variable millivolt (e.g., generated by a potentiometer or similar device). In some aspects, the first and second trailer brake application levels applied to the first and second trailer brakes 234a-234c and 236a-236c may be in accordance with the brake pedal pressure signal.

In some aspects, the computer 124 may control the valve block 260 to individually activate solenoids of the valve block 260 (e.g., to reduce brake output to prevent wheel lockup). In some aspects, the computer 124 may use speed information (e.g., output from the one or more speed sensors 232) and/or acceleration information (e.g., output from the one or more acceleration sensors 230) to individually activate solenoids of the valve block 260 for braking control. In some aspects, the computer 124 may additionally or alternatively use pressure information and/or weight information to individually activate solenoids of the valve block 260 for braking control. In some aspects, stability control, traction control, anti-lock brake system (ABS), automatic load-dependent braking (ALB), and/or anti-roll control may additionally or alternatively activate solenoids of the valve block 260 to individually supply air from the constant air supply to the first and second trailer brakes 234a-234c and 236a-236c to automatically control braking of the trailer 20.

In some aspects, the one or more pressure sensors may additionally or alternatively receive pressure inputs from the first and second trailer brakes 234a-234c and 236a-236c, and the one or more pressure sensors may output pressure information indicative of the air pressures within the first and second trailer brakes 234a-234c and 236a-236c. In some aspects, the first and second trailer brakes 234a-234c and 236a-236c and/or scales may have analog and/or digital capability for signal pressure. In some aspects, test points may be fitted to the valve block 260 for pressure testing and fault diagnosis in each of the circuits. In some aspects, one or more display 137, the one or more telematics units 141, and/or the one or more user interfaces, which may be part of an ECU of an OBM system, may have system diagnostics for fault diagnosis, which may be read remotely. In some aspects, the data may have remote download capability along with GPS tracking (e.g., within the EBS electronics). In some aspects, a weigh scales interface (e.g., the one or more displays 137) may be configured to switch between cross-flow pressure-based information to average of first and second side pressures-based information to maintain a constant total weight. In some aspects, the vehicle system 100 and/or trailer system 200 may vent residual pressure from the cross-flow passage 116 and/or trailer cross-flow passage 216 when the leveling valves move out of cross-flow to allow for an updated pressure read, as pressures for weight can change constantly. In some aspects, if weight shifts and the cross-flow is closed, a digital read out (e.g., on the one or more displays 137) may split weight per side to show the operator where the load has shifted and how much weight is on each side of the vehicle 10 or the trailer 20.

In some aspects, as illustrated in FIGS. 2S-2U, the trailer 20 may be a two axle trailer (e.g., a two axle dolly). In some aspects, as shown in FIGS. 2T and 2U, the trailer 20 may include axles 18 and 19. In some aspects, as shown in FIG. 2U, the trailer 20 may include a first trailer air spring 206a that supports the axle 18 on a first side, a first trailer air spring 206b that supports the axle 19 on the first side, a second trailer air spring 210a that supports the axle 18 on a second side, and a second trailer air spring 210b that supports the axle 19 on the second side.

In some aspects, as shown in FIG. 2U, the trailer 20 may include a first trailer leveling valve 208 that adjusts independently the height of the axle 19 on the first side of the trailer 20 (e.g., by increasing or decreasing air in the first trailer air spring 206b), a second trailer leveling valve 212 that adjusts independently the height of the axle 19 on the second side of the trailer 20 (e.g., by increasing or decreasing air in the second trailer air spring 210b), and a first trailer cross-flow passage 216a that connects the first trailer leveling valve 208 with the second trailer leveling valve 212. In some aspects, the trailer 20 may include a third trailer leveling valve 280 that adjusts the height of the axle 18 on the first and second sides (e.g., by increasing or decreasing air in the first and second trailer air springs 206a and 210a), and a second trailer cross-flow passage 216b that connects the third trailer leveling valve 280 with the first trailer cross-flow passage 216a (and therefore the first and second trailer leveling valves 208 and 212). In some aspects, the trailer 20 may include a fitting 284 (e.g., a T-fitting) that connects the second trailer cross-flow passage 216b to the first trailer cross-flow passage 216a.

In some aspects, as shown in FIG. 2U, two or more of the first, second, and third leveling trailer leveling valves 208, 212, and 280 may establish pneumatic communication via the trailer cross-flow passages 216a and/or 216b when none of the two or more of the first, second, and third leveling trailer leveling valves 208, 212, and 280 is adjusting the height of an axle of the trailer 20. In some aspects, the pneumatic communication between the first, second, and third leveling trailer leveling valves 208, 212, and 280 via the trailer cross-flow passages 216a and 216b may equalize air pressure between the first trailer air springs 206a and 206b and the second trailer air springs 110a and 110b. In some aspects, the adjustment of the height of the axle 18 by the third leveling valve 280, which is independent of the height adjustment of the first and second sides of the axle 19 by the first and second trailer leveling valves 208 and 212, may reduce or prevent front to back pitching (e.g., a see saw effect) that might otherwise occur (e.g., when the trailer 20 is braking or accelerating).

In some aspects, as shown in FIG. 2U, the trailer 20 may include one or more trailer air supply tanks 214 that supply the first leveling valve 208 (e.g., via a PPV 219 and an air line 286), the second leveling valve 212 (e.g., via the PPV 219 and an air line 288), and the third leveling valve 280 (e.g., via a PPV 282 and an air line 298). In some aspects, the first leveling valve 208 may supply air to or remove air from the first trailer air spring 206b via an air line 290, and the second leveling valve 212 may supply air to or remove air from the second trailer air spring 210b via an air line 292. In some aspects, the third leveling valve 280 may supply air to or remove air from the first trailer air spring 206a via an air line 294, and the third leveling valve 280 may supply air to or remove air from the second trailer air spring 210a via an air line 296.

In some aspects, as illustrated in FIGS. 2V-2X, the trailer 20 may be a three axle trailer (e.g., a tri axle dolly). In some aspects, as shown in FIGS. 2W and 2X, the trailer 20 may include axles 18, 19, and 21. In some aspects, as shown in FIG. 2X, the trailer 20 may include a first trailer air spring 206a that supports the axle 18 on a first side, a first trailer air spring 206b that supports the axle 19 on the first side, a first trailer air spring 206c that supports the axle 21 on the first side, a second trailer air spring 210a that supports the axle 18 on a second side, a second trailer air spring 210b that supports the axle 19 on the second side, and a second trailer air spring 210c that supports the axle 21 on the second side.

In some aspects, as shown in FIG. 2X, the trailer 20 may include a first trailer leveling valve 208 that adjusts independently the height of the axles 19 and 21 on the first side of the trailer 20 (e.g., by increasing or decreasing air in the first trailer air springs 206b and 206c), a second trailer leveling valve 212 that adjusts independently the height of the axles 19 and 21 on the second side of the trailer 20 (e.g., by increasing or decreasing air in the second trailer air springs 210b and 210c), and a first trailer cross-flow passage 216a that connects the first trailer leveling valve 208 with the second trailer leveling valve 212. In some aspects, the trailer 20 may include a third trailer leveling valve 280 that adjusts the height of the axle 18 on the first and second sides (e.g., by increasing or decreasing air in the first and second trailer air springs 206a and 210a), and a second trailer cross-flow passage 216b that connects the third trailer leveling valve 280 with the first trailer cross-flow passage 216a (and therefore the first and second trailer leveling valves 208 and 212). In some aspects, the trailer 20 may include a fitting 284 (e.g., a T-fitting) that connects the second trailer cross-flow passage 216b to the first trailer cross-flow passage 216a.

In some aspects, as shown in FIG. 2X, two or more of the first, second, and third leveling trailer leveling valves 208, 212, and 280 may establish pneumatic communication via the trailer cross-flow passages 216a and/or 216b when none of the two or more of the first, second, and third leveling trailer leveling valves 208, 212, and 280 is adjusting the height of an axle (or axles) of the trailer 20. In some aspects, the pneumatic communication between the first, second, and third leveling trailer leveling valves 208, 212, and 280 via the trailer cross-flow passages 216a and 216b may equalize air pressure between the first trailer air springs 206a-206c and the second trailer air springs 110a-110c. In some aspects, the adjustment of the height of the axle 18 by the third leveling valve 280, which is independent of the height adjustment of the first and second sides of the axles 19 and 21 by the first and second trailer leveling valves 208 and 212, may reduce or prevent front to back pitching (e.g., a see saw effect) that might otherwise occur (e.g., when the trailer 20 is braking or accelerating).

In some aspects, as shown in FIG. 2X, the trailer 20 may include one or more trailer air supply tanks 214 that supply the first leveling valve 208 (e.g., via a PPV 219 and an air line 286), the second leveling valve 212 (e.g., via the PPV 219 and an air line 288), and the third leveling valve 280 (e.g., via a PPV 282 and an air line 298). In some aspects, the first leveling valve 208 may supply air to or remove air from the first trailer air spring 206b via an air line 290, the first leveling valve 208 may supply air to or remove air from the first trailer air spring 206c via an air line 291, the second leveling valve 212 may supply air to or remove air from the second trailer air spring 210b via an air line 292, and the second leveling valve 212 may supply air to or remove air from the second trailer air spring 210c via an air line 293. In some aspects, the third leveling valve 280 may supply air to or remove air from the first trailer air spring 206a via an air line 294, and the third leveling valve 280 may supply air to or remove air from the second trailer air spring 210a via an air line 296.

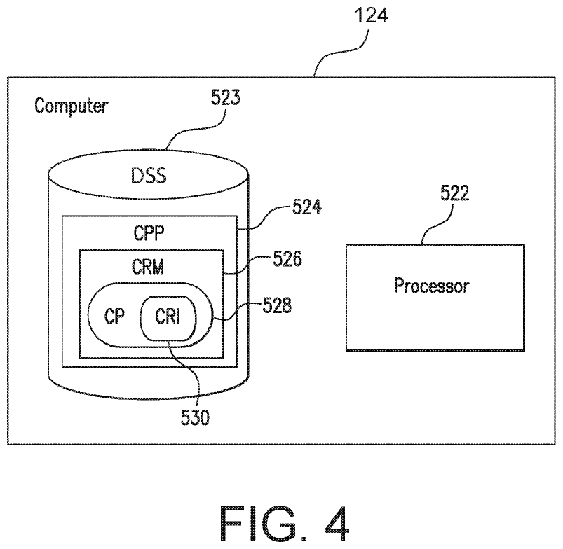

FIG. 4 is a block diagram of a non-limiting aspect of the computer 124 of the vehicle system 100. As shown in FIG. 4, in some aspects, the computer 124 may include one or more processors 522 (e.g., a general purpose microprocessor) and/or one or more circuits, such as an application specific integrated circuit (ASIC), field-programmable gate arrays (FPGAs), a logic circuit, and the like. In some aspects, the computer 124 may include a data storage system (DSS) 523. The DSS 523 may include one or more non-volatile storage devices and/or one or more volatile storage devices (e.g., random access memory (RANI)). In aspects where the computer 124 includes a processor 522, the DSS 523 may include a computer program product (CPP) 524. CPP 524 may include or be a computer readable medium (CRM) 526. The CRM 526 may store a computer program (CP) 528 comprising computer readable instructions (CRI) 530. The CRM 526 may be a non-transitory computer readable medium, such as, but not limited, to magnetic media (e.g., a hard disk), optical media (e.g., a DVD), solid state devices (e.g., random access memory (RAM) or flash memory), and the like. In some aspects, the CRI 530 of computer program 528 may be configured such that when executed by processor 522, the CRI 530 causes the computer 124 to perform one or more of the steps described below with reference to the vehicle 10 and/or trailer 20. In other aspects, the computer 124 may be configured to perform steps described herein without the need for a computer program. That is, for example, the computer may consist merely of one or more ASICs. Hence, the features of the aspects described herein may be implemented in hardware and/or software.

In some aspects, the computer 124 may be located entirely on the vehicle 10. However, this is not required, and, in some alternative aspects, one portion of the computer 124 may be located on the vehicle 10, and another portion of the computer 124 (e.g., one or more processors, one or more ADCs 126, and/or one or more amplifiers 127) may be located on the trailer 20. In some aspects, one or more of the pressure sensors 118, 120, 122, 218, 220, and 222 may be pressure transducers. In some aspects, as shown in FIGS. 2A, 2D, 3A, 3B, and 3D, the pressure sensors 118, 120, 122, 218, 220, and/or 222 may be separate from the computer 124. In these aspects, the computer 124 may receive pressure information from one or more pressure sensors (e.g., either directly from the pressure sensor as an analog electrical signal or indirectly from the pressure sensor as a digital electrical signal after being converted by an ADC). However, this is not required, and, in some alternative aspects, as shown in FIGS. 3C and 3E, the computer 124 may include one or more of the pressure sensors 118, 120, 122, 218, 220, and 222. In these aspects, computer 124 may receive one or more air flow lines as inputs.

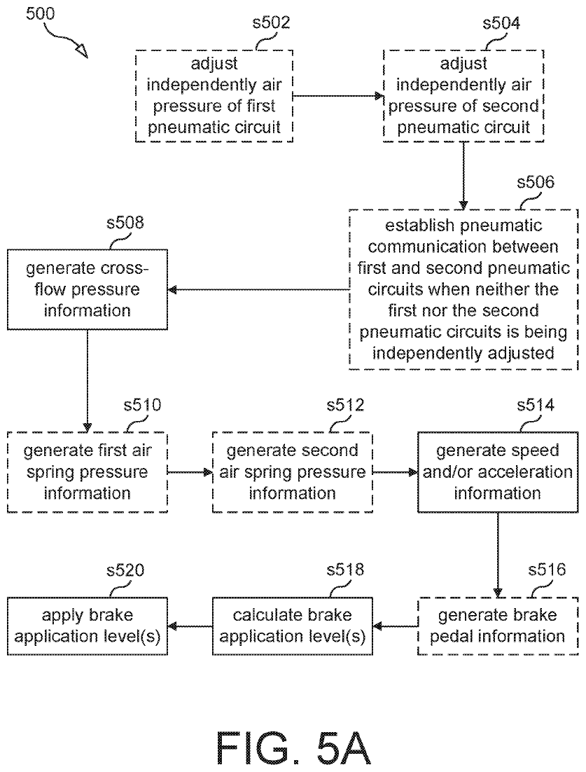

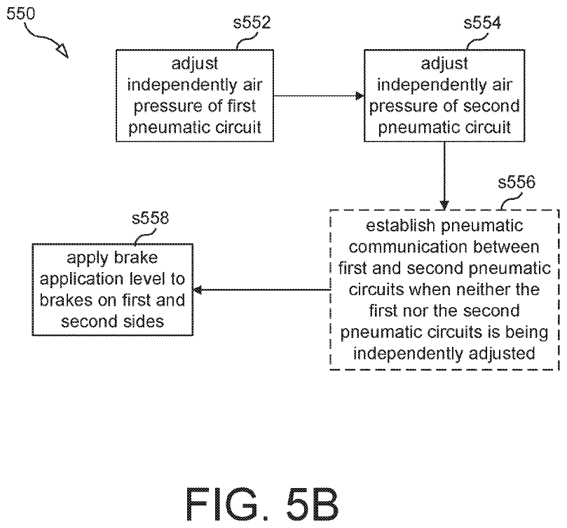

FIG. 5A is a flow chart illustrating a braking control process 500 according to some non-limiting aspects of the invention. In some aspects, the vehicle 10 and/or trailer 20 (e.g., the computer 124 of the vehicle 10 and/or trailer 20) may perform one or more steps of the process 500.

In some aspects, as shown in FIG. 5A, the process 500 may include an optional step 502 in which the first leveling valve 108 of the first pneumatic circuit 102 adjusts independently the height of the first side of the vehicle 10. In some aspects, the first leveling valve 108 may adjust independently the height of the first side of the vehicle 10 by increasing or decreasing air in the one or more first air springs 106. In some aspects, the first leveling valve 108 of the first pneumatic circuit 102 may adjust independently the height of the first side of the vehicle 10 to keep the vehicle 10 in (or return the vehicle 10 to) a level state.

In some aspects, as shown in FIG. 5A, the process 500 may include an optional step 504 in which the second leveling valve 112 of the second pneumatic circuit 104 adjusts independently the height of the second side of the vehicle 10. In some aspects, the second leveling valve 112 may adjust independently the height of the second side of the vehicle 10 by increasing or decreasing air in the one or more second air springs 110. In some aspects, the second leveling valve 112 of the second pneumatic circuit 104 may adjust independently the height of the second side of the vehicle 10 to keep the vehicle 10 in (or return the vehicle 10 to) a level state.

In some aspects, as shown in FIG. 5A, the process 500 may include an optional step 506 in which the first and second leveling valves 108 and 112 establish pneumatic communication between the first and second pneumatic circuits 102 and 104 via the cross-flow passage 116 when neither the first leveling valve 108 is adjusting independently the height of the first side of the vehicle 10 nor the second leveling valve 112 is adjusting independently the height of the second side of the vehicle 10.

In some aspects, as shown in FIG. 5A, the process 500 may include a step 508 in which a cross-flow air pressure sensor 118 outputs cross-flow pressure information indicative of an air pressure within the cross-flow passage 116 connecting the first leveling valve 108 of the first pneumatic circuit 102 with the second leveling valve 112 of the second pneumatic circuit 104. In some aspects, the computer 124 may receive the cross-flow pressure information.

In some aspects, as shown in FIG. 5A, the process 500 may include an optional step 510 in which the first air spring air pressure sensor 120 outputs first air spring pressure information indicative of an air pressure within the one or more first air springs 106 of the first pneumatic circuit 102. In some aspects, as shown in FIG. 5A, the process 500 may include an optional step 512 in which the second air spring air pressure sensor 120 outputs second air spring pressure information indicative of an air pressure within the one or more second air springs 110 of the second pneumatic circuit 104. In some aspects, the computer 124 may receive the first air spring pressure information and/or the second air spring pressure information.

In some aspects, as shown in FIG. 5A, the process 500 may include a step 514 in which the one or more speed sensors 132 output speed information indicative of a speed of the vehicle 10 and/or the one or more acceleration sensors 130 output acceleration information indicative of an acceleration of the vehicle 10. In some aspects, the computer 124 may receive the speed information and/or the acceleration information.

In some aspects, as shown in FIG. 5A, the process 500 may include an optional step 516 in which the brake pedal sensor 128 outputs a brake pedal pressure signal indicative of a pressure applied to a brake pedal of the vehicle 10. In some aspects, the computer 124 may receive the brake pedal pressure signal.

In some aspects, as shown in FIG. 5A, the process 500 may include a step 518 in which the computer 124 calculates first and second brake application levels. In some aspects, the computer 124 may calculate the first and second brake application levels using one or more of the speed and/or acceleration information and the cross-flow pressure information. In some aspects, the computer 124 may additionally use one or more of the brake pedal pressure signal, steering angle information, the first air spring pressure information, and the second air spring pressure information to calculate the first and second brake application levels. In some aspects, the computer 124 may use the speed information and the acceleration information to calculate the first and second brake application levels. In some aspects, the first and second brake application levels may be brake application pressure levels.

In some aspects, as shown in FIG. 5A, the process 500 may include a step 520 in which the computer 124 applies the first and second brake application levels. In some aspects, the computer 124 may apply the calculated first brake application level to the one or more first brakes 134 on the first side of the vehicle 10. In some aspects, the computer 124 may apply the calculated second brake application level to the one or more second brakes 136 on the second side of the vehicle 10.

In some aspects, the optional step 502 may additionally or alternatively include the first trailer leveling valve 208 of the first trailer pneumatic circuit 202 adjusting independently the height of the first side of the trailer 20. In some aspects, the first trailer leveling valve 208 may adjust independently the height of the first side of the trailer 20 by increasing or decreasing air in the one or more first trailer air springs 206. In some aspects, the first trailer leveling valve 208 of the first trailer pneumatic circuit 202 may adjust independently the height of the first side of the trailer 20 to keep the trailer 20 in (or return the trailer 20 to) a level state.

In some aspects, the optional step 504 may additionally or alternatively include the second trailer leveling valve 212 of the second trailer pneumatic circuit 204 adjusting independently the height of the second side of the trailer 20. In some aspects, the second trailer leveling valve 212 may adjust independently the height of the second side of the trailer 20 by increasing or decreasing air in the one or more trailer second air springs 210. In some aspects, the second trailer leveling valve 212 of the second trailer pneumatic circuit 204 may adjust independently the height of the second side of the trailer 20 to keep the trailer 20 in (or return the trailer 20 to) a level state.

In some aspects, the optional step 506 may additionally or alternatively include the first and second trailer leveling valves 208 and 212 establishing pneumatic communication between the first and second trailer pneumatic circuits 202 and 204 via the trailer cross-flow passage 216 when neither the first trailer leveling valve 208 is adjusting independently the height of the first side of the trailer 20 nor the second trailer leveling valve 212 is adjusting independently the height of the second side of the trailer 20.

In some aspects, the step 508 may additionally or alternatively include the trailer cross-flow air pressure sensor 218 outputting trailer cross-flow pressure information indicative of an air pressure within the trailer cross-flow passage 216 connecting the first trailer leveling valve 208 of the first trailer pneumatic circuit 202 with the second trailer leveling valve 212 of the second trailer pneumatic circuit 204. In some aspects, the computer 124 may receive the trailer cross-flow pressure information (e.g., via the trailer interface 143).

In some aspects, the step 508 may additionally or alternatively include one or more axle load sensors 111 outputting axle strain information indicative of the strain in one or more vehicle axles. In some aspects, the step 508 may additionally or alternatively include one or more trailer axle load sensors 211 outputting trailer axle strain information indicative of the strain in one or more trailer axles.

In some aspects, the optional step 510 may additionally or alternatively include the first trailer air spring air pressure sensor 220 outputting first trailer air spring pressure information indicative of an air pressure within the one or more first trailer air springs 206 of the first trailer pneumatic circuit 202. In some aspects, the optional step 512 may additionally or alternatively include the second trailer air spring air pressure sensor 220 outputting second trailer air spring pressure information indicative of an air pressure within the one or more second trailer air springs 210 of the second trailer pneumatic circuit 204. In some aspects, the computer 124 may receive the first trailer air spring pressure information and/or the second trailer air spring pressure information (e.g., via the trailer interface 143).

In some aspects, the step 514 may additionally or alternatively include the one or more trailer speed sensors 232 outputting trailer speed information indicative of a speed of the trailer 20 and/or the one or more trailer acceleration sensors 230 outputting trailer acceleration information indicative of an acceleration of the trailer 20. In some aspects, the computer 124 may receive the trailer speed information and/or the trailer acceleration information (e.g., via the trailer interface 143).

In some aspects, in the step 518, the computer 124 may additionally use one or more of the trailer speed information, the trailer acceleration information, the trailer cross-flow pressure information, the first trailer air spring pressure information, and the second trailer air spring pressure information to calculate the first and second brake application levels. For example, if the trailer cross flow pressure information indicates that the trailer 20 is empty (unladen), half loaded (half laden) or loaded (full laden), the computer 124 may decrease or increase the first and second brake application levels.

In some aspects, in the step 518, the computer 124 may additionally or alternatively calculate first and second trailer brake application levels. In some aspects, the computer 124 may calculate the first and second trailer brake application levels using one or more of the vehicle speed information, the trailer speed information, the vehicle acceleration information, the steering angle information, the trailer acceleration information, the cross-flow pressure information, and the trailer cross-flow pressure information. In some aspects, the computer 124 may additionally use the brake pedal pressure signal, the first trailer air spring pressure information, and/or the second trailer air spring pressure information to calculate the first and second trailer brake application levels. In some aspects, the first and second trailer brake application levels may be brake application pressure levels.

In some aspects, using the brake pedal pressure signal, the computer 124 may calculate first and second brake application levels and/or first and second trailer brake application levels appropriate for the amount of pressure being applied to the brake pedal of the vehicle 10. In some aspects, the calculated first and second brake application levels may be in proportion to the brake pedal pressure signal. In some aspects, the calculated first and second brake application levels and/or first and second trailer brake application levels may increase as the brake pedal pressure signal increases. In some aspects, using the speed information, the computer 124 may calculate increased first and second brake application levels appropriate for the speed at which the vehicle 10 and trailer 20 are traveling. In some aspects, the calculated first and second brake application levels may be in proportion to the speed at which the vehicle 10 and trailer 20 are traveling. In some aspects, the calculated first and second brake application may increase as the speed at which the vehicle 10 and trailer 20 are traveling increases.

In some aspects, the computer 124 may calculate the first and second brake application levels and/or the first and second trailer brake application levels to optimally distribute brake forces throughout the system. In some aspects, the computer 124 may calculate the first and second brake application levels and/or the first and second trailer brake application levels to perform one or more of functions of an anti-lock brake system (ABS), automatic load-dependent braking (ALB), and an electronic braking system (EBS). In some aspects, the first and second leveling valves 108 and 112 (and/or the first and second trailer leveling valves 208 and 212), which adjust independently the height of the first and second sides of the vehicle 10 and/or the trailer 20 to keep the vehicle 10 and/or the trailer 20 level and increase stability, may enhance one or more of the functions of the ABS, ALB, and EBS by reducing the amount and/or severity of conditions addressed by the ABS, ALB, and/or EBS. That is, the first and second leveling valves 108 and 112 (and/or the first and second trailer leveling valves 208 and 212) may reduce the amount and/or frequency of occurrences in which the functions of the ABS, ALB, and/or EBS are called into action.

In some aspects, an ABS may be designed to react to extreme braking events (e.g., by providing and maintaining the best possible traction and steering control during an extreme braking event). In some aspects, during a potential wheel lock event, the computer 124 may apply one or more brake application levels to one or more of the first and second brakes 134 and 136 and/or one or more of the first and second trailer brakes 234 and 236 to hold, apply, or release the one or more of the first and second brakes 134 and 136 and/or one or more of the first and second trailer brakes 234 and 236 as needed. In some aspects, the computer 124 may use the speed information and/or the acceleration information received from one or more speed sensors 132 and/or the one or more acceleration sensors 130 to calculate the one or more brake application levels.

In some aspects, the EBS may detect and control what is going on with each individual wheel set. In some aspects, the EBS may be predictive in addition to reactive (e.g., the EBS may use sensor information to predict that a dangerous situation such as jackknifing is about to occur and take action to prevent the dangerous situation from occurring). In some aspects, the EBS may include, for example and without limitation, one or more of stability control (e.g., electronic stability control (ESC), electronic stability program (ESP), dynamic stability control (DSC), and/or vehicle stability control (VSC)), traction control (e.g., automatic traction control (ATC)), ABS, ALB, and/or anti-roll control (e.g., roll stability system (RSS), roll stability program (RSP), and/or roll stability control (RSC)). In some aspects, the stability control may include measuring the yaw rate and/or lateral acceleration of the vehicle 10 and/or the trailer 20. In some aspects, the traction control may help improve traction in low traction road conditions and/or may minimize skids (e.g., by applying different brake application levels to different wheels). In some aspects, the traction control may reduce the potential of jackknifing caused by excessive wheel spin during acceleration or in curves. In some aspects, the traction control may, when one drive wheel is spinning at a different speed than the other, momentarily apply one or more of the brakes 134, 136, 234, and 236 until traction is regained and/or may, when both drive wheels are spinning on a poor-traction surface, automatically reduce engine power to attain optimum tire-to-road traction.

In some aspects, to provide automatic load-dependent braking (ALB), the computer 124 may calculate increased or decreased first and second brake application levels and/or the first and second trailer brake application levels based on whether (and/or the extent to which) the pressure information (e.g., cross-flow pressure information trailer cross-flow pressure information) indicates heavy or light loads on an axle or axle group. For instance, the computer 124 may calculate increased braking applications when the pressure information indicates a heavy load on the vehicle 10 and/or trailer 20 and decreased braking application levels when the pressure information indicates a light load (or no load) on the vehicle 10 and/or trailer 20.

In some aspects, to provide anti-roll control (e.g., RSS, RSP, and/or RSC), the acceleration information output by the one or more acceleration sensors 130 and/or 230 indicates lateral acceleration of the vehicle 10 and/or trailer 20 above a roll threshold, the computer 124 may calculate the first and second brake application levels and/or the first and second trailer brake application levels to immediately brake the vehicle 10 and/or the trailer 20 and reduce the risk of skidding and/or the vehicle 10 and/or the trailer 20 tipping over. In some aspects, the anti-roll control may apply the brakes differently to particular wheels to prevent a rollover from occurring. In some aspects, when conditions indicate the potential for a rollover, the anti-roll control may reduce engine torque, engage an engine retarder, apply pressure to the brakes 134 and 136 (e.g., drive axle brakes alone or in combination with steer axle brakes), and/or modulate the trailer brakes 234 and 236 to slow the vehicle 10 and/or trailer 20 down.

In some aspects, the step 520 may additionally or alternatively include the computer 124 applying the first and second trailer brake application levels. In some aspects, the computer 124 may apply the calculated first trailer brake application level to the one or more first trailer brakes 234 on the first side of the trailer 20 (e.g., via the trailer interface 143). In some aspects, the computer 124 may apply the calculated second trailer brake application level to the one or more second trailer brakes 236 on the second side of the trailer 10 (e.g., via the trailer interface 143).

In some aspects in which the vehicle 10 includes multiple cross-flow sets and/or multiple trailer cross-flow sets, each of the steps 502, 504, 506, 508, 510, and 512 may be performed for each of the multiple cross-flow sets and/or each of the multiple trailer cross-flow sets. In some aspects, the step 518 may include using information (e.g., cross-flow pressure information, first air spring pressure information, second air spring pressure information, trailer cross-flow pressure information, first trailer air spring pressure information, and/or second trailer air spring pressure information) from multiple cross-flow sets and/or multiple trailer cross-flow sets when calculating one or more of the vehicle and/or trailer brake application levels.

For example, in some aspects, the calculation of brake application levels in step 518 may include determining and using a difference (and/or a change in the difference) between (i) cross-flow pressure information indicative of an air pressure in a cross-flow passage 116 or 216 of a first cross-flow set associated with an axle or axle group that is relatively close to the front of the vehicle 10 or trailer 20 and (ii) cross-flow pressure information indicative of an air pressure in a cross-flow passage 116 or 216 of a second cross-flow set associated with an axle or axle group that is relatively close to the back of the vehicle 10 or trailer 20. For example, in some aspects, the calculation of brake application levels in step 518 may include determining and using a difference (and/or a change in the difference) between (i) a load on a first axle or axle set of the vehicle 10 or trailer 20 that is relatively close to the front of the vehicle 10 or trailer 20 and (ii) a load on a second axle or axle set of the vehicle 10 or trailer 20 that is relatively close to the back of the vehicle 10 or trailer 20. In some aspects, the load on the first axle or axle set may be indicated by, for example and without limitation, cross-flow pressure information or axle strain information, and the load on the second axle or axle set may be indicated by, for example and without limitation, cross-flow pressure information.

In some aspects, use of the cross-flow pressure information, which is indicative of the weight or mass on one or more axles of the vehicle 10 or the trailer 20 may enable vehicle and/or trailer operators to obtain on board mass information sufficient to apply for over dimension under performance based standards (PBS) and/or permits for various additional road access under a main roads framework. For example, by using cross-flow pressure information, a vehicle that is permitted to carry 9 tons on a single axle drive may be permitted to carry 10 tons after meeting the PBS as shown by the on board mass information.

In some aspects, the process 500 may include (e.g., in step 518) the computer 124 conveying digital pressure information (e.g., cross-flow pressure information, first air spring pressure information, second air spring pressure information, trailer cross-flow pressure information, first trailer air spring pressure information, and/or second trailer air spring pressure information), one or more weights calculated by the computer 124 using the pressure information, speed information, acceleration information, and/or first and second brake application levels to the one or more telematics units 141. In some aspects, the one or more telematics units 141 may receive the information and store and/or communicate it.

FIG. 5B is a flow chart illustrating an alternative braking control process 550 according to some non-limiting aspects of the invention. In some aspects, the vehicle 10 and/or trailer 20 (e.g., the computer 124 of the vehicle 10 and/or trailer 20) may perform one or more steps of the process 550.

In some aspects, as shown in FIG. 5B, the process 550 may include a step 552 in which the first leveling valve 108 of the first pneumatic circuit 102 adjusts independently the height of the first side of the vehicle 10. In some aspects, the first leveling valve 108 may adjust independently the height of the first side of the vehicle 10 by increasing or decreasing air in the one or more first air springs 106. In some aspects, in step 552, the first leveling valve 108 of the first pneumatic circuit 102 may adjust independently the height of the first side of the vehicle 10 to keep the vehicle 10 in (or return the vehicle 10 to) a level state.

In some aspects, as shown in FIG. 5B, the process 550 may include a step 554 in which the second leveling valve 112 of the second pneumatic circuit 104 adjusts independently the height of the second side of the vehicle 10. In some aspects, the second leveling valve 112 may adjust independently the height of the second side of the vehicle 10 by increasing or decreasing air in the one or more second air springs 110. In some aspects, in step 554, the second leveling valve 112 of the second pneumatic circuit 104 may adjust independently the height of the second side of the vehicle 10 to keep the vehicle 10 in (or return the vehicle 10 to) a level state.

In some aspects, as shown in FIG. 5B, the process 550 may include an optional step 556 in which the first and second leveling valves 108 and 112 establish pneumatic communication between the first and second pneumatic circuits 102 and 104 via the cross-flow passage 116 when neither the first leveling valve 108 is adjusting independently the height of the first side of the vehicle 10 nor the second leveling valve 112 is adjusting independently the height of the second side of the vehicle 10.

In some aspects, as shown in FIG. 5B, the process 550 may include a step 558 of applying a brake application level to the one or more first brakes 134 on the first side of the vehicle 10 and the one or more second brakes 136 on the second side of the vehicle 10. In some aspects, the step 558 may include applying only the same brake application level to the both first and second brakes 134 and 136. In some aspects, the brake application level may be in proportion to a pressure applied to a brake pedal of the vehicle 10. In some aspects, the brake application level may increase as the pressure applied to a brake pedal of the vehicle 10 (e.g., as indicated by the brake pedal pressure signal) increases.

In some aspects, the independent adjustment of the height of the first and second sides of the vehicle 10 in steps 552 and 554 may be so effective at keeping the vehicle 10 in (or close to) a level state that different brake application levels for the first and second brakes 134 and 136 on the first and second sides of the vehicle 10 are not necessary or are not activated under dynamic driving conditions. In some aspects, the independent adjustment of the height of the first and second sides of the vehicle 10 in steps 552 and 554 may be so effective at keeping the vehicle 10 in (or close to) a level state that one or more of ABS, ALB, and EBS are not necessary or are not activated under dynamic driving conditions. In some aspects, the independent adjustment of the height of the first and second sides of the vehicle 10 in steps 552 and 554 may be so effective at keeping the vehicle 10 in (or close to) a level state that one or more of stability control, traction control, ABS, ALB, and anti-roll control systems are not necessary or are not activated under dynamic driving conditions.

In some aspects, the step 558 may include a brake pedal sensor 128 outputting a brake pedal pressure signal indicative of the pressure (e.g., mechanical pressure) applied to the brake pedal of the vehicle 10 (e.g., by the foot of a driver of the vehicle 10). In some aspects, in step 558, the computer 124 may receive the brake pedal pressure signal. In some aspects, the step 558 may include the computer 124 calculating the brake application level using the brake pedal pressure signal. In some aspects, the computer 124 may calculate the brake application level using one or more of the brake pedal pressure signal, speed and/or acceleration information, and cross-flow pressure information. In some alternative aspects, the computer 124 may use only the brake pedal pressure signal to calculate the brake application level. In some aspects, the computer 124 may apply the calculated brake application level to the one or more first brakes 134 on the first side of the vehicle 10 and the one or more second brakes 136 on the second side of the vehicle 10. In some alternative aspects, a computer (e.g., the computer 124) may not be used in step 558 to apply the brake application level to the first and second brakes 134 and 136 (e.g., a conventional hydraulically or pneumatically controlled braking control system may be used).

In some aspects, the step 552 may additionally or alternatively include the first trailer leveling valve 208 of the first trailer pneumatic circuit 202 adjusting independently the height of the first side of the trailer 20. In some aspects, the first trailer leveling valve 208 may adjust independently the height of the first side of the trailer 20 by increasing or decreasing air in the one or more first trailer air springs 206. In some aspects, in step 552, the first trailer leveling valve 208 of the first trailer pneumatic circuit 202 may adjust independently the height of the first side of the trailer 20 to keep the trailer 20 in (or return the trailer 20 to) a level state.

In some aspects, the step 554 may additionally or alternatively include the second trailer leveling valve 212 of the second trailer pneumatic circuit 204 adjusting independently the height of the second side of the trailer 20. In some aspects, the second trailer leveling valve 212 may adjust independently the height of the second side of the trailer 20 by increasing or decreasing air in the one or more second trailer air springs 210. In some aspects, in step 554, the second trailer leveling valve 212 of the second trailer pneumatic circuit 204 may adjust independently the height of the second side of the trailer 20 to keep the trailer 20 in (or return the trailer 20 to) a level state.

In some aspects, the optional step 556 may additionally or alternatively include the first and second trailer leveling valves 208 and 212 establishing pneumatic communication between the first and second trailer pneumatic circuits 202 and 204 via the trailer cross-flow passage 216 when neither the first trailer leveling valve 208 is adjusting independently the height of the first side of the trailer 20 nor the second trailer leveling valve 212 is adjusting independently the height of the second side of the trailer 20.

In some aspects, the step 558 may additionally or alternatively include applying a brake application level to the one or more first trailer brakes 234 on the first side of the trailer 20 and the one or more second trailer brakes 236 on the second side of the trailer 20. In some aspects, the step 558 may include applying only the same brake application level to the first and second trailer brakes 234 and 236. In some aspects, the brake application level may be in proportion to a pressure applied to a brake pedal of the vehicle 10. In some aspects in which a brake application level is applied to the first and second brakes 134 and 136 and a brake application level is applied to the first and second trailer brakes 234 and 236, the brake application level applied to the first and second brakes 134 and 136 may be the same as or different than the brake application level applied to the first and second trailer brakes 234 and 236.

In some aspects, the process 500 may include (e.g., in step 558) the computer 124 conveying digital pressure information (e.g., cross-flow pressure information, first air spring pressure information, second air spring pressure information, trailer cross-flow pressure information, first trailer air spring pressure information, and/or second trailer air spring pressure information), one or more weights calculated by the computer 124 using the pressure information, speed information, acceleration information, and/or brake application level to the one or more telematics units 141. In some aspects, the one or more telematics units 141 may receive the information and store and/or communicate it.

In some aspects, the independent adjustment of the height of the first and second sides of the trailer 20 in steps 552 and 554 may be so effective at keeping the trailer 20 in (or close to) a level state that different brake application levels for the first and second trailer brakes 234 and 236 on the first and second sides of the trailer 20 are not necessary. In some aspects, the independent adjustment of the height of the first and second sides of the trailer 20 in steps 552 and 554 may be so effective at keeping the trailer 20 in (or close to) a level state that one or more of ABS, ALB, and EBS are not necessary. In some aspects, the independent adjustment of the height of the first and second sides of the trailer 20 in steps 552 and 554 may be so effective at keeping the trailer 20 in (or close to) a level state that one or more of stability control, traction control, ABS, ALB, and/or anti-roll control systems are not necessary.

In some aspects in which the step 558 includes applying a brake application level to the first and second trailer brakes 234 and 236 of the trailer 20, the step 558 may include a brake pedal sensor 128 outputting a brake pedal pressure signal indicative of the pressure applied to the brake pedal of the vehicle 10. In some aspects, in step 558, the computer 124 may receive the brake pedal pressure signal. In some aspects, the step 558 may include the computer 124 calculating the brake application level for the first and second trailer brakes 234 and 236 using the brake pedal pressure signal. In some aspects, the computer 124 may calculate the brake application level for the first and second trailer brakes 234 and 236 using one or more of the brake pedal pressure signal, speed and/or acceleration information, and cross-flow pressure information. In some alternative aspects, the computer 124 may use only the brake pedal pressure signal to calculate the brake application level for the first and second trailer brakes 234 and 236. In some aspects, the computer 124 may apply the calculated brake application level to the one or more first trailer brakes 234 on the first side of the trailer 20 and the one or more second trailer brakes 236 on the second side of the trailer 20. In some alternative aspects in which the step 558 includes applying a brake application level to the first and second trailer brakes 234 and 236 of the trailer 20, a computer (e.g., the computer 124) may not be used in step 558 to apply the brake application level to the first and second trailer brakes 234 and 236 (e.g., a conventional hydraulically or pneumatically controlled braking control system may be used).

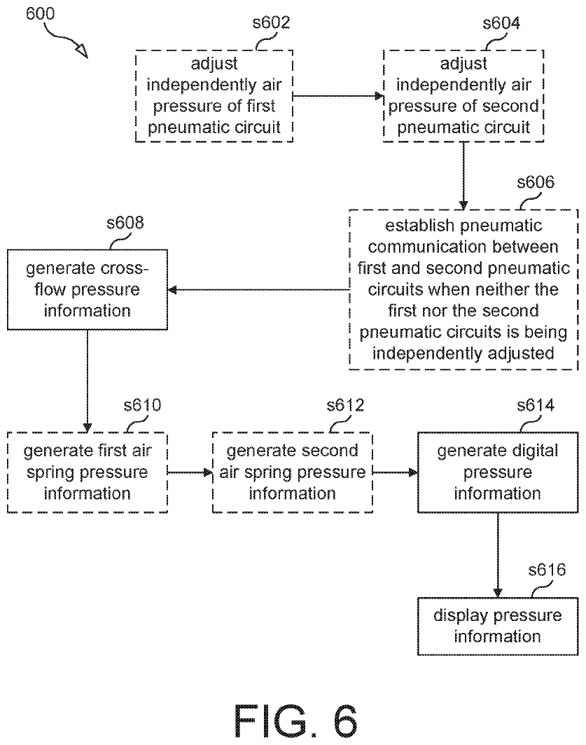

FIG. 6 is a flow chart illustrating a vehicle load monitoring process 600 according to some non-limiting aspects of the invention. In some aspects, the vehicle 10 and/or trailer 20 (e.g., the computer 124 of the vehicle 10 and/or trailer 20) may perform one or more steps of the process 600.

In some aspects, as shown in FIG. 6, the process 600 may include an optional step 602, an optional step 604, an optional step 606, a step 608, an optional step 610, and an optional step 612, which may be the same as the optional step 502, the optional step 504, the optional step 506, the step 508, the optional step 510, and the optional step 512, respectively, of the process 500 described above with respect to FIG. 5A.

In some aspects, as shown in FIG. 6, the process 600 may include a step 614 in which an ADC 126 converts the cross-flow pressure information into digital cross-flow pressure information. In some aspects, the step 614 may include an ADC 126 converting the first air spring pressure information into digital first air spring pressure information. In some aspects, the step 614 may include an ADC 126 converting the second air spring pressure information into digital second air spring pressure information.

In some aspects, the step 614 may include an ADC 126 converting trailer cross-flow pressure information into digital trailer cross-flow pressure information. In some aspects, the step 614 may include an ADC 126 converting the first trailer air spring pressure information into digital first trailer air spring pressure information. In some aspects, the step 614 may include an ADC 126 converting the second trailer air spring pressure information into digital second trailer air spring pressure information.

In some aspects, the step 614 may include an ADC 126 converting axle strain information into digital axle strain information. In some aspects, the step 614 may include an ADC 126 converting trailer axle strain information into digital trailer axle strain information.

In some aspects, as shown in FIG. 6, the process 600 may include a step 616 in which a display (e.g., a display 137) displays the digital cross-flow pressure information. In some aspects, the step 616 may include the display displaying the digital first air spring pressure information and/or the digital second air spring pressure information (e.g., simultaneously with the digital cross-flow pressure information).

In some aspects, the step 616 may include the display displaying the digital trailer cross-flow pressure information (e.g., simultaneously with the digital cross-flow pressure information). In some aspects, the step 616 may include the display displaying the digital first trailer air spring pressure information and/or the digital second trailer air spring pressure information (e.g., simultaneously with the digital trailer cross-flow pressure information). In some aspects, the step 616 may include the display displaying the digital axle strain information and/or the digital trailer axle strain information.

In some aspects, the step 616 may additionally or alternatively include the one or more printers 138 printing any of the digital information (e.g., the digital cross-flow pressure information and/or the digital trailer cross-flow pressure information). In some aspects, the step 616 may additionally or alternatively include the one or more communication units 139 communicating (e.g., wirelessly communicating) any of the digital information (e.g., for display on a remote device).

In some aspects, the process 600 may include (e.g., in step 616) the computer 124 conveying digital pressure information (e.g., cross-flow pressure information, first air spring pressure information, second air spring pressure information, trailer cross-flow pressure information, first trailer air spring pressure information, and/or second trailer air spring pressure information) to the one or more telematics units 141. In some aspects, the one or more telematics units 141 may receive the information and store and/or communicate it.

In some aspects in which the vehicle 10 includes multiple cross-flow sets and/or multiple trailer cross-flow sets, each of the steps 602, 604, 606, 608, 610, 612, 614, and 616 may be performed for each of the multiple cross-flow sets and/or each of the multiple trailer cross-flow sets. In some aspects, the step 618 may include the display displaying (e.g., simultaneously) digital information for multiple cross-flow sets and/or multiple trailer cross-flow sets. For example, in step 618, the display may display digital cross-flow pressure information for each of multiple cross-flow sets and/or digital trailer cross-flow pressure information for each of multiple trailer cross-flow sets.

In this way, a vehicle operator may be able to view displayed information indicative of the cross-flow pressure associated with one or more vehicle axles, one or more groups of vehicle axles, one or more trailer axles, and one or more groups of trailer axles. In some aspects, the display (e.g., a display 137) may display (i) digital axle strain information associated with one or more axles (e.g., axle 12) of the vehicle 10, (ii) digital cross-flow pressure information associated with one or more axles of the vehicle 10 (e.g., axle 12 individually as shown in FIG. 2C) and/or one or more groups of axles of the vehicle 10 (e.g., group of axles 14 and 15 as shown in FIGS. 2B and 2C), (iii) digital trailer axle strain information associated with one or more axles of the trailer 20 (e.g., axle 16), and/or (iv) digital trailer cross-flow pressure information associated with one or more axles of the trailer 20 (e.g., axles 18, 19, and 21 individually as shown in FIG. 2F) and/or one or more groups of axles of the trailer 20 (e.g., group of axles 18 and 19 as shown in FIG. 2E).

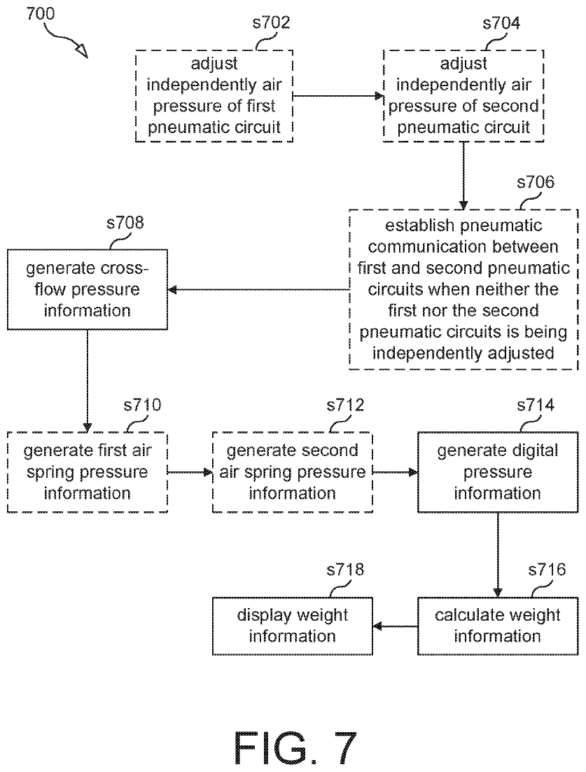

In some aspects, as shown in FIG. 7, the process 700 may include an optional step 702, an optional step 704, an optional step 706, a step 708, an optional step 710, an optional step 712, and a step 714, which may be the same as the optional step 502, the optional step 504, the optional step 506, the step 508, the optional step 510, the optional step 512, and the step 614, respectively, described above with respect to FIGS. 5 and 6.

In some aspects, as shown in FIG. 7, the process 700 may include a step 714 in which the computer 124 calculates a cross-flow-based weight on one or more axles of the vehicle 10 (e.g., an axle mass or an axle group mass). In some aspects, the computer 124 may calculate the cross-flow-based weight using the digital cross-flow pressure information. In some aspects, in the step 714, the computer 124 may additionally or alternatively calculate a trailer cross-flow-based weight on one or more axles of the trailer 20. In some aspects, the computer 124 may calculate the trailer cross-flow-based weight using the digital trailer cross-flow pressure information. In some aspects, the computer 124 that calculates the cross-flow-based weight in step 714 may be the same computer 124 that calculates the first and second brake application levels and/or the first and second trailer brake application levels to perform one or more of functions of an anti-lock brake system (ABS), automatic load-dependent braking (ALB), and/or an electronic braking system (EBS). In some aspects, the computer 124 may calculate the cross-flow-based weight in step 714 as a part of performing one or more of functions of an ABS, ALB, and/or an EBS (e.g., stability control, traction control, ALB, and/or anti-roll control). In some aspects, the cross-flow-based weight calculated by the computer 124 may be accurate enough (e.g., within ±2%) for the vehicle 10 and/or the trailer 20 to meet the requirements of one or more performance based standards (PBS) without the vehicle 10 and/or the trailer 20 being equipped with any on board mass units and/or load cells, which are expensive and are conventionally needed to meet the performance based standards.

In some aspects, the step 714 may include the computer 124 calculating a first air spring-based weight using the digital first air spring pressure information and/or calculating a second air spring-based weight using the digital second air spring pressure information. In some aspects, the step 714 may include the computer 124 calculating a first trailer air spring-based weight using the digital first trailer air spring pressure information and/or calculating a second trailer air spring-based weight using the digital second trailer air spring pressure information.

In some aspects, the step 714 may include the computer 124 calculating a strain-based weight on one or more axles (e.g., axle 12) of the vehicle 10. In some aspects, the computer 124 may calculate the strain-based weight using the digital axle strain information. In some aspects, the step 714 may additionally or alternatively include the computer 124 calculating a strain-based weight on one or more axles (e.g., axle 16) of the trailer 20. In some aspects, the computer 124 may calculate the strain-based weight using the digital trailer axle strain information.

In some aspects, the computer 124 may receive reference weight information (e.g., one or more reference weight measurements). In some aspects, the computer 124 may include the reference weight information (e.g., via the communication unit 139 or a user input). In some aspects, the computer 124 may use the reference weight information to calibrate the one or more weight calculations of step 716, which may calculate one or more weights at a first measurement time.

In some aspects, the computer 124 may receive first reference weight information indicative of a weight on one or more axles of the vehicle 10 or trailer 20 at a second measurement time (e.g., a time when the vehicle 10 or trailer 20 is unloaded). In some aspects, the first reference weight information may be obtained by moving the vehicle 10 or trailer 20 in an unloaded state onto a scale. In some aspects, the system 100 may generate measurement information at the second measurement time so that is corresponds to the first reference weight information. In some aspects, the measurement information may including one or more of cross-flow pressure information, first air spring pressure information, second air spring pressure information, axle strain information, trailer cross-flow pressure information, first trailer air spring pressure information, second trailer air spring pressure information, and trailer axle strain information at the second measurement time. In some aspects, the system 100 may use one or more ADCs 126 to convert that measurement information to digital measurement information. In some aspects, the system 100 may use the first reference weight information and the corresponding measurement information at the second measurement time to calculate the one or more weights at the first measurement time in step 716.

In some aspects, the computer 124 may receive a second reference weight information indicative of a weight on one or more axles of the vehicle 10 or trailer 20 at a third measurement time (e.g., a time when the vehicle 10 or trailer 20 is loaded). In some aspects, the second reference weight information may be obtained by moving the vehicle 10 or trailer 20 in a loaded state onto the scale. In some aspects, the system 100 may generate measurement information at the third measurement time so that is corresponds to the second reference weight information. In some aspects, the system 100 may use one or more ADCs 126 to convert that measurement information to digital measurement information. In some aspects, the system 100 may use the first and second reference weight information and the corresponding measurement information at the second and third measurement times to calculate the one or more weights at the first measurement time in step 716.

In some aspects, the computer 124 may use the one or more reference weight information and the corresponding measurement information to calculate one or more pressure-to-weight conversion functions (e.g., a cross-flow-pressure-to-weight conversion function) and/or one or more strain-to-weight functions. In some aspects, the computer 124 may calculate one or more weights on one or more axles at the first measurement time using the one or more conversion functions and measurement information at the first measurement time. In some aspects in which the computer 124 receives at least first and second reference weight information, the computer 124 may use linear interpolation to calculate the one or more conversion functions. In some alternative aspects in which the computer 124 receives at least first, second, and third reference weight information, the computer 124 may use polynomial interpolation to calculate the one or more conversion functions.

In some aspects, as shown in FIG. 7, the process 700 may include a step 718 in which a display (e.g., a display 137) displays the cross-flow-based weight. In some aspects, the step 718 may include the display displaying the first air spring-based weight and/or the second air spring-based weight (e.g., simultaneously with the cross-flow-based weight).

In some aspects, the step 718 may include the display displaying the trailer cross-flow-based weight (e.g., simultaneously with the cross-flow-based weight). In some aspects, the step 718 may include the display displaying the first trailer air spring-based weight and/or the second trailer air spring-based weight (e.g., simultaneously with the trailer cross-flow-based weight). In some aspects, the step 718 may include the display displaying the strain-based weight and/or the trailer strain-based weight.

In some aspects, the step 718 may additionally or alternatively include the one or more printers 138 printing any of the calculated weights (e.g., the cross-flow-based weight and/or the trailer cross-flow-based weight). In some aspects, the step 718 may additionally or alternatively include the one or more communication units 139 communicating (e.g., wirelessly communicating) any of the calculated weights (e.g., for display on a remote device).

In some aspects, the process 700 may include (e.g., in step 718) the computer 124 conveying digital pressure information (e.g., cross-flow pressure information, first air spring pressure information, second air spring pressure information, trailer cross-flow pressure information, first trailer air spring pressure information, and/or second trailer air spring pressure information) and/or one or more weights calculated by the computer 124 using the pressure information to the one or more telematics units 141. In some aspects, the one or more telematics units 141 may receive the information and store and/or communicate it.

In some aspects in which the vehicle 10 includes multiple cross-flow sets and/or multiple trailer cross-flow sets, each of the steps 702, 704, 706, 708, 710, 712, 714, and 716 may be performed for each of the multiple cross-flow sets and/or each of the multiple trailer cross-flow sets. In some aspects, the step 718 may include the display displaying (e.g., simultaneously) calculated weights for multiple cross-flow sets and/or multiple trailer cross-flow sets. For example, in step 718, the display may display a cross-flow-based weight for each of multiple cross-flow sets and/or a trailer cross-flow-based weight for each of multiple trailer cross-flow sets.

In this way, a vehicle operator may be able to view displayed cross-flow-based weight indicative of the weights one or more vehicle axles, one or more groups of vehicle axles, one or more trailer axles, and one or more groups of trailer axles. In some aspects, the display (e.g., a display 137) may display (i) one or more strain-based weights on one or more axles (e.g., axle 12) of the vehicle 10, (ii) one or more cross-flow-based weights on one or more axles of the vehicle 10 (e.g., axle 12 individually as shown in FIG. 2C) and/or one or more groups of axles of the vehicle 10 (e.g., group of axles 14 and 15 as shown in FIGS. 2B and 2C), (iii) one or more trailer strain-based weights on one or more axles of the trailer 20 (e.g., axle 16), and/or (iv) one or more trailer cross-flow-based weights on one or more axles of the trailer 20 (e.g., axles 18, 19, and 21 individually as shown in FIG. 2F) and/or one or more groups of axles of the trailer 20 (e.g., group of axles 18 and 19 as shown in FIG. 2E).

In some aspects, the step 716 may include the computer 124 calculating one or more of a gross vehicle weight, a gross trailer weight, and a gross combined weight. In some aspects, the gross vehicle weight may be a combined weight on all of the axles and/or axle groups of the vehicle 10. In some aspects, the computer 124 may calculate the gross vehicle weight by summing the weights of the axles and/or axle groups of the vehicle 10. For example, in the aspect shown in FIG. 2B, the computer 124 may calculate the gross vehicle weight as the sum of the strain-based weight on the axle 12 and the cross-flow-based weight on the group of axles 14 and 15. In the aspect shown in FIG. 2C, the computer 124 may calculate the gross vehicle weight as the sum of the cross-flow-based weight on the axle 12 and the cross-flow-based weight on the group of axles 14 and 15.

In some aspects, the gross trailer weight may be the combined weight on all of the axles and/or axle groups of the trailer 20. In some aspects, the computer 124 may calculate the gross trailer weight by summing the weights of the axles and/or axle groups of the trailer 20. For example, in the aspect shown in FIG. 2E, the computer 124 may calculate the gross trailer weight as the sum of the strain-based weight on the axle 16 and the cross-flow-based weight on the group of axles 18 and 19. In the aspect shown in FIG. 2F, the computer 124 may calculate the gross trailer weight as the sum of the cross-flow-based weight on the axle 18, the cross-flow-based weight on the axle 19, and the cross-flow-based weight on the axle 21.

In some aspects, the gross combined weight may be the combined weight on all of the axles and/or axle groups of the vehicle 10 and the trailer 20. In some aspects, the gross combined weight may be equal to the sum of the gross vehicle weight and the gross trailer weight.

In some aspects, the step 716 may include the computer 124 additionally or alternatively calculating one or more of a vehicle load weight, a trailer load weight, and a combined load weight. In some aspects, the vehicle load weight may be the current gross vehicle weight minus the gross vehicle weight in the unloaded state. In some aspects, the trailer load weight may be the current gross trailer weight minus the gross trailer weight in the unloaded state. In some aspects, the combined load weight may be equal to the sum of the vehicle load weight and the trailer load weight.

In some aspects, the step 718 may include the display (e.g., a display 137) displaying one or more of the gross vehicle weight, gross trailer weight, gross combined weight, vehicle load weight, trailer load weight, and combined load weight.

Experimental Data

Testing was carried out to compare (a) cross-flow-based weights calculated (e.g., by a computer 124) using cross-flow pressure information (e.g., output by a cross-flow air pressure sensor 118 or a trailer cross-flow air pressure sensor 218) indicative of an air pressure within a cross-flow passage (e.g., cross-flow passage 116 or trailer cross-flow passage 216) and (b) air spring-based weights calculated (e.g., by a computer 124) using air spring pressure information (e.g., output by an air spring air pressure sensor 120, 122, 220, or 222) indicative of an air pressure within an air spring (e.g., air spring 106, 110, 206, or 210) on one side of a vehicle or trailer. The measurements were taken using a system 100 embodying aspects of the present invention with the only difference being whether the pressure sensor measured the air pressure within the cross-flow passage or within an air spring on one side of the vehicle or trailer.

In one test, a trailer 20 was loaded with cattle. During dynamic driving conditions, cattle can slide and move around a trailer 20, making it difficult to keep the vehicle 10 and/or the trailer 20 stable. Measurements were taken with the trailer 20 loaded with cattle and traveling at a speed of over 20 km/hr. A trip was defined as (i) starting when an axle load sum was over 12 metric tons (T) and a speed was over 20 km/hr (i.e., when there were cattle on the trailer 20 and the trailer 20 was moving) and (ii) ending when the axle load sum drops down below 12 T.

As shown in Table 1 below, during three trips in which trailer air spring-based axle weights were calculated using trailer air spring pressure information indicative of an air pressure within an air spring on a side of the trailer 20, the calculated trailer axle weights (e.g., calculated trailer axle load sums) varied by 3400 kg, 4500 kg, and 4200 kg, respectively, even though the trailer axle weights did not actually change by those amounts during the trips. In contrast, during the trip in which trailer cross-flow-based axle weights were calculated using trailer cross-flow pressure information indicative of an air pressure within a trailer cross-flow passage 216 of the trailer 20, the calculated trailer axle weights (e.g., calculated trailer axle load sums) varied by only 800 kg. Moreover, the lowest trailer cross-flow-based axle weight was calculated at the start of the trip, and, once the trailer 20 was traveling at over 40 km/h, the calculated trailer cross-flow-based axle weights varied by only 400 kg.

TABLE 1
Comparison of Air Spring-Based and Cross-Flow-Based Weights

| | | | | Difference |
|---|---|---|---|---|
| | | | | between Max. |
| | | Minimum | Maximum | and Min. |
| | Trip | Calculated | Calculated | Calculated |
| Type | # | Weight | Weight | Weights |
| Air Spring-Based Axle | 1 | 25,000 kg | 28,400 kg | 3,400 kg |
| Weights Calculated | 2 | 21,900 kg | 26,400 kg | 4,500 kg |
| using Air Spring | 3 | 22,000 kg | 26,300 kg | 4,300 kg |
| Pressure Information | | | | |
| in System with | | | | |
| Cross-Flow Passage | | | | |
| Cross-Flow-Based Axle | 4 | 26,300 kg | 27,100 kg | 800 kg |
| Weights Calculated | | | | |
| using Cross-Flow | | | | |
| Pressure Information | | | | |
| in System with | | | | |
| Cross-Flow Passage | | | | |

In some aspects, as the cross-flow passage 116 (or 216) is not in pneumatic communication with the first and second pneumatic circuits 102 and 104 (or 202 and 204) when the first and/or second leveling valves 108 and 112 (or 208 and 212) are adjusting independently the height of the first and/or second sides of the vehicle 10 (or the trailer 20), the air pressure within the cross-flow passage 116 (or 216) is consistent and may not be affected by events (e.g., lateral acceleration, surface unevenness, etc.) that cause the first and/or second leveling valves 108 and 112 (or 208 and 212) to adjust independently the height of the first and/or second sides of the vehicle 10 (or the trailer 20). Accordingly, the air pressure within the cross-flow passage 116 (or 216) may be an accurate representation of air spring suspension pressure.

The measurements taken during the trip in which trailer cross-flow-based axle weights were calculated using trailer cross-flow pressure information indicative of an air pressure within a trailer cross-flow passage 216 of the trailer 20 bear this out. In particular, the calculated trailer cross-flow-based axle weights showed that the air pressure within the trailer cross-flow passage 216 was not affected by even significant shifts in lateral acceleration of the trailer 20. In contrast, for calculated trailer air spring-based axle weights, which were calculated based on the measured air pressure within one or more trailer air springs 206 or 210 instead of based on the measured air pressure within the trailer cross-flow passage 216, the amplitude of difference in calculated trailer axle weights was 425% to 562% higher compared to the difference in trailer axle weights calculated using the trailer cross-flow passage 216, demonstrating the inaccuracies that exist in conventional systems that rely on air spring pressure information. Accordingly, the experimental data shows that the air pressure within the cross-flow passage 116 or 216 is a more consistent and more accurate representation of the air pressure of the complete air spring suspension system including the first and second pneumatic circuits 102 and 104 (or 202 and 204) than the air pressure within one or more air springs on one side of the vehicle 10 (or trailer 20). Thus, use of the air pressure within the cross-flow passage 116 or 216 for load monitoring and/or braking control provides advantages over the conventional use of the air pressure within one or more air springs on one side of the vehicle 10 (or trailer 20).

Raise Lower Valve (RLV) Configuration

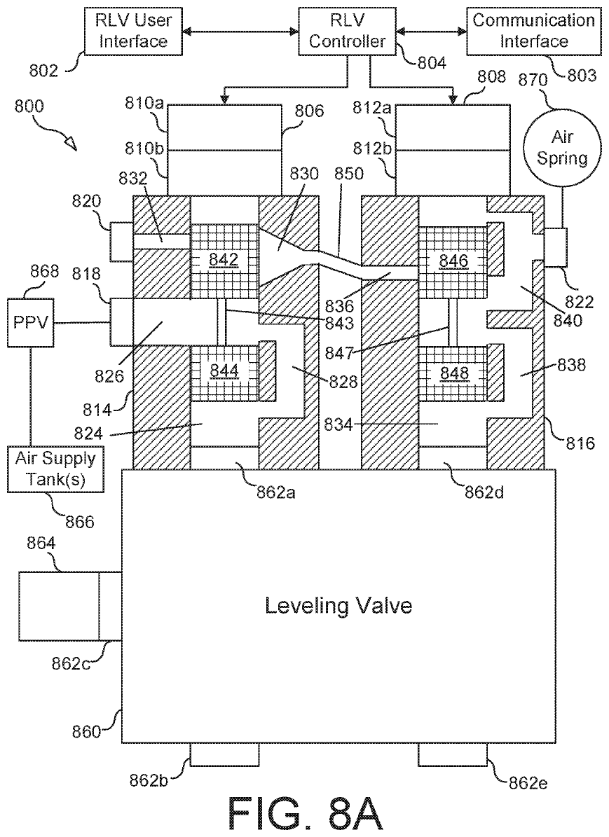

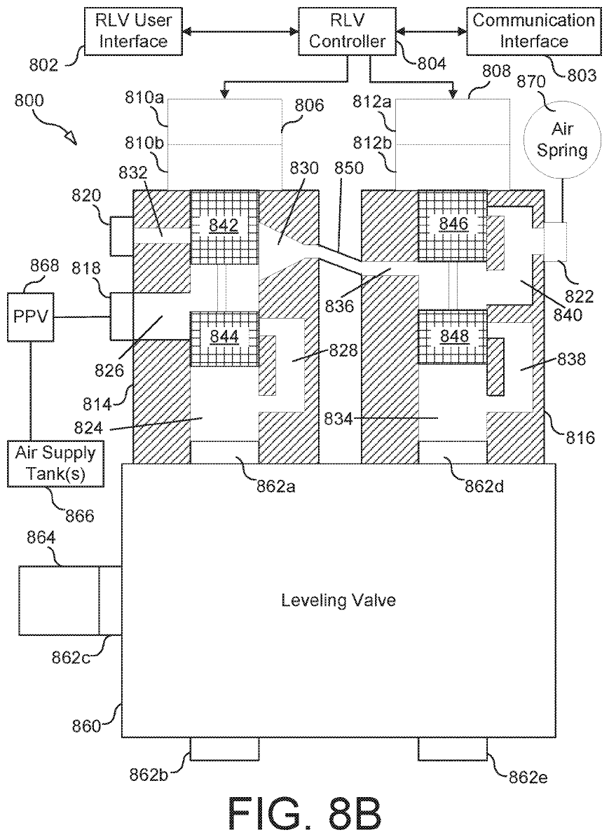

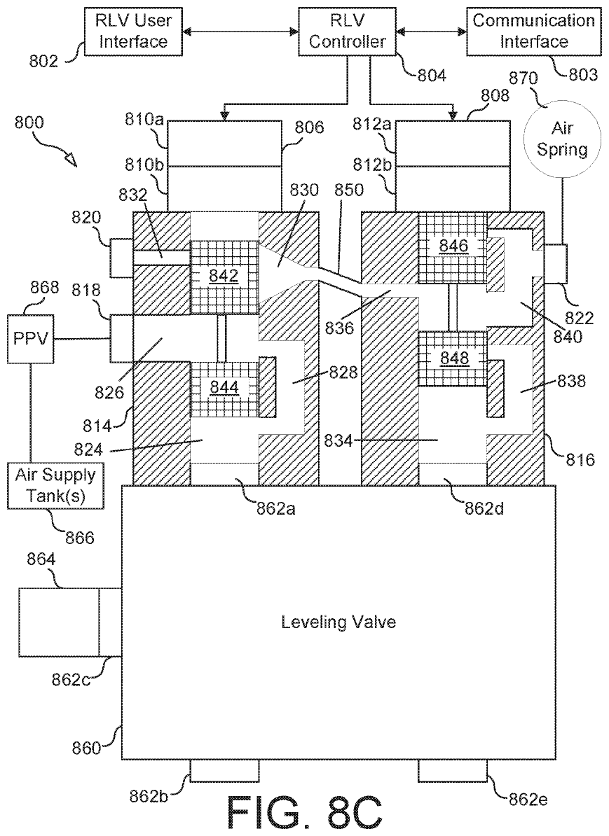

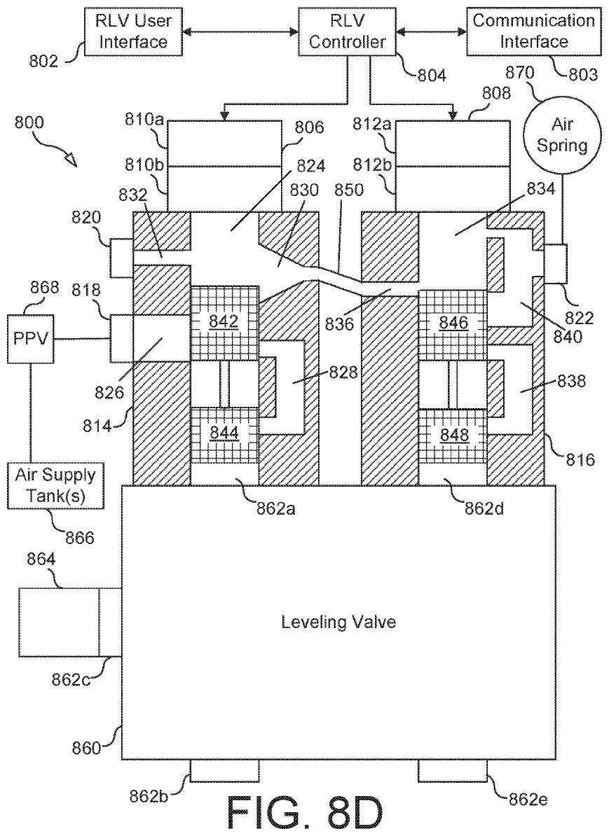

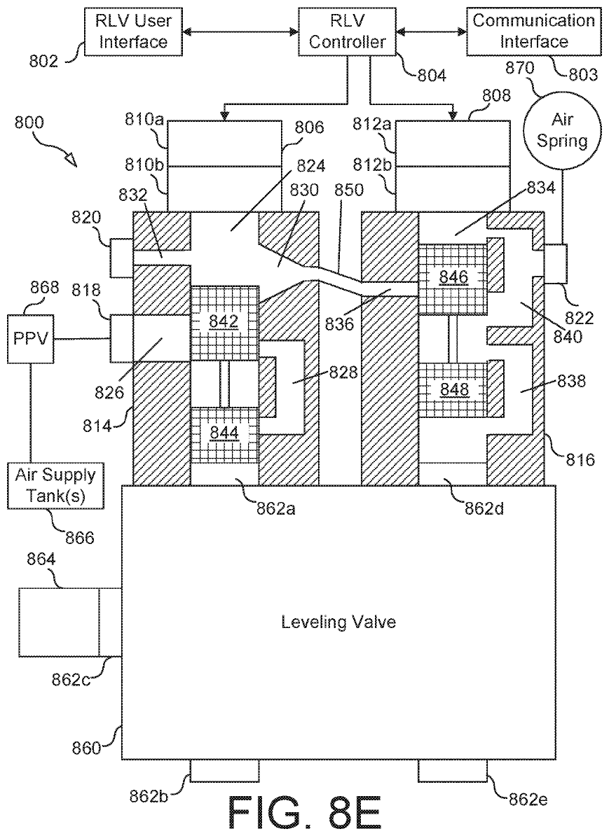

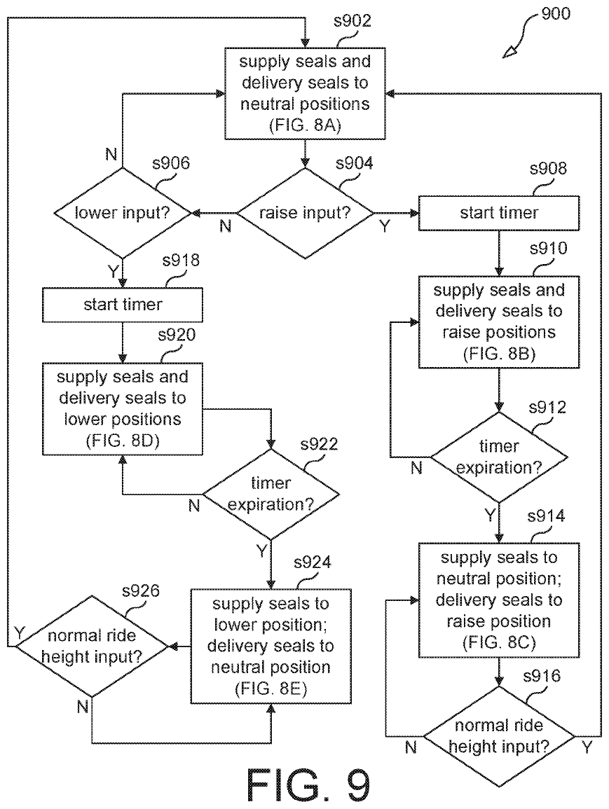

FIGS. 8A-8E illustrate a system including a leveling valve 860 (e.g., the leveling valve 108, 112, 208, or 212) and a raise lower valve (RLV) 800 (e.g., RLV 107 or 207) according to some aspects. In some aspects, the leveling valve 860 may be configured to adjust independently the height of a side of a vehicle 10 or trailer 20. In some aspects, the leveling valve 860 may adjust the height of the one side of the vehicle 10 or trailer 20 by increasing or decreasing air in one or more air springs 870 (e.g., one or more air springs 106, 110, 206, or 210) on the one side of the vehicle 10 or trailer 20. In some aspects, the RLV 800 may enable an operator to manually vary the height of the chassis of the vehicle 10 or trailer 20 relative to the ground (e.g., to facilitate height adjustment of the vehicle or trailer at a loading dock).

In some aspects, as shown in FIGS. 8A-8E, the leveling valve 860 may include one or more ports 862. In some aspects, as shown in FIGS. 8A-8E, the leveling valve 860 may include a supply port 862a, an exhaust (or dump or vent) port 862b, a cross-flow port 862c, and/or one or more spring ports 862d and 862e. In some aspects, the supply port 862a of the leveling valve 860 may be configured to receive air from an air source such as one or more air supply tanks 866 (e.g., the one or more air supply tanks 114 or 214). In some aspects, a pressure protection valve (PPVs) 868 may be located between the one or more air supply tanks 866 and the supply port 862a of the leveling value 860, and the PPV 868 may protect the system in the event of a leak or failure within the system. However, the PPV 868 is not required, and, in some alternative aspects, the system may not include a PPV. In some aspects, the exhaust port 862b may be configured to exhaust air into the atmosphere. In some aspects, the one or more spring ports 862d and 862e may be configured to receive air from or supply air to the one or more air springs 870. In some aspects, the spring port 862e may be plugged.

In some aspects, the cross-flow port 862c may be configured to connect the leveling valve 860 with a leveling valve on a pneumatic circuit on the other side of the vehicle or trailer via a cross-flow passage 864 (e.g., the cross-flow passage 116 or 216). In some aspects, the leveling valves may be configured to establish pneumatic communication via the cross-flow passage 864 when the first and second leveling valves are allowed to adjust independently the heights of the first and second sides of the vehicle or the trailer but neither the first leveling valve is adjusting independently the height of the first side nor the second leveling valve is adjusting independently the height of the second side neither leveling valve is adjusting independently the height of a side of the vehicle 10 or trailer 20. In some aspects, the pneumatic communication between the pneumatic circuits via the cross-flow passage 864 may equalize air pressure between air springs 870 on opposite sides of the vehicle 10 or trailer 20.

In some aspects, the RLV 800 may include an RLV user interface 802, a communication interface 803, an RLV controller 804, a first RLV actuator 806, a second RLV actuator 808, a first RLV housing 814, and/or a second RLV housing 816. In some aspects, as shown in FIGS. 8A-8E, the first and second RLV housings 814 and 816 may be separate and distinct housings. In some alternative aspects, the first and second RLV housings 814 and 816 may be a single, integrated housing. In some aspects, the first RLV actuator 806 may be a three position solenoid including first and second solenoids 810a and 810b, and the second RLV actuator 808 may be a three position solenoid including first and second solenoids 812a and 812b.

In some aspects, the first RLV housing 814 may include a supply port 818 and/or an exhaust (or dump or vent) port 820. In some aspects, the second RLV housing 816 may include a spring port 822. In some aspects, the supply port 818 of the first RLV housing 814 may be configured to receive air from an air source such as the one or more air supply tanks 866 (e.g., either directly or indirectly through the PPV 868). In some aspects, an air line may connect the source port 818 of the first RLV housing 814 and the PPV 868 (or an air supply tank 866). In some aspects, the exhaust port 820 of the first RLV housing 814 may be configured to exhaust air into the atmosphere. In some aspects, the spring port 822 of the second RLV housing 816 may be configured to receive air from or supply air to the one or more air springs 870.

FIGS. 8A-8E provide a cross-sectional view of the first and second RLV housings 814 and 816. In some aspects, as shown in FIGS. 8A-8E, the first RLV housing 814 may include a main passage 824 (e.g., a central passage or bore), a supply passage 826, a leveling valve supply passage 828, a leveling valve bypass passage 830, and/or an exhaust passage 832. In some aspects, the first RLV housing 814 may include a first supply seal 842 and a second supply seal 844 in the main passage 824. In some aspects, a connector 844 may connect the first and second supply seals 842 and 844 and may maintain the first and second supply seals 842 and 844 a constant distance apart from each other. In some aspects, the first RLV actuator 806 may be configured to move the first and second supply seals 842 and 844 between neutral, raise, and lower positions. FIGS. 8A and 8C illustrate the first and second supply seals 842 and 844 of the first RLV housing 814 in a neutral position. FIG. 8B illustrates the first and second supply seals 842 and 844 in a raise position. FIGS. 8D and 8E illustrate the first and second supply seals 842 and 844 of the first RLV housing 814 in a lower position. In some aspects, one or more of the first and second supply seals 842 and 844 may include magnetic material. In some aspects in which the first RLV actuator 806 is a three position solenoid including first and second solenoids 810a and 810b, an electrical current passing through one of the first and second solenoids 810a and 810b may generate a magnetic field that moves the first and second supply seals 842 and 844 from the neutral position shown in FIG. 8A to the raise position shown in FIG. 8B, and an electrical current passing through the other one of the first and second solenoids 810a and 810b may generate a magnetic field that moves the first and second supply seals 842 and 844 from the neutral position shown in FIG. 8A to the lower position shown in FIG. 8D. In some aspects, springs (not shown) in the main passage 824 above and/or below the first and second supply seals 842 and 844 may cause the first and second supply seals 842 and 844 to return to their neutral position as shown in FIGS. 8A and 8C when neither of the first and second solenoids 810a and 810b is generating a magnetic field.

In some aspects, the main passage 824 of the first RLV housing 814 may connect pneumatically with the supply port 862a of the leveling valve 860. In some aspects, as shown in FIGS. 8A-8E, the first RLV housing 814 may be attached to the supply port 862a of the leveling value 860 so that the main passage 824 of the first RLV housing 814 connects directly with the supply port 862a of the leveling valve 860. However, this is not required, and, in some alternative aspects, the first RLV housing 814 may not be attached to the supply port 862a of the leveling value 860, and an air line may connect pneumatically the main passage 824 of the first RLV housing 814 with the supply port 862a of the leveling valve 860.

In some aspects, the supply passage 826 of the first RLV housing 814 may connect pneumatically the supply port 818 and the main passage 824. In some aspects, the leveling valve supply passage 828 may connect pneumatically the main passage 824 above the second supply seal 844 when in the neutral position to the main passage 824 below the second supply seal 844 when the second supply seal 844 is in the neutral position, as shown in FIGS. 8A and 8C. In some aspects, the exhaust passage 832 may connect pneumatically the main passage 824 and the exhaust port 820 of the first RLV housing 814. In some aspects, the leveling valve bypass passage 830 may be part of a bypass path that connects pneumatically the main passage 824 of the first RLV housing 814 and a main passage 834 of the second RLV housing 816.

In some aspects, as shown in FIGS. 8A-8E, the second RLV housing 816 may include the main passage 834 (e.g., a central passage or bore), a leveling valve bypass passage 836, a leveling valve spring passage 838, and/or a spring passage 840. In some aspects, the second RLV housing 816 may include a first delivery seal 846 and a second delivery seal 848 in the main passage 834. In some aspects, a connector 847 may connect the first and second delivery seals 846 and 848 and may maintain the first and second seals delivery 846 and 848 a constant distance apart from each other. In some aspects, the second RLV actuator 808 may be configured to move the first and second delivery seals 846 and 848 between neutral, raise, and lower positions. FIGS. 8A and 8E illustrate the first and second delivery seals 846 and 848 of the second RLV housing 816 in a neutral position. FIGS. 8B and 8C illustrate the first and second delivery seals 846 and 848 in a raise position. FIG. 8D illustrates the first and second delivery seals 846 and 848 of the second RLV housing 816 in a lower position. In some aspects, one or more of the first and second delivery seals 846 and 848 may include magnetic material. In some aspects in which the second RLV actuator 808 is a three position solenoid including first and second solenoids 812a and 812b, an electrical current passing through one of the first and second solenoids 812a and 812b may generate a magnetic field that moves the first and second delivery seals 846 and 848 from the neutral position shown in FIG. 8A to the raise position shown in FIG. 8B, and an electrical current passing through the other one of the first and second solenoids 812a and 812b may generate a magnetic field that moves the first and second delivery seals 846 and 848 from the neutral position shown in FIG. 8A to the lower position shown in FIG. 8D. In some aspects, springs (not shown) in the main passage 834 above and/or below the first and second delivery seals 846 and 848 may cause the first and second delivery seals 846 and 848 to return to their neutral position as shown in FIGS. 8A and 8E when neither of the first and second solenoids 812a and 812b is generating a magnetic field.

In some aspects, the main passage 834 of the second RLV housing 816 may connect pneumatically with the spring port 862d of the leveling valve 860. In some aspects, as shown in FIGS. 8A-8E, the second RLV housing 816 may be attached to the supply port 862a of the leveling value 860 so that the main passage 834 of the second RLV housing 816 connects directly with the spring port 862d of the leveling valve 860. However, this is not required, and, in some alternative aspects, the second RLV housing 816 may not be attached to the spring port 862d of the leveling value 860, and an air line may connect pneumatically the main passage 834 of the second RLV housing 816 with the spring port 862d of the leveling valve 860.

In some aspects, the leveling valve bypass passage 836 of the second RLV housing 816 may be part of the bypass path that connects pneumatically the main passage 824 of the first RLV housing 814 and the main passage 834 of the second RLV housing 816. In some aspects, the leveling valve spring passage 838 may connect pneumatically the main passage 834 above the second delivery seal 848 when in the neutral position to the main passage 834 below the second delivery seal 848 when in the neutral position, as shown in FIGS. 8A and 8E. In some aspects, a spring passage 840 may connect pneumatically the main passage 834 and the spring port 822 of the second RLV housing 816.

In some aspects including first and second RLV housings 814 and 816, a bypass air line 850 may connect pneumatically the leveling valve bypass passage 836. In these aspects, the bypass path that connects pneumatically the main passages 824 and 834 of the first and second RLV housings 814 and 816 may include the leveling valve bypass passage 830 of the first RLV housing 814, the bypass air line 850, and the leveling valve bypass passage 836 of the second RLV housing 816. In some alternative aspects including a single integrated housing, the bypass path that connects pneumatically the main passages 824 and 834 of the integrated RLV housing may include a single leveling valve bypass passage.

In some aspects, the RLV controller 804 may receive input from the RLV user interface 802 and/or the communication interface 803. In some embodiments, communication interface 803 may communicate with one or more devices (e.g., the computer 124, the communication interface 139, and/or another computer such as a smartphone running an RLV application) through wired and/or wireless communication. In some aspects, the vehicle communicates (e.g., automatically) with a location, e.g., a loading dock, using one or more sensors (e.g., proximity sensors), cameras, lasers, radar, lidar (Light Detection and Ranging), wireless communication protocols (e.g., Bluetooth) to determine the appropriate height setting and the RLV responds accordingly to raise or lower the vehicle. In some aspects, the vehicle is an autonomous vehicle such that no user/driver is required to operate the system.

In some aspects, the RLV user interface 802 may include a user input. In some aspects, the user input may include a switch. In some aspects, the switch may a three-position switch including a lower position (e.g., left position), neutral position (e.g., center position), and raise position (e.g., right position). In some aspects, the user input may additionally or alternatively include a raise button and a lower button. In some aspects, user input (e.g., one or more switches and/or one or more buttons) of the RLV user interface 802 may be implemented using physical switches and/or physical buttons and/or a touchscreen having a graphical user interface that may be manipulated by touch or by another control device. In some aspects, the RLV controller 804 may receive user input from the RLV user interface 802. In some aspects, the RLV controller 804 may control one or more of the first and second RLV actuators 806 and 808 based on the input received from the RLV user interface 802 and/or the communication interface 803. In some aspects, the RLV controller 804 may be part of the computer 124 of the vehicle 10 and/or trailer 20.

In some aspects, the RLV controller 804 may include a timer, which the RLV controller 804 may use to control or limit the amount of time that the RLV 800 adds or removes air to or from the one or more air springs 870 to an interval defined by the timer. In this way, the RLV controller 804 may use the timer to control or limit the amount of air added to or removed from the one or more air springs 870 in response to input received via the RLV user interface 802 and/or the communication interface 803. In some alternative embodiments, the RLV controller 804 may include a raise timer and a lower timer. In these alternative embodiments, the raise timer may define an interval of time for supplying air to the one or more air springs 870 in response to a raise input (e.g., indicating that the user would like to raise the height of a side of the chassis of the vehicle 10 or trailer 20), and the lower timer may define an interval of time for removing air from the one or more air springs 870 in response to a lower input (e.g., indicating that the user would like to lower the height of a side of the chassis of the vehicle 10 or trailer 20). In these alternative embodiments, the intervals of time defined by the raise and lower timers may be different. In some aspects, the timer(s) may be set to an amount of time that it would take for the RLV 800 to completely raise and/or lower the height of the chassis to a fully raised or fully lowered height. However, this is not required, and, in some alternative aspects, the timer(s) may be set a smaller amount of time so that multiple raise or lower inputs would be required to reach the fully raised or fully lowered height. In this alternative aspects, a counter may be used to limit the number of consecutive raise or lower steps so that the chassis does not exceed the fully raised height or go below the fully lowered height.

FIG. 9 is a flow chart illustrating a raise lower process 900 according to some non-limiting aspects of the invention. In some aspects, the RLV 800 (e.g., the RLV controller 804) may perform one or more steps of the process 900.

In some aspects, the process 900 may include a step 902 in which the when RLV 800 is not being used to raise or lower the height of the chassis of the vehicle 10 or trailer 20 (e.g., while the vehicle 10 or trailer 20 is traveling). In some aspects, in step 902, the RLV controller 804 may control the first and second RLV actuators 806 and 808 to maintain the seals 842, 844, 846, and 848 of the first and second RLV housings 814 and 816 in their neutral positions as shown in FIG. 8A (e.g., by providing current to none of the solenoids 810a, 810b, 812a, and 812b). In some aspects, with the seals 842, 844, 846, and 848 of the first and second RLV housings 814 and 816 in their neutral positions as shown in FIG. 8A, the RLV 800 may allow normal operation of the leveling valve 860 in which the leveling valve 860 controls the height of a side of a chassis of the vehicle 10 or trailer 20 (e.g., to maintain a level condition of the vehicle 10 or trailer 20 while traveling).

In some aspects, when the first and second supply seals 842 and 844 of the first RLV housings 814 are in the neutral position as shown in FIG. 8A, the supply port 818 of the first RLV housing 814 may be connected pneumatically to the supply port 862a of the leveling valve 860 (e.g., via the supply passage 826 and leveling valve supply passage 828) such that the first RLV housing 814 supplies air received at the supply port 818 of the first RLV housing 814 to the supply port 862a of the leveling valve 860. In some aspects, when in the neutral position as shown in FIG. 8A, the first supply seal 842 of the first RLV housing 814 may block air received at the supply port 818 from entering the leveling valve bypass passage 830 and the exhaust passage 832.

In some aspects, when the first and second delivery seals 846 and 848 of the second RLV housing 816 are in the neutral position as shown in FIG. 8A, the spring port 862d of the leveling valve 860 may be connected pneumatically to the spring port 822 of the second RLV housing 816 (via the leveling valve spring passage 838 and the spring passage 840) such that the spring port 862d of the leveling valve 860 is pneumatically connected to the one or more air springs 870, and the spring port 862d receives air from or supplies air to the one or more air springs 870. In some aspects, when in the neutral position as shown in FIG. 8A, the first delivery seal 846 of the second RLV housing 816 may block air from entering the leveling valve bypass passage 836.

In some aspects, in step 902, with the seals 842, 844, 846, and 848 in the neutral positions as shown in FIG. 8A, the leveling valve 860 can supply air to the one or more air springs 870 (e.g., by supplying air received at the supply port 862a of the leveling valve 860 to the one or more air springs 870 via the spring port 862d of the leveling valve 860) or remove air from the one or more air springs 870 (e.g., by receiving air from the one or more air springs 870 via the spring port 862d of the leveling valve 860 and venting the received air to the atmosphere via the exhaust port 862b of the leveling valve 860) as the leveling valve 860 deems appropriate to maintain the vehicle 10 or trailer 20 in a level condition.

In some aspects, the process 900 may include a step 904 in which the RLV 800 (e.g., the RLV controller 804) determines whether the RLV 800 (e.g., the RLV controller 804) has received via the RLV user input 802 and/or the communication interface 803 a raise input (e.g., indicating that the user would like to raise the height of a side of the chassis of the vehicle 10 or trailer 20 relative to the ground). In some aspects, the raise input may be, for example and without limitation, indicative of a switch of the RLV user interface 802 turned to the right. In some aspects, if the RLV 800 determines that no raise input was received in step 904, the process 900 may proceed to a step 906. In some aspects, if the RLV 800 determines that a raise input was received in step 904, the process 900 may proceed to a step 908.

In some aspects, the process 900 may include a step 906 in which the RLV 800 (e.g., the RLV controller 804) determines whether the RLV 800 (e.g., the RLV controller 804) has received via the RLV user input 802 and/or the communication interface 803 a lower input (e.g., indicating that the user would like to lower the height of a side of the chassis of the vehicle 10 or trailer 20 relative to the ground). In some aspects, the lower input may be, for example and without limitation, indicative of a switch of the RLV user interface 802 turned to the left. In some aspects, if the RLV 800 determines that no lower input was received in step 906, the process 900 may proceed back to the step 902 in which the RLV 800 maintains the seals 842, 844, 846, and 848 in the neutral positions so that the leveling valve 860 performs height control. In some aspects, if the RLV 800 determines that a raise input was received in step 904, the process 900 may proceed to a step 918.

In some aspects, the process 900 may include a step 908 in which the RLV controller 804, in response to a raise input received via the RLV user interface 802 and/or the communication interface 803, starts a timer of the RLV controller 804. In some aspects, if the RLV controller 804 includes a raise timer and a lower timer, in step 908, the RLV controller 804 may start the raise timer.

In some aspects, the process 900 may include a step 910 in which the RLV controller 804, in response to a raise input, controls the first RLV actuator 806 to move the first and second supply seals 842 and 844 from the neutral position shown in FIG. 8A to the raise position shown in FIG. 8B (e.g., by passing an electrical current through one of the first and second solenoids 810a and 810b of the first RLV actuator 806) and controls the second RLV actuator 808 to move the first and second delivery seals 846 and 848 from the neutral position shown in FIG. 8A to the raise position shown in FIG. 8B (e.g., by passing an electrical current through one of the first and second solenoids 812a and 812b of the second RLV actuator 808).

In some aspects, in step 910, when the first and second supply seals 842 and 844 of the first RLV housing 814 and the first and second delivery seals 846 and 848 of the second RLV housing 816 are in the raise positions, as shown in FIG. 8B, the RLV 800 may bypass the leveling valve 860 and supply air received at the supply port 818 of the first RLV housing 814 to the one or more air springs 870 (e.g., to increase the amount of air in the one or more air springs 870 and, thereby, increase the height of the chassis on a side of the vehicle 10 or trailer 20). In some aspects, with the seals 842, 844, 846, and 848 in the raise positions, the RLV 800 may prevent the leveling valve 860 from controlling the height of a side of a chassis of the vehicle 10 or trailer 20.

In some aspects, in step 910, when the seals 842, 844, 846, and 848 of the first and second RLV housings 814 and 816 are in the raise position as shown in FIG. 8B, the supply port 818 of the first RLV housing 814 may be connected pneumatically to the spring port 822 of the second RLV housing 816 (e.g., via the supply passage 826 of the first RLV housing 814, the bypass path, and the spring passage 840 of the second RLV housing 816) such that the first and second RLV housings 814 and 816 supply air received at the supply port 818 of the first RLV housing 814 to the spring port 822 of the second RLV housing 816. In some aspects, the bypass path may include the leveling valve bypass passage 830 of the first RLV housing 814, the bypass air line 850, and the leveling valve bypass passage 836 of the second RLV housing 816. In some aspects, when in the raise position as shown in FIG. 8B, the second supply seal 844 of the first RLV housing 814 may block air received at the supply port 818 from entering the leveling valve supply passage 828 and, thus, prevent air received at the supply port 818 from reaching the supply port 862a of the leveling valve 860. In some aspects, when in the raise position as shown in FIG. 8B, the second delivery seal 848 of the second RLV housing 816 may block the leveling valve spring passage 838 and, thus, prevent air in the bypass path from reaching the spring port 862d of the leveling valve 860. In some aspects, after the RLV 800 has added air to the one or more air springs 870 and increased the height of the chassis on one side of the vehicle 10 or trailer 20, the leveling valve 860 (if operational) would attempt to remove air from the one or more air springs 870 to return the vehicle 10 or trailer 20 to a level condition, but the second delivery seal 848 in the raise position prevents the leveling valve 860 from operating to remove air from the one or more air springs 870.

In some aspects, the process 900 may include a step 912 in which the RLV controller 804 determines whether the timer (e.g., the raise timer) has expired. In some aspects, the timer may be set to expire after an amount of time allows for enough air to be added to the one or more air springs 870 that the height of the side of the vehicle 10 or trailer 20 is raised relative to the ground by a certain amount (e.g., 6 inches or 1 foot). In some aspects, the step 912 may additionally or alternatively include the RLV controller 804a determining that the air pressure within the one or more air springs has reached a threshold raise pressure (e.g., using a pressure sensor such as pressure sensor 120, 122, 220, or 222) and/or that the side of the chassis of the vehicle 10 or trailer 20 has reached a threshold raise height (e.g., using a proximity sensor). In some aspects, if the RLV controller 804 determines that the timer has expired (or that the threshold raise pressure and/or threshold raise height has been reached) in step 912, the process 900 may proceed to a step 914. In some aspects, if the RLV controller 804 determines that the timer has not expired (or that the threshold raise pressure and/or threshold raise height have not been reached) in step 912, the process 900 may proceed back to the step 910 so that the RLV 800 continues to add air to the one or more air springs 870 to raise the height of the side of the chassis of the vehicle 10 or trailer 20 relative to the ground.

In some aspects, the process 900 may include a step 914 in which the RLV controller 804, in response to the interval of time having passed (or the threshold raise pressure and/or threshold raise height having been reached), controls the first RLV actuator 806 to move the first and second supply seals 842 and 844 from the raise position shown in FIG. 8B to the neutral position shown in FIG. 8C (e.g., by providing no electrical current to the first and second solenoids 810a and 810b of the first RLV actuator 806) and controls the second RLV actuator 808 to maintain the first and second delivery seals 846 and 848 in the raise position shown in FIG. 8C (e.g., by continuing to pass the electrical current through one of the first and second solenoids 812a and 812b of the second RLV actuator 808). In some aspects, moving the supply seals 842 and 844 to the neutral position and keeping the delivery seals 846 and 848 in the raise position will maintain the increased amount of air in the one or more air springs 870 and maintain the raised height of the one side of the chassis of the vehicle 10 or the trailer 20.

In some aspects, in step 914, when the first and second supply seals 842 and 844 of the first RLV housings 814 are in the neutral position as shown in FIG. 8C, the first supply seal 842 of the first RLV housing 814 may block pneumatic communication of the leveling valve bypass passage 830 of the bypass path with the exhaust passage 832 and pneumatic communication of the supply passage 826 with the leveling valve bypass passage 830. In some aspects, when the first and second delivery seals 846 and 848 of the second RLV housing 816 are in the raise position as shown in FIG. 8C, the second delivery seal 848 of the second RLV housing 816 may block the leveling valve spring passage 838 and prevent pneumatic communication of the spring passage 840 with the spring port 862d of the leveling valve 860. Accordingly, with the supply seals 842 and 844 in the neutral position and the delivery seals 846 and 848 in the raise position, the raised height of the side of the chassis of the vehicle 10 or trailer 20 is maintained because (i) the first supply seal 842 prevents additional air received at the supply port 818 from entering the leveling valve bypass passage 830, (ii) the first supply seal 842 prevents air from the one or more air springs 870 from being vented to atmosphere via the exhaust passage 832 and exhaust port 820, and (iii) the second delivery seal 848 prevents air from the one or more air springs 870 from being vented to atmosphere via the leveling valve 860 (e.g., via the spring port 862d and then through the exhaust port 862b of the leveling valve). With the supply seals 842 and 844 in the neutral position, the supply port 818 of the first RLV housing 814 may be connected pneumatically to the supply port 862a of the leveling valve 860 (e.g., via the supply passage 826 and leveling valve supply passage 828) such that the first RLV housing 814 could supply air received at the supply port 818 of the first RLV housing 814 to the supply port 862a of the leveling valve 860. However, as the side of the chassis of the vehicle 10 or trailer 20 is at a raised height in step 914, the leveling valve 860 would be trying to remove air from the one or more air bags 870 (if the ability to do so were not blocked by the second delivery seal 848) and would not be trying to supply more air to the one or more air springs 870.

In some aspects, the process 900 may include a step 916 in which the RLV 800 (e.g., the RLV controller 804) determines whether the RLV 800 (e.g., the RLV controller 804) has received via the RLV user input 802 and/or the communication interface 803 a leveling valve height control input (e.g., indicating that the user would like to return height control to the leveling valve 860, which will return the side of the chassis of the vehicle 10 or trailer 20 to the normal ride height). In some aspects, the leveling valve height control may be indicative of, for example and without limitation, a switch of the RLV user interface 802 turned to the center position. In some aspects, if the RLV 800 determines that no leveling valve height control input was received in step 916 (e.g., determines that a switch of the RLV user interface 802 was kept in the raise position and was not moved to the center position and/or that no leveling valve height control input was received via the communication interface 803), the process 900 may proceed back to the step 914 in which the RLV 800 maintains the supply seals 842 and 844 in the neutral position and the delivery seals 846 and 848 in the raise position so that the side of the chassis of the vehicle 10 or trailer 20 is maintained at the raised height. In some aspects, if the RLV 800 determines that a leveling valve height control input was received in step 916, the process 900 may proceed to the step 902 in which the seals 842, 844, 846, and 848 are all moved to their neutral positions so that the leveling valve 860 performs height control, which will return (e.g., lower) the height of the side of the chassis of the vehicle 10 or trailer 20 to its normal ride height.

In some aspects, the process 900 may include a step 918 in which the RLV controller 804, in response to a lower input received via the RLV user interface 802 and/or the communication interface 803, starts a timer of the RLV controller 804. In some aspects, if the RLV controller 804 includes a raise timer and a lower timer, in step 918, the RLV controller 804 may start the lower timer.

In some aspects, the process 900 may include a step 920 in which the RLV controller 804, in response to a lower input, controls the first RLV actuator 806 to move the first and second supply seals 842 and 844 from the neutral position shown in FIG. 8A to the lower position shown in FIG. 8D (e.g., by passing an electrical current through one of the first and second solenoids 810a and 810b of the first RLV actuator 806) and controls the second RLV actuator 808 to move the first and second delivery seals 846 and 848 from the neutral position shown in FIG. 8A to the lower position shown in FIG. 8D (e.g., by passing an electrical current through one of the first and second solenoids 812a and 812b of the second RLV actuator 808).

In some aspects, in step 920, when the first and second supply seals 842 and 844 of the first RLV housing 814 and the first and second delivery seals 846 and 848 of the second RLV housing 816 are in the lower positions, as shown in FIG. 8D, the RLV 800 may bypass the leveling valve 860 and provide air from one or more air springs 870 to the exhaust port 820 of the first RLV housing 814 (e.g., to decrease the amount of air in the one or more air springs 870 and, thereby, decrease the height of the side of the chassis of the vehicle 10 or trailer 20). In some aspects, with the seals 842, 844, 846, and 848 in the lower positions, the RLV 800 may prevent the leveling valve 860 from controlling the height of a side of a chassis of the vehicle 10 or trailer 20.

In some aspects, in step 920, when the seals 842, 844, 846, and 848 of the first and second RLV housings 814 and 816 are in the lower position as shown in FIG. 8D, the spring port 822 of the second RLV housing 816 may be connected pneumatically to the exhaust port 820 of the first RLV housing 814 (e.g., via the spring passage 840 of the second RLV housing 816, bypass path, and exhaust passage 832 of the first RLV housing 814) such that the first and second RLV housings 814 and 816 provide air received at the spring port 822 of the second RLV housing 816 to the exhaust port 820 of the first RLV housing 814. In some aspects, the bypass path may include the leveling valve bypass passage 830 of the first RLV housing 814, the bypass air line 850, and the leveling valve bypass passage 836 of the second RLV housing 816. In some aspects, when in the lower position as shown in FIG. 8D, the first delivery seal 846 and/or second delivery seal 848 of the second RLV housing 816 may block the leveling valve spring passage 838 and, thus, prevent pneumatic communication between (i) the spring port 862d of the leveling valve 860 and (ii) the spring port 822 of the second RLV housing 816 and/or the bypass path. In some aspects, when in the lower position as shown in FIG. 8D, the first supply seal 842 and/or the second supply seal 844 of the first RLV housing 814 may block the leveling valve supply passage 828 and, thus, prevent pneumatic communication between (i) the supply port 862a of the leveling valve 860 and (ii) the bypass path and/or the exhaust port 820 of the first RLV housing 814. In some aspects, when in the lower position as shown in FIG. 8D, the first supply seal 842 and/or the second supply seal 844 of the first RLV housing 814 may block the supply passage 826 and, thus, prevent pneumatic communication between (i) the supply port 818 of the first RLV housing 814 and (ii) the supply port 862a of the leveling valve 860 and/or the bypass path. In some aspects, after the RLV 800 has removed air from the one or more air springs 870 and decreased the height of the chassis on one side of the vehicle 10 or trailer 20, the leveling valve 860 (if able to operate) would attempt to add air to the one or more air springs 870 to return the vehicle 10 or trailer 20 to a level condition, but the seals 842, 844, 846, and 848 in the lower positions prevent the leveling valve 860 from operating to add air to the one or more air springs 870.

In some aspects, the process 900 may include a step 922 in which the RLV controller 804 determines whether the timer (e.g., the lower timer) has expired. In some aspects, the timer may be set to expire after an amount of time allows for enough air to be removed from the one or more air springs 870 that the height of the side of the vehicle 10 or trailer 20 is lowered relative to the ground by a certain amount (e.g., 6 inches or 1 foot). In some aspects, the step 922 may additionally or alternatively include the RLV controller 804a determining that the air pressure within the one or more air springs has fallen to a threshold lower pressure (e.g., using a pressure sensor such as pressure sensor 120, 122, 220, or 222) and/or that the side of the chassis of the vehicle 10 or trailer 20 has fallen to a threshold lower height (e.g., using a proximity sensor). In some aspects, if the RLV controller 804 determines that the timer has expired (or that the threshold lower pressure and/or threshold lower height has been reached) in step 922, the process 900 may proceed to a step 924. In some aspects, if the RLV controller 804 determines that the timer has not expired (or that the threshold raise pressure and/or threshold raise height have not been reached) in step 922, the process 900 may proceed back to the step 920 so that the RLV 800 continues to remove air from the one or more air springs 870 to lower the height of the side of the chassis of the vehicle 10 or trailer 20 relative to the ground.

In some aspects, the process 900 may include a step 924 in which the RLV controller 804, in response to the interval of time having passed (or the threshold lower pressure and/or threshold lower height having been reached), controls the first RLV actuator 806 to maintain the first and second supply seals 842 and 844 in the lower position shown in FIG. 8E (e.g., by continuing to pass the electrical current through one of the first and second solenoids 810a and 810b of the first RLV actuator 806) and controls the second RLV actuator 808 to move the first and second delivery seals 846 and 848 from the lower position to the neutral position shown in FIG. 8E (e.g., by providing no electrical current to the first and second solenoids 812a and 812b of the second RLV actuator 808). In some aspects, keeping the supply seals 842 and 844 in the lower position and moving the delivery seals 846 and 848 to the neutral position will maintain the decreased amount of air in the one or more air springs 870 and maintain the lowered height of the one side of the chassis of the vehicle 10 or the trailer 20.

In some aspects, in step 924, when the first and second delivery seals 846 and 848 of the second RLV housings 816 are in the neutral position as shown in FIG. 8E, the first delivery seal 846 may block pneumatic communication of the spring passage 840 with the leveling valve bypass passage 830 of the bypass path. In some aspects, when the first and second supply seals 842 and 844 of the first RLV housing 814 are in the lower position as shown in FIG. 8E, the first and/or second supply seals 842 and 844 may block the supply passage 826 and the leveling valve supply passage 828 and prevent pneumatic communication of the supply passage 826 with the supply port 862a of the leveling valve 860. Accordingly, with the supply seals 842 and 844 in the lower position and the delivery seals 846 and 848 in the neutral position, the lowered height of the side of the chassis of the vehicle 10 or trailer 20 is maintained because (i) the first supply seal 842 prevents air received at the supply port 818 from entering the leveling valve bypass passage 830, (ii) the first delivery seal 846 prevents air from the one or more air springs 870 from being vented to atmosphere via the bypass path (e.g., including the leveling valve bypass passage 836 of the second RLV housing 816, the bypass air line 850, and the leveling valve bypass passage 830 of the first RLV housing 814), exhaust passage 832, and exhaust port 820, and (iii) the first and/or second supply seals 842 and 844 prevent air from supply port 818 of the first RLV housing 814 being supplied to the supply port 862a of the leveling valve 860 (e.g., via the leveling valve supply passage 828). With the delivery seals 846 and 848 in the neutral position, the spring port 822 of the second RLV housing 816 may be connected pneumatically to the spring port 862d of the leveling valve 860 (e.g., via the spring passage 840 and the leveling valve spring passage 838) such that the second RLV housing 816 could provide air received at the spring port 822 of the second RLV housing 816 to the spring port 862d of the leveling valve 860 for venting to atmosphere via the exhaust port 862b of the leveling valve 860. However, as the side of the chassis of the vehicle 10 or trailer 20 is at a lowered height in step 924, the leveling valve 860 would be trying to supply air to the one or more air bags 870 (if the ability to do so were not blocked by the first and second supply seals 842 and 844) and would not be trying to remove more air from the one or more air springs 870.

In some aspects, the process 900 may include a step 926 in which the RLV 800 (e.g., the RLV controller 804) determines whether the RLV 800 (e.g., the RLV controller 804) has received via the RLV user input 802 and/or the communication interface 803 a leveling valve height control input (e.g., indicating that the user would like to return height control to the leveling valve 860, which will return the side of the chassis of the vehicle 10 or trailer 20 to the normal ride height). In some aspects, the leveling valve height control input may be, for example and without limitation, be indicative of a switch of the RLV user input 802 turned to the center position. In some aspects, if the RLV 800 determines that no leveling valve height control input was received in step 926 (e.g., determines that a switch of the RLV user interface 802 was kept in the lower position and was not moved to the center position and/or that no leveling valve height control input was received via the communication interface 803), the process 900 may proceed back to the step 924 in which the RLV 800 maintains the supply seals 842 and 844 in the lower position and the delivery seals 846 and 848 in the neutral position so that the side of the chassis of the vehicle 10 or trailer 20 is maintained at the lowered height. In some aspects, if the RLV 800 determines that a leveling valve height control input was received in step 926, the process 900 may proceed to the step 902 in which the seals 842, 844, 846, and 848 are all moved to their neutral positions so that the leveling valve 860 performs height control, which will return (e.g., raise) the height of the side of the chassis of the vehicle 10 or trailer 20 to its normal ride height.

Although in some aspects the RLV 800 uses a timer (or timers) to limit the amount of air the RLV 800 adds to or removes from the one or more air springs 870, this is not required. In some alternative aspects, the RLV 800 may not use a timer or timer and instead uses one or more sensors (e.g., one or more pressure sensors and/or one or more proximity sensors) to determine the appropriate time to stop raising or lowering the height of the side of the chassis of the vehicle 10 or trailer 20. In some further alternative aspects, the RLV 800 may not limit the amount of air the RLV 800 adds to or removes from the one or more air springs 870. In these alternative embodiments, the controller 804 may control the first and second RLV actuators 806 and 808 to move the seals 842, 844, 846, and 848 to the raise or lower positions (e.g., as in FIG. 8B or 8D) so that the RLV 800 adds or removes air to or from the one or more air springs 870 the entire time that the raise or lower input is received via the RLV user interface 802 and/or the communication interface 803 (e.g., indicating that the user would like to raise or lower the height of a side of the chassis of the vehicle 10 or trailer 20 relative to the ground). For example, in some aspects, the RLV 800 may add or remove air to or from the one or more air springs 870 the entire time that a switch of the RLV user interface 802 is turned to the right or left.

In some aspects, the RLV controller the RLV user interface 802, the communication interface 803, and/or RLV controller 804 may be contained in the same housing. In some aspects, the housing including the RLV user interface 802, the communication interface 803, and/or RLV controller 804 may be located in a cabin of the vehicle 10, at a back corner of the trailer 20, or in a control box.

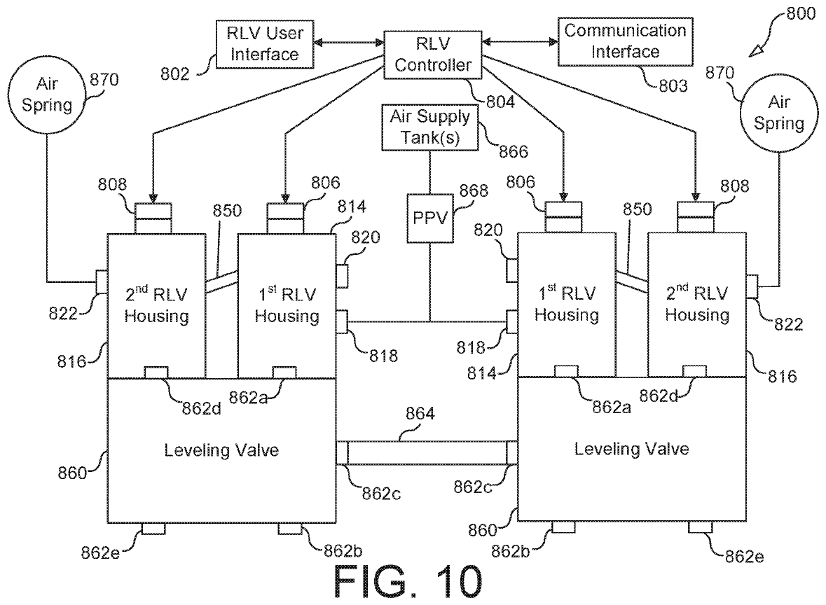

In some aspects, as shown in FIG. 10, the RLV user interface 802, the communication interface 803, and/or the RLV controller 804 may be used to control raising or lowering of the height on either or both sides of the chassis of a vehicle 10 or trailer 20. In some aspects, as shown in FIG. 10, the supply and spring ports 862a and 862d of a first leveling valve 860 (e.g., first leveling valve 108 or 208) on the right side of the vehicle 10 or trailer 20 may be connected pneumatically to the main passages 824 and 834, respectively, of a first set of first and second RLV housings 814 and 816, and supply and spring ports 862a and 862d of a second leveling valve 860 (e.g., first leveling valve 112 or 212) on the left side of the vehicle 10 or trailer 20 may be connected pneumatically to the main passages 824 and 834, respectively, of a second set of first and second RLV housings 814 and 816. In some aspects, the RLV user interface 802 may include a first user input (e.g., a three-position switch) for providing raise, leveling valve height control, or lower inputs (e.g., right, center, and left positions, respectively, or upper, center, and lower positions, respectively) and a second user input (e.g., a three-position switch) for providing right side, both sides, or left side inputs (e.g., right, center, and left positions, respectively, or upper, center, and lower positions, respectively). In some aspects, the raise, leveling valve height control, and lower inputs and/or right side, both sides, and left side inputs may additionally or alternatively be provided to the RLV controller 804 via the communication interface 803.

In some aspects, if the RLV controller 804 receives the both sides input from the second user input (or from the communication interface 803), then the RLV controller 804 may control the actuators 806 and 808 for both sets of first and second RLV housings 814 and 816 in accordance with the process 900 shown in FIG. 9 in response to raise, leveling valve height control, and lower inputs from the first user input (or from the communication interface 803) (e.g., so that the height of chassis of the vehicle 10 or trailer 20 on both the right and lefts sides is raised, controlled by the respective leveling valve 860, or lowered). In some aspects, if the RLV controller 804 receives the right side input or the left side input from the second user input (or from the communication interface 803), then the RLV controller 804 may (i) control the actuators 806 and 808 for the set of first and second RLV housings 814 and 816 on the selected side in accordance with the process 900 shown in FIG. 9 in response to raise, leveling valve height control, and lower inputs from the first user input (or from the communication interface 803) and (ii) control the actuators 806 and 808 for the first and second RLV housings 814 and 816 on the non-selected side maintain the amount of air in the air springs 870 on the non-selected side and, therefore, maintain the height of the chassis on the non-selected side. In some aspects, if no action were taken on the non-selected side (e.g., if the seals 842, 844, 846, and 848 of the RLV housings 814 and 816 on the non-selected side were kept in the neutral positions) while raising or lowering the selected side, the leveling valve 860 on the non-selected side would attempt to compensate for the height change on the selected side. Accordingly, in some aspects, in response to a raise input for a selected side, the RLV controller 804 may control the actuators 806 and 808 on the non-selected side to move the supply seals 842 and 844 from the neutral position to the lower position and to maintain the delivery seals 846 and 848 in the neutral position (resulting in the arrangement shown in FIG. 8E). When arranged as shown in FIG. 8E, the seals 842, 844, 846, and 848 on the non-selected side may maintain the amount of air in the one or more air springs 870 of the non-selected side and prevent the leveling valve 860 on the non-selected side from adding air to the one or more air springs 870 on the non-selected side to match the air added to the one or more air springs 870 on the selected side. In addition, in some aspects, in response to a lower input for a selected side, the RLV controller 804 may control the actuators 806 and 808 on the non-selected side to maintain the supply seals 842 and 844 in the neutral position and to move the delivery seals 846 and 848 from the neutral position to the raise position (resulting in the arrangement shown in FIG. 8C). When arranged as shown in FIG. 8C, the seals 842, 844, 846, and 848 on the non-selected side may maintain the amount of air in the one or more air springs 870 of the non-selected side and prevent the leveling valve 860 on the non-selected side from removing air from the one or more air springs 870 on the non-selected side to match the air removed from the one or more air springs 870 on the selected side.

In some alternative aspects, the RLV user interface 802 may include a first user input (e.g., a three-position switch) for providing raise, leveling valve height control, or lower inputs (e.g., right, center, and left positions, respectively, or upper, center, and lower positions, respectively) for controlling the height on one side of the vehicle 10 or trailer 20, and a second user input (e.g., a three-position switch) for providing raise, leveling valve height control, or lower inputs (e.g., right, center, and left positions, respectively, or upper, center, and lower positions, respectively) for controlling the height on the other side of the vehicle 10 or trailer 20.

In some alternative embodiments, the user input that provides the raise, neutral, or lower inputs may be a variable switch (e.g., a potentiometer type switch) and allow for one up and one down at the same time as required.

In some aspects, the cross-flow passage 864 (e.g., the cross-flow passage 116 or 216) may be configured to connect the leveling valves 860 on opposite sides of the vehicle 10 or trailer 20. In some aspects, the leveling valves 860 may be configured to establish pneumatic communication via the cross-flow passage 864 when the leveling valves 860 are allowed to adjust independently the heights of the first and second sides of the vehicle or the trailer (e.g., because the RLV controller 804 has controlled the seals 842, 844, 846, and 848 of the housings 814 and 816 on both sides to the neutral positions) but neither of the leveling valves 860 is adjusting independently the height of a side of the vehicle 10 or trailer 20. In some aspects, the pneumatic communication between the pneumatic circuits via the cross-flow passage 864 may equalize air pressure between air springs 870 on opposite sides of the vehicle 10 or trailer 20.

Similar to the computer 124 of the vehicle system 100, in some aspects, as shown in FIG. 4, the RLV controller 804 may include one or more processors 522 (e.g., a general purpose microprocessor) and/or one or more circuits, such as an application specific integrated circuit (ASIC), field-programmable gate arrays (FPGAs), a logic circuit, and the like. In some aspects, the RLV controller 804 may include a data storage system (DSS) 523. The DSS 523 may include one or more non-volatile storage devices and/or one or more volatile storage devices (e.g., random access memory (RANI)). In aspects where the RLV controller 804 includes a processor 522, the DSS 523 may include a computer program product (CPP) 524. CPP 524 may include or be a computer readable medium (CRM) 526. The CRM 526 may store a computer program (CP) 528 comprising computer readable instructions (CRI) 530. The CRM 526 may be a non-transitory computer readable medium, such as, but not limited, to magnetic media (e.g., a hard disk), optical media (e.g., a DVD), solid state devices (e.g., random access memory (RAM) or flash memory), and the like. In some aspects, the CRI 530 of computer program 528 may be configured such that when executed by processor 522, the CRI 530 causes the computer 124 to perform one or more of the steps described with reference to the RLV 800 (e.g., the steps of the process 900 shown in FIG. 9). In other aspects, the RLV controller 804 may be configured to perform steps described herein without the need for a computer program. That is, for example, the computer may consist merely of one or more ASICs. Hence, the features of the aspects described herein may be implemented in hardware and/or software.

In any of the aspects above, the vehicle 10 and/or the trailer 20 may be an autonomous vehicle, and the vehicle 10 and/or trailer 20 may be capable of operating without input from a user/driver. In some aspects, the vehicle 10 and/or the trailer 20 may be a self-driving vehicle. In some aspects, the computer 124 and/or the RLV controller 804 may be configured for autonomous operation (e.g., for operation without input from a user/driver). In some aspects, autonomous operation may include communication (e.g., wireless communication) with one or more other vehicles or trailers (e.g., using the communication unit 139 and/or the communication interface 803) and/or with one or more other devices (a communication unit at a loading dock and/or another computer such as a smartphone). For example, in some aspects, the computer 124 and/or the RLV controller 804 may, without user input, may control the RLV 800 to raise or lower one or both sides of the vehicle 10 or the trailer 20 (e.g., as appropriate for unloading or loading to or from a loading dock of a particular height).

In any of the aspects described above, the leveling valves may be the same or similar to leveling valves described in U.S. Pat. No. 10,093,145, which is incorporated by reference herein in its entirety.

Aspects of the present invention have been fully described above with reference to the drawing. Although the invention has been described based upon these preferred aspects, it would be apparent to those of skill in the art that certain modifications, variations, and alternative constructions could be made to the described aspects within the spirit and scope of the invention.

1-162. (canceled)

163. A load monitoring system comprising:
a cross-flow passage;
a cross-flow air pressure sensor configured to output cross-flow pressure information indicative of an air pressure within the cross-flow passage;
an analog-to-digital converter (ADC) configured to convert the cross-flow pressure information into digital cross-flow pressure information;
a first pneumatic circuit having a first leveling valve configured to adjust independently a pressure within one or more air springs of a first side of a vehicle or a trailer; and
a second pneumatic circuit having a second leveling valve configured to adjust independently a pressure within one or more air springs of a second side of the vehicle or the trailer;
wherein the cross-flow passage connects the first leveling valve and the second leveling valve, the first and second leveling valves are configured to establish pneumatic communication between the first and second pneumatic circuits via the cross-flow passage when the first leveling valve is not adjusting independently the pressure in the one or more air springs of the first side and the second leveling valve is not adjusting independently the pressure in the one or more air springs of the second side, and the cross-flow pressure information is used for monitoring a load in the vehicle or the trailer.

164. The system of claim 163, further comprising a fitting at each end of the cross-flow passage, wherein a first fitting connects the cross-flow passage to the first leveling valve and a second fitting connects the cross-flow passage to the second leveling valve.

165. The system of claim 163, wherein the cross-flow air pressure sensor is inside the cross-flow passage.

166. The system of claim 163, further comprising a fitting connected to the cross-flow passage, wherein the cross-flow air pressure sensor is configured to communicate pneumatically with the cross-flow passage via the fitting.

167. The system of claim 166, further comprising one or more air lines that connect the cross-flow air pressure sensor to the fitting for pneumatic communication between the cross-flow air pressure sensor and the cross-flow passage.

168. The system of any claim 163, wherein the cross-flow pressure information is indicative of the air pressure retained within the cross-flow passage, and varied when the first or second leveling valves have established pneumatic communication between the first and/or second pneumatic circuits and the cross-flow passage, and the cross-flow pressure information is indicative of the higher of (i) an air pressure within the first pneumatic circuit when the first leveling valve is not independently adjusting the pressure within the one or more air springs of the first side of the vehicle or trailer and (ii) an air pressure in the second pneumatic circuit when the second leveling valve is not adjusting independently the pressure in the one or more air springs of the second side of the vehicle or the trailer.

169. The system of any claim 163, wherein:
the first pneumatic circuit comprises a first air spring disposed on the first side;
a first air spring air pressure sensor is configured to output first air spring pressure information indicative of an air pressure within the first air spring; and
an ADC is configured to convert the first air spring pressure information into digital first air spring pressure information.

170. The system of claim 169, wherein:
the second pneumatic circuit comprises a second air spring disposed on the second side;
a second air spring air pressure sensor is configured to output second air spring pressure information indicative of an air pressure within the second air spring; and
an ADC is configured to convert the second air spring pressure information into digital second air spring pressure information.

171. The system of claim 163, further comprising a computer configured to use the digital cross-flow pressure information to calculate a cross-flow-based weight on one or more axles of the vehicle or the trailer.

172. The system of claim 171, wherein:
the cross-flow pressure information is first cross-flow pressure information indicative of an air pressure within the cross-flow passage at a first measurement time;
the cross-flow air pressure sensor is further configured to output second cross-flow pressure information indicative of an air pressure within the cross-flow passage at a second measurement time;
the digital cross-flow pressure information is digital first cross-flow pressure information;
the ADC is further configured to convert the second cross-flow pressure information into digital second cross-flow pressure information;
the cross-flow-based weight is indicative of a weight on the one or more axles of the vehicle or the trailer at the first measurement time; and
the computer is configured to use reference weight information, the digital first cross-flow pressure information, and the digital second cross-flow pressure information to calculate the cross-flow-based weight, wherein the reference weight information is indicative of a weight on the one or more axles of the vehicle or the trailer at the second measurement time.

173. The system of claim 172, wherein:
the first pneumatic circuit comprises a first air spring disposed on the first side;
a first air spring air pressure sensor is configured to output first air spring pressure information indicative of an air pressure within the first air spring at the first measurement time and second air spring pressure information indicative of an air pressure within the first air spring at the second measurement time;
the system further comprises an ADC configured to convert the first air spring pressure information into digital first air spring pressure information and to convert the second air spring pressure information into digital second air spring pressure information; and
the computer is further configured to use the reference weight information, the digital first air spring pressure information, and the digital second air spring pressure information to calculate a first air spring-based weight on one or more axles of the vehicle or the trailer at the first measurement time.

174. The system of claim 173, wherein:
the second pneumatic circuit comprises a second air spring disposed on the second side;
the system further comprises a second air spring air pressure sensor configured to output third air spring pressure information indicative of an air pressure within the second air spring at the first measurement time and fourth air spring pressure information indicative of an air pressure within the second air spring at the second measurement time;
the system further comprises an ADC configured to convert the third air spring pressure information into digital third air spring pressure information and to convert the fourth air spring pressure information into digital fourth air spring pressure information; and
the computer is further configured to use the reference weight information, the digital third air spring pressure information, and the digital fourth air spring pressure information to calculate a second air spring-based weight on one or more axles of the vehicle or the trailer at the first measurement time.

175. The system of claim 174, wherein the ADC configured to convert the first and second cross-flow pressure information, the ADC configured to convert the first and second air spring pressure information, and the ADC configured to convert the third and fourth air spring pressure information are the same ADC.

176. The system of claim 174, further comprising a display configured to display:
a) the cross-flow-based weight;
b) the first air spring-based weight;
c) the second air spring-based weight; or
d) a combination of a)-c).

177. The system of claim 174, wherein using the reference weight information, the digital first cross-flow pressure information, and the digital second cross-flow pressure information to calculate the cross-flow-based weight on the one or more axles of the vehicle or the trailer at the first measurement time comprises:
using the reference weight information and the digital first cross-flow pressure information to calculate a pressure-to-weight conversion function; and
using the pressure-to-weight conversion function and the digital second cross-flow pressure information to calculate the cross-flow-based weight on the one or more axles of the vehicle or the trailer at the first measurement time.

178. The system of claim 174, wherein:
the reference weight information is first reference weight information;
the cross-flow air pressure sensor is further configured to output third cross-flow pressure information indicative of an air pressure within the cross-flow passage at a third measurement time;
the ADC configured to convert the first and second cross-flow pressure information is further configured to convert the third cross-flow pressure information into third digital cross-flow pressure information; and
the computer is configured to use the first reference weight information, second reference weight information, the digital first cross-flow pressure information, the digital second cross-flow pressure information, and the third digital cross-flow pressure information to calculate the cross-flow-based weight on the one or more axles of the vehicle or the trailer at the first measurement time, wherein the second reference weight information is indicative of a weight on the one or more axles of the vehicle or the trailer at the third measurement time.

179. The system of claim 178, wherein using the first reference weight information, the second reference weight information, the digital first cross-flow pressure information, the digital second cross-flow pressure information, and the third digital cross-flow pressure information to calculate the cross-flow-based weight on the one or more axles of the vehicle at the first measurement time comprises:
using the first and second reference weight information and the first and third digital cross-flow pressure information to calculate a pressure-to-weight conversion function; and
using the pressure-to-weight conversion function and the digital second cross-flow pressure information to calculate the cross-flow-based weight on the one or more axles of the vehicle or the trailer at the first measurement time.

180. A load monitoring method comprising:
using a cross-flow air pressure sensor to output cross-flow pressure information indicative of an air pressure within a cross-flow passage, wherein the cross-flow passage connects a first leveling valve of a first pneumatic circuit with a second leveling valve of a second pneumatic circuit, the first level circuit is configured to adjust independently pressure of one or more air springs of a first side of a vehicle or a trailer, the second leveling valve is configured to adjust independently pressure of one or more air springs of a second side of the vehicle or the trailer, and the first and second leveling valves are configured to establish pneumatic communication between the first and second pneumatic circuits when the first leveling valve is not adjusting independently the pressure of the one or more air springs of the first side and the second leveling valve is not adjusting independently the pressure of the one or more air springs of the second side;
wherein the cross-flow pressure information indicates the air pressure retained within the cross-flow passage, and varies when the first or second leveling valves have established pneumatic communication between the first and/or second pneumatic circuits and the cross-flow passage, and the cross-flow pressure information indicates the higher of (i) an air pressure within the first pneumatic circuit when the first leveling valve is not independently adjusting the pressure of the air springs of the first side of the vehicle or trailer and (ii) an air pressure within the second pneumatic circuit when the second leveling valve is not adjusting independently the pressure of the air springs of the second side of the vehicle or the trailer;
using an analog-to-digital converter (ADC) to convert the cross-flow pressure information into digital cross-flow pressure information at one or more measurement times; and
using a computer to use the digital cross-flow pressure information to calculate a cross-flow-based weight on one or more axles of the vehicle or the trailer at the first and subsequent measurement times.

181. The method of claim 180, wherein the first pneumatic circuit comprises:
a first air spring disposed on the first side of the vehicle or the trailer;
using a first air spring air pressure sensor configured to output first air spring pressure information indicative of an air pressure within the first air spring at one or more measurement times;
using an ADC to convert the first air spring pressure information into digital first air spring pressure information at one or more measurement times; and
using a computer to use the digital first air spring pressure information to calculate a first air spring based weight on one or more axles of the vehicle or the trailer at the first and subsequent measurement times.

182. The method of claim 181, wherein the second pneumatic circuit comprises:
a second air spring disposed on the second side of the vehicle or the trailer;
using a second air spring air pressure sensor configured to output second air spring pressure information indicative of an air pressure within the second air spring at one or more measurement times;
using an ADC to convert the second air spring pressure information into digital second air spring pressure information at one or more measurement times;
using a computer to use the second spring pressure information to calculate a second air spring based weight on one or more axles of the vehicle or the trailer at the first and subsequent measurement times.

183. The method of claim 180, further comprising using a computer to use the digital cross flow pressure information to calculate a cross-flow-based weight on one or more axles of the vehicle or the trailer, wherein the cross-flow pressure information is first cross-flow pressure information indicative of an air pressure within the cross-flow passage at a first measurement time, the digital cross-flow pressure information is digital first cross-flow pressure information, the cross-flow-based weight is indicative of a weight on the one or more axles of the vehicle or the trailer at the first measurement time, and the method further comprises:
using the cross-flow air pressure sensor to output second cross-flow pressure information indicative of an air pressure within the cross-flow passage at a second measurement time; and
using the ADC to convert the second cross-flow pressure information into digital second cross-flow pressure information;
wherein the computer uses reference weight information, the digital first cross-flow pressure information, and the digital second cross-flow pressure information to calculate the cross-flow-based weight, and the reference weight information is indicative of a weight on the one or more axles of the vehicle or the trailer at the second measurement time.

184. The method of claim 183, wherein the first pneumatic circuit comprises a first air spring disposed on the first side of the vehicle or the trailer, and the method further comprises:
using a first air spring air pressure sensor to output first air spring pressure information indicative of an air pressure within the first air spring at the first measurement time;
using the first air spring air pressure sensor to output second air spring pressure information indicative of an air pressure within the first air spring at the second measurement time;
using an ADC to convert the first air spring pressure information into digital first air spring pressure information and to convert the second air spring pressure information into digital second air spring pressure information; and
using the computer to use the reference weight information, the digital first air spring pressure information, and the digital second air spring pressure information to calculate a first air spring-based weight on the one or more axles of the vehicle or the trailer at the first measurement time.

185. The method of claim 184, wherein the second pneumatic circuit comprises a second air spring disposed on a second side of the vehicle or the trailer, and the method further comprises:
using a second air spring air pressure sensor to output third air spring pressure information indicative of an air pressure within the second air spring at the first measurement time; and
using the second air spring air pressure sensor to output fourth air spring pressure information indicative of an air pressure within the second air spring at the first measurement time;
using an ADC to convert the third air spring pressure information into third digital air spring pressure information and to convert the fourth air spring pressure information into fourth digital air spring pressure information; and
using the computer to use the reference weight information, the third digital air spring pressure information, and the fourth digital air spring pressure information to calculate a second air spring-based weight on the one or more axles of the vehicle or the trailer at the first measurement time.

186. The method of claim 185, further comprising displaying the cross-flow-based weight, the first air spring-based weight, and/or the second air spring-based weight.

187. The method of claim 183, wherein using the reference weight information, the digital first cross-flow pressure information, and the digital second cross-flow pressure information to calculate the cross-flow-based weight on the one or more axles of the vehicle or the trailer at the first measurement time comprises:
using the reference weight information and the digital first cross-flow pressure information to calculate a pressure-to-weight conversion function; and
using the pressure-to-weight conversion function and the digital second cross-flow pressure information to calculate the cross-flow-based weight on the one or more axles of the vehicle or the trailer at the first measurement time.

188. The method of claim 183, wherein the reference weight information is first reference weight information, and the method further comprises:
using the cross-flow air pressure sensor to output third cross-flow pressure information indicative of an air pressure within the cross-flow passage at a third measurement time;
using an ADC to convert the third cross-flow pressure information into third digital cross-flow pressure information; and
using the computer to use the first reference weight information, the second reference weight information, the digital first cross-flow pressure information, the digital second cross-flow pressure information, and the third digital cross-flow pressure information to calculate the cross-flow-based weight on the one or more axles of the vehicle or the trailer at the first measurement time, wherein the second reference weight information is indicative of a weight on the one or more axles of the vehicle or the trailer at the third measurement time.

189. The method of claim 188, wherein using the first reference weight information, the second reference weight information, the digital first cross-flow pressure information, the digital second cross-flow pressure information, and the third digital cross-flow pressure information to calculate the cross-flow-based weight on the one or more axles of the vehicle or the trailer at the first measurement time comprises:
using the first and second reference weight information and the first and third digital cross-flow pressure information to calculate a pressure-to-weight conversion function; and
using the pressure-to-weight conversion function and the digital second cross-flow pressure information to calculate the cross-flow-based weight on the one or more axles of the vehicle or the trailer at the first measurement time.

190. A system comprising:
(1) a first pneumatic circuit including:
(1A) a first air spring configured to support a first axle of a vehicle or a trailer on a first side of the vehicle or the trailer;
(1B) a second air spring configured to support a second axle of the vehicle or the trailer on the first side of the vehicle or the trailer;
(1C) a third air spring configured to support a third axle of the vehicle or the trailer on the first side of the vehicle or the trailer, wherein the second axle is located between the first and third axles;
(1D) a first air line that connects the first and second air springs of the first pneumatic circuit;
(1E) a second air line that connects second and third air springs of the first pneumatic circuit; and
(1F) a first leveling valve configured to adjust independently a height of the first side of the vehicle or the trailer by increasing or decreasing an amount of air in the first, second, and third air springs of the first pneumatic circuit; and
(2) a second pneumatic circuit including:
(2A) a first air spring configured to support the first axle of the vehicle or the trailer on a second side of the vehicle or the trailer;
(2B) a second air spring configured to support the second axle of the vehicle or the trailer on the second side of the vehicle or the trailer;
(2C) a third air spring configured to support the third axle of the vehicle or the trailer on the second side of the vehicle or the trailer;
(2D) a first air line that connects the first and second air springs of the second pneumatic circuit;
(2E) a second air line that connects second and third air springs of the second pneumatic circuit; and
(2F) a second leveling valve configured to adjust independently a height of the second side of the vehicle or the trailer by increasing or decreasing an amount of air in the first, second, and third air springs of the second pneumatic circuit.

191. The system of claim 190, wherein the first and second air lines of the first pneumatic circuit are configured to enable front-to-back and/or back-to-front air flow between the first, second, and third air springs of the first pneumatic circuit, and the first and second air lines of the second pneumatic circuit are configured to enable front-to-back and/or back-to-front air flow between the first, second, and third air springs of the second pneumatic circuit.

192. The system of claim 190, further comprising a cross-flow passage that connects the first leveling valve and the second leveling valve, wherein the first and second leveling valves are configured to establish pneumatic communication between the first and second pneumatic circuits via the cross-flow passage when neither the first leveling valve is adjusting independently the amount of air in the first, second, and third air springs of the first pneumatic circuit nor the second leveling valve is adjusting independently the amount of air in the first, second, and third air springs of the second pneumatic circuit.

193. A system comprising:
a first leveling valve configured to adjust independently a height of a first side of a vehicle or a trailer by increasing or decreasing an amount of air in one or more air springs on the first side of the vehicle or trailer;
a second leveling valve configured to adjust independently a height of a second side of the vehicle or the trailer by increasing or decreasing an amount of air in one or more air springs on the second side of the vehicle or trailer;
a raise lower valve (RLV) configured to:
in response to a leveling valve height control input, allow the first and second leveling valves to adjust independently the heights of the first and second sides of the vehicle or the trailer;
in response to a raise input, raise the height of one or both of the first and second sides of the vehicle or the trailer and prevent the first and second leveling valves from adjusting independently the heights of the first and second sides of the vehicle or the trailer; and
in response to a lower input, lower the height of one or both of the first and second sides of the vehicle or the trailer and prevent the first and second leveling valves from adjusting independently the heights of the first and second sides of the vehicle or the trailer.

194. The system of claim 193, further comprising one or more air supply tanks, one or more first air springs on the first side, and one or more second air springs on the second side, wherein the RLV comprises:
one or more supply seals and one or more delivery seals in one or more passages of one or more first side housings;
one or more supply seals and one or more delivery seals in one or more passages of one or more second side housings;
a first actuator configured to move the one or more supply seals in the one or more passages of the one or more first side housings;
a second actuator configured to move the one or more delivery seals in the one or more passages of the one or more first side housings;
a third actuator configured to move the one or more supply seals in the one or more passages of the one or more second side housings; and
a fourth actuator configured to move the one or more delivery seals in the one or more passages of the one or more second side housings.

195. The system of claim 194, wherein, to allow the first and second leveling valves to adjust independently the heights of the first and second sides of the vehicle or the trailer, the RLV is configured to:
control the first actuator to position the one or more supply seals in the one or more passages of the one or more first side housings at a neutral position that allows air supplied by the one or more air supply tanks to reach the first leveling valve;
control the second actuator to position the one or more delivery seals in the one or more passages of the one or more first side housings at a neutral position that allows the first leveling valve to add air to or remove air from the one or more first air springs;
control the third actuator to position the one or more supply seals in the one or more passages of the one or more second side housings at a neutral position that allows air supplied by the one or more air supply tanks to reach the second leveling valve; and
control the fourth actuator to position the one or more delivery seals in the one or more passages of the one or more second side housings at a neutral position that allows the second leveling valve to add air to or remove air from the one or more second air springs.

196. The system of claim 195, wherein the one or more passages of the one or more first side housings comprise a first leveling valve bypass path, the one or more passages of the one or more second side housings comprise a second leveling valve bypass path, the one or more supply seals and/or the one or more delivery seals at the neutral positions in the one or more passages of the one or more first side housings block the first leveling valve bypass path, and the one or more supply seals and/or the one or more delivery seals at the neutral positions in the one or more passages of the one or more second side housings block the second leveling valve bypass path.

197. The system of claim 193, wherein the RLV is further configured to:
in response to the raise input and a first side input, raise the height of the first side of the vehicle or the trailer and maintain the height of the second side of the vehicle or the trailer;
in response to the raise input and a second side input, raise the height of the second side of the vehicle or the trailer and maintain the height of the first side of the vehicle or the trailer;
in response to the raise input and a both sides input, raise the height of both the first and second sides of the vehicle;
in response to the lower input and the first side input, lower the height of the first side of the vehicle or the trailer and maintain the height of the second side of the vehicle or the trailer;
in response to the lower input and the second side input, lower the height of the second side of the vehicle or the trailer and maintain the height of the first side of the vehicle or the trailer; and
in response to the lower input and the both sides input, lower the height of both the first and second sides of the vehicle.

198. The system of claim 197, further comprising one or more air supply tanks, one or more first air springs on the first side, and one or more second air springs on the second side, and wherein the RLV comprises:
one or more supply seals and one or more delivery seals in one or more passages of one or more first side housings, wherein the one or more passages of the one or more first side housings comprise a first leveling valve bypass path;
one or more supply seals and one or more delivery seals in one or more passages of one or more second side housings, wherein the one or more passages of the one or more second side housings comprise a second leveling valve bypass path;
a first actuator configured to move the one or more supply seals in the one or more passages of the one or more first side housings;
a second actuator configured to move the one or more delivery seals in the one or more passages of the one or more first side housings;
a third actuator configured to move the one or more supply seals in the one or more passages of the one or more second side housings; and
a fourth actuator configured to move the one or more delivery seals in the one or more passages of the one or more second side housings.

199. A method performed by a raise lower valve (RLV), the method comprising:
in response to a leveling valve height control input, allowing a first leveling valve to adjust independently a height of a first side of a vehicle or a trailer and a second leveling valve to adjust independently a height of a second side of the vehicle or the trailer;
in response to a raise input, raising the height of one or both of the first and second sides of the vehicle or the trailer and preventing the first and second leveling valves from adjusting independently the heights of the first and second sides of the vehicle or the trailer; and
in response to a lower input, lowering the height of one or both of the first and second sides of the vehicle or the trailer and preventing the first and second leveling valves from adjusting independently the heights of the first and second sides of the vehicle or the trailer.

200. A raise lower valve (RLV) comprising:
one or more housings including one or more passages;
one or more supply seals in the one or more passages;
one or more delivery seals in the one or more passages;
a first actuator configured to move the one or more supply seals in the one or more passages;
a second actuator configured to move the one or more delivery seals in the one or more passages; and
a controller configured to control the first and second actuators to move the one or more supply seals and the one or more delivery seals in the one or more passages.

201. A method performed by the RLV of claim 200, the method comprising:
using the controller to control the first actuator to move the one or more supply seals in the one or more passages of the one or more housings; and
using the controller to control the second actuator to move the one or more delivery seals in the one or more passages.

202. An air management system for a vehicle or trailer, the air management system comprising:
a first pneumatic circuit having a first leveling valve configured to adjust independently a height of a first side of a first axle of the vehicle or the trailer;
a second pneumatic circuit having a second leveling valve configured to adjust independently a height of a second side of the first axle of the vehicle or the trailer; and
a first cross-flow line connecting the first leveling valve with the second leveling valve;
a third pneumatic circuit having a third leveling valve configured to adjust independently a height of a second axle of the vehicle or the trailer; and
a second cross-flow line connecting the third leveling valve with the first cross-flow line;
wherein the first, second, and third leveling valves are configured to establish pneumatic communication between the first, second, and third pneumatic circuits when the first leveling valve is not independently adjusting the height of the first side of the first axle, the second leveling valve is not independently adjusting the height of the second side of the first axle, and the third leveling valve is not independently adjusting the height of the second axle.
